(19) United States
(12) Patent Application Publication
(10) Pub. No.: US 2023/0001956 A1
(43) Pub. Date: Jan. 5, 2023

(54) SYSTEM AND METHOD FOR UNATTENDED PACKAGE MANIPULATION

(71) Applicant: DEKA Products Limited Partnership, Manchester, NH (US)

(72) Inventors: Christopher C. LANGENFELD, Nashua, NH (US); Justin M. WHITNEY, Goffstown, NH (US); Spencer TRAFTON, Nashua, NH (US); Seth SCHAFFER, Nashua, NH (US); Michael J. SLATE, Merrimack, NH (US); Dirk A. VAN DER MERWE, Canterbury, NH (US); Sooshin CHOI, Savannah, GA (US); Dean KAMEN, Bedford, NH (US); Karla BEAGLE, Bedford, NH (US); Eliza AGOSTA, Manchester, NH (US); John C. LANGENFELD, Nashua, NH (US)

(21) Appl. No.: 17/809,946

(22) Filed: Jun. 30, 2022

Related U.S. Application Data
(60) Provisional application No. 63/202,925, filed on Jun. 30, 2021.
(60) Provisional application No. 63/203,180, filed on Jul. 12, 2021.

(51) Int. Cl. B60W 60/00; B60P 1/64; B62D 63/06; B25J 18/02; B25J 15/00

(52) U.S. Cl. CPC B60W 60/00256; B60P 1/6436; B62D 63/06; B25J 18/025; B25J 15/0028; B65G 2203/0216; B65G 2203/041

(57) ABSTRACT

A deployment mechanism and a delivery container enabling unattended delivery of cargo by a vehicle navigating autonomously on both vehicle lanes and pedestrian ways. A trailer for an autonomous vehicle for hauling additional cargo and power supplies. A method for delivering and picking up goods using delivery trucks, autonomous vehicles, and trailers. The deployment mechanism can include a crane, a robot arm, a forklift, straps, and sails. The delivery container can include visible, partly visible, or hidden security features and grasping features, and can be foldable and stackable. The trailer can include a 4-bar linkage, the 4-bar linkage enabling consistent pitch between the trailer cargo and a cargo hold of the towing vehicle. The trailer wheels are decoupled from the 4-bar linkage, connected by swing arms and possible shock absorbers. The trailer can buffer fore/aft movement of the trailer.

### CROSS REFERENCE TO RELATED APPLICATIONS

This application claims the benefit of U.S. Provisional Application Ser. No. 63/202,295, filed Jun. 30, 2021, entitled SYSTEM AND METHOD FOR UNATTENDED PACKAGE DELIVERY (Attorney Docket No. AA589), U.S. Provisional Application Ser. No. 63/203,180, filed Jul. 12, 2021, entitled TRAILER FOR AUTONOMOUS DELIVERY (Attorney Docket No. AA618), and which are incorporated herein by reference in their entirety.

### BACKGROUND

The present teachings relate generally to unattended package delivery using autonomous vehicles, trailers, and trucks. The package delivery industry has exploded in recent years, especially during the COVID pandemic. Alongside the increase in front door package delivery has grown up an industry of package theft. As people emerge from the pandemic and leave their homes once again for entry into commerce, the theft industry is expected to return to its post-pandemic loss percentages, which will result in a net increase in package theft over pre-pandemic levels because the ease of package delivery is expected to fuel its continued expansion.

In common use are autonomous delivery vehicles that travel on either public roads or sidewalks, but not both. Autonomous delivery vehicles either require attended delivery, or delivery to a secure location. In either case, the recipient provides a code or some other means to verify that the package is intended for the recipient. Unless the recipient invests in a secure delivery location such as a pod or box, current autonomous delivery devices cannot perform unattended delivery. Yet, unattended delivery is the primary mode of delivery today.

Unattended autonomous delivery can require the same type of handling that would be accomplished by a delivery person, attended or unattended, for example, attending to the safety of the contents when depositing the cargo, attending to the security of the cargo until the recipient retrieves the cargo, and ensuring that the recipient and the cargo are paired correctly. An unattended delivery might require the package to be protected from the elements, whether rain, snow, heat, cold, or sunshine, among other conditions.

In an exemplary configuration, an autonomous vehicle picks up packages from package delivery vendor or a costumer of the package delivery vendor, and deliver the package to a desired destination autonomously with supervision. In an aspect, the autonomous vehicle is docked at a base station in which the autonomous vehicle is secured when not in use. At the docking station, power is recharged and/or swapped out. In an aspect, a remote operator or user or customer of the vendor enters a request to deliver a package to a desired location along a pre-mapped route. In an aspect, a fleet management system receives the request and allocates an autonomous vehicle, and possibly a delivery truck, to perform the delivery. In an aspect, the fleet management system calculates a route from the base station to the pickup point and then on to the drop off location. In an aspect, the route is reviewed and approved by an operator. In an aspect, the fleet management system generates a navigation package that contains the pickup and drop off locations for the package, a valid route containing the drivable surfaces, curbs, intersections and traffic signals, and identification information for the delivery that could be used to for the package to self-identify. In an aspect, the fleet management system supplies the navigation package to the autonomous vehicle while the autonomous vehicle is at a base station, possibly a docking station. If the same route is repeatedly run, the navigation package is pre-loaded on the autonomous vehicle.

In an aspect, a remote operator ensures that the remote control for the autonomous vehicle is active and working properly. The operator can enable autonomous driving on the autonomous vehicle. The autonomous vehicle leaves its base station and proceeds to the pickup point. This can include driving with the sidewalk traffic or with the road traffic. The autonomous vehicle stops at the pickup point, disables autonomous driving and requests the pickup on the screen from the package recipient. When the package recipient shows the correct identifying information to the autonomous vehicle or sends the appropriate command using handheld device/laptop/tablet/desktop computer, the cargo box door opens. The autonomous vehicle closes the cargo box door when the appropriate identifying information is provided to the autonomous vehicle or the autonomous vehicle receives the appropriate command from a computing device. The autonomous vehicle signals the remote control operator and waits for the operator to enable autonomous driving.

The autonomous vehicle can travel on the sidewalk and the road to the drop off location possibly autonomously or under supervision of the remote control operator. The autonomous vehicle continuously monitors the link to the remote control operator and can optionally bring the autonomous vehicle to a standstill if the link is dropped. While navigating with road traffic, the autonomous vehicle navigates around vehicles parked on the side of the road and avoids road obstacles like pedestrians and other vehicles. On the sidewalk the autonomous vehicle is expected to interact with pedestrians, animals and other sidewalk obstacles. Where the autonomous vehicle is expected to cross traffic intersections the autonomous vehicle can come to a complete stop and alert the remote control operator, or navigate autonomously through the intersection. If the intersection is to be navigated remotely, the remote control operator confirms that there is sufficient cellular signal that the remote operator does not expect the cellular signal to be dropped and at complex intersections can drive the autonomous vehicle across the intersection.

On arrival at the drop off location the autonomous vehicle stops and displays the appropriate screen waiting for the recipient to show the correct identifying information to the device or to send the appropriate command using computing device. When shown the correct identifying information, the autonomous vehicle opens the appropriate door and waits for the recipient to remove the package. When the recipient signals that the package has been removed by showing identifying information or by sending a command using computing device, the cargo box the door closes and the autonomous vehicle alerts the remote control operator. The remote control operator enables the return route on the autonomous vehicle and the autonomous vehicle returns to the base or docking station in a similar fashion as what was described above.

The autonomous vehicle relies on redundant sensors that allow an expansive view of the environment across a range of lighting and weather conditions. The autonomous driving system uses complex software to detect and categorize other road users and static obstacles and relies on advanced control systems to safely and courteously plan a path through these to efficiently reach a desired destination.

The autonomous driving system for the autonomous vehicle relies on redundant processing of sensor information to ensure safe operation of the device. All the sensor information is processed in the perception system through both machine learning algorithms and traditional image and point cloud processing algorithms. This information is combined before being used by the path planning system. The path planning system for the trail includes a free space planner that does not produce a path that is in collision. A parallel emergency stop detection algorithm uses a close range sensor to detect possible collisions and bring the device to a stop.

The system of the present teachings for an autonomous delivery vehicle can include, but is not limited to including, a vehicle having a pre-selected length, width, and height, such as, for example, but not limited to, 40″×28″×62″, having a pre-selected payload capacity, such as, for example, but not limited to, 100 pounds. The vehicle can travel without recharge of its battery for a pre-selected amount of time, for example, but not limited to, twelve hours, and its battery can recharge in a pre-selected amount of time, for example, but not limited to, 1.5 hours from empty. To enable delivery to destinations that require traveling over pedestrian and vehicular pathways, the vehicle can navigate discontinuous surfaces of a pre-selected height and inclines/declines of pre-selected angles, and can avoid obstacles and change directions based on obstacles in real-time. The pre-selected discontinuous surface height can include, but is not limited to including, six inches. The pre-selected angles can include, but are not limited to including, 20° straight up and down, and 12° turning. The vehicle can turn inside the vehicle's footprint, for example, but not limited to, a radius of 24 inches. The vehicle can include a variety of sensors, for example, but not limited to, radar, LIDAR, ultrasonic sensors, and cameras.

What is needed are systems and methods that can provide unattended secure autonomous delivery, taking the foregoing situations into account. What is further needed is a way to add storage capacity to the autonomous vehicle.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for autonomous unattended package delivery. The method also includes receiving a package into a cargo area of an autonomous vehicle (av), the cargo area including a secure container; receiving a desired destination for the package; autonomously commanding the av to navigate to the desired destination; and autonomously deploying the secure container containing the package from the av at the desired destination, the desired destination being unattended. Other embodiments of this aspect include corresponding computer systems, apparatus, and computer programs recorded on one or more computer storage devices, each configured to perform the actions of the methods.

Implementations may include one or more of the following features. The method as where autonomously receiving the package may include: adjusting security settings on the secure container achieving may include between the desired destination and the secure container. Autonomously deploying the package may include: opening the cargo area, autonomously moving the secure container out of the cargo area using a deployment device, commanding the deployment device to move the secure container to a surface outside of the av, continuously determining a position of the secure container, disengaging the secure container from the deployment device when the secure container reaches the surface, retracting the deployment device into the cargo area, and closing the cargo area. The deployment device may include: a crane. The deployment device may include: a forklift. The deployment device may include: a robotic arm. The deployment device may include: a rotating linkage. The deployment device may include: an extendable ramp. The deployment device may include: a plurality of cables deployed from telescopic arms. The deployment device may include: a plurality of rollers operably coupled with a sail. The cargo area may include: an at least partially-covered region of the ay. The secure container may include: at least one secure entry device, at least one location sensing device, at least one camera, at least one alarm system, and at least one device coupling the deployment device with the secure container. The at least one secure entry device may include: a keypad. The at least one location sensing device may include: a gps. The at least one camera may include: a 360° imaging camera. The at least one alarm system may include: an audio tampering alert device. Autonomously navigating the av to the desired destination may include: determining a route between a location of the av and the desired destination, continuously determining free space for navigation of the av in proximity to the route, and commanding the av to traverse the free space. Determining the route may include: reading package identifying information associated with the package, the package identifying information including the desired destination. The method as may include: autonomously picking up a second package at the desired destination, determining a second desired destination from identifying information on the second package, and navigating to the second desired destination. Implementations of the described techniques may include hardware, a method or process, or computer software on a computer-accessible medium.

One general aspect includes a system for autonomous unattended package delivery. The system also includes an autonomous vehicle (av) having a cargo area; a receiver on the av configured to receive a desired destination for a package; a deployment device associated with the cargo area, the deployment device configured to deploy the package at the desired destination; a plurality of sensors configured to receive sensor information about an environment surrounding the av; a controller configured to determine a route between a location of the av and the desired destination; continuously determine free navigation space along the route based at least one the sensor information; autonomously generate commands to navigate the av in the free navigation space to the desired destination; autonomously generate the commands to deploy the package; autonomously re-store the deployment device; and autonomously provide a notification when the package has completed deployment. Other embodiments of this aspect include corresponding computer systems, apparatus, and computer programs recorded on one or more computer storage devices, each configured to perform the actions of the methods.

One general aspect includes a trailer for autonomous package delivery. The trailer also includes a mast configured to mount a cargo box; a hitch cross configured to connect the trailer to a towing vehicle; a frame structure configured to operably couple with the mast at a first end, the frame structure configured to operably couple with the hitch cross at a second end; and a tie rod configured to operably couple with the mast at a third end, the tie rod configured to operably couple with the hitch cross at a fourth end. The trailer also includes where the mast, the hitch cross, the frame structure, and the tie rod are configured to form rigid elements of a 4-bar linkage, the 4-bar linkage maintaining may include pitch between the cargo box and a cargo hold of the towing vehicle. Other embodiments of this aspect include corresponding computer systems, apparatus, and computer programs recorded on one or more computer storage devices, each configured to perform the actions of the methods.

Implementations may include one or more of the following features. The trailer as may include: at least two wheels decoupled from the 4-bar linkage, the at least two wheels bearing a load in the trailer. The trailer as may include: swing arms configured to operably couple with wheels, the wheels bearing a load in the trailer. The trailer as may include: shocks configured to operably couple with wheels, the wheels bearing a load in the trailer. The trailer as may include: springs surrounding the tie rod, the springs buffering fore and aft motion of the frame structure. The trailer as may include: a steering damper operably coupled with the frame structure. Implementations of the described techniques may include hardware, a method or process, or computer software on a computer-accessible medium.

One general aspect includes a delivery arm assembly for moving cargo autonomously from a cargo area. The delivery arm assembly also includes a motor. The assembly also includes a sector gear driven by the motor. The assembly also includes at least one delivery arm operably coupled with the sector gear. The assembly also includes a gear train coupled with the sector gear, the gear train configured to transfer power from the motor to the at least one delivery arm. The assembly also includes where the motor, the sector gear, the at least one delivery arm, and the gear train are configured to occupy the cargo area. Other embodiments of this aspect include corresponding computer systems, apparatus, and computer programs recorded on one or more computer storage devices, each configured to perform the actions of the methods.

Implementations may include one or more of the following features. The delivery arm assembly as where the cargo area may include: a cavity in an autonomous vehicle. The at least one delivery arm may include: a base plate, and at least one extension tube configured to extend a length of the base plate. The at least one delivery arm may include: a latch configured to operably couple with a cargo box delivery device. The cargo box delivery device may include: a pin. The delivery arm assembly as may include: a geared cross shaft configured to rotate when the motor is activated, the geared cross shaft operably coupling a first of the at least one delivery arm with a second of the at least one delivery arm. The delivery arm assembly as may include: at least one rotation restriction device configured to limit a rotation of the sector gear. The at least one rotation restriction device may include: at least one standoff. The delivery arm assembly as may include: at least one switch. Implementations of the described techniques may include hardware, a method or process, or computer software on a computer-accessible medium.

One general aspect includes a delivery arm assembly for moving cargo autonomously from a cargo area. The delivery arm assembly also includes a motor; a drive gear configured to be rotated by the motor; at least one delivery arm; and a spur gear configured to be driven by the drive gear, the spur gear configured to drive the at least one delivery arm. The assembly also includes where the motor, the drive gear, the at least one delivery arm, and the spur gear are configured to occupy the cargo area. Other embodiments of this aspect include corresponding computer systems, apparatus, and computer programs recorded on one or more computer storage devices, each configured to perform the actions of the methods.

Implementations may include one or more of the following features. The delivery arm assembly as where the at least one delivery arm may include: at least one extension tube configured to move when the spur gear rotates; and at least one roller guide plate including at least one cam channel, where the at least one delivery arm is slidingly coupled with the at least one extension tube, the at least one delivery arm including a cam follower, the cam follower traveling in the at least one cam channel as the at least one extension tube moves. The delivery arm assembly as may include: a geared cross shaft configured to rotate when the motor is activated, the geared cross shaft operably coupling a first of the at least one delivery arm with a second of the at least one delivery arm. Implementations of the described techniques may include hardware, a method or process, or computer software on a computer-accessible medium.

One general aspect includes . The secure cargo container also includes at least one secure entry device; at least one location sensing device, at least one camera, at least one alarm system, and at least one device coupling a deployment device with the secure cargo container. Other embodiments of this aspect include corresponding computer systems, apparatus, and computer programs recorded on one or more computer storage devices, each configured to perform the actions of the methods.

Implementations may include one or more of the following features. The secure cargo container as where the at least one secure entry device may include: a keypad. The at least one location sensing device may include: a gps. The at least one camera may include: a 360° imaging camera. The at least one alarm system may include: an audio tampering alert device. The secure cargo container as may include: at least one connection point configured to accept the deployment device. The secure cargo container as may include: at least one shock absorber configured to buffer movement of contents of the secure cargo container. The secure cargo container as may include: at least one fold line configured to enable collapsibility of the secure cargo container. The secure cargo container as may include: at least one hinge configured to enable collapsibility of the secure cargo container. Implementations of the described techniques may include hardware, a method or process, or computer software on a computer-accessible medium.

One general aspect includes. The cargo container also includes an outer shell having an outer skin and at least one end skin, the outer skin having a first end and a second end; a top panel situated between a first of the at least one end skin and the first end; a tote tray situated between a second of the at least one end skin and the second end; an inner skin operably coupled with the tote tray; and a plurality of side panels situated between the outer skin and the inner skin, the plurality of side panels configured to enable collapsibility of the cargo container. Other embodiments of this aspect include corresponding computer systems, apparatus, and computer programs recorded on one or more computer storage devices, each configured to perform the actions of the methods.

Implementations may include one or more of the following features. The cargo container as may include: a tote device configured to operably couple with a lift device. The tote device may include: a pin. The cargo container as may include: at least one camera. The cargo container as may include: at least one alarm system. The cargo container as may include: at least one handle. Implementations of the described techniques may include hardware, a method or process, or computer software on a computer-accessible medium.

One general aspect includes a container drop. The container also includes a plurality of panels; at least one actuator; at least two link arms configured at an angle with respect to each other, the at least two link arms configured to move under control of the at least one actuator; and at least two corners operably coupled with the at least two link arms, the at least two corners traveling in opposite directions from each other when at least one of the at least two link arms moves, the at least two corners traveling along an edge of at least one of the plurality of panels, where the at least two corners release a container when the angle increases past a threshold value. Other embodiments of this aspect include corresponding computer systems, apparatus, and computer programs recorded on one or more computer storage devices, each configured to perform the actions of the methods.

Implementations may include one or more of the following features. The container drop system as may include: at least one lift device. The lift device may include: at least one pin. The plurality of panels may include: a first panel; a second panel configured to be larger than the first panel; and a plurality of third panels operably coupling the first panel with the second panel, the plurality of third panels providing at least one cavity for the at least one lift device. The first panel may include: at least one cavity configured to allow a passage of one of the at least two corners. The second panel may include: at least one cavity configured to allow a passage of one of the at least two corners. Implementations of the described techniques may include hardware, a method or process, or computer software on a computer-accessible medium.

One general aspect includes . The delivery system also includes at least one long haul vehicle controller associated with at least one long haul vehicle; at least one autonomous vehicle controller associated with at least one autonomous vehicle, the at least one autonomous vehicle controller configured to communicate with the at least one long haul device controller, the at least one autonomous vehicle controller executing instructions including: issuing a summons to the at least one long haul vehicle controller; issuing at least one command to the at least one autonomous vehicle, the at least one command configured to receive into the at least one autonomous vehicle a delivery from the at least one long haul vehicle; issuing at least one movement command to the at least one autonomous vehicle, the at least one movement command navigating the at least one autonomous vehicle to a delivery location; and issuing the at least one command to the at least one autonomous vehicle, the at least one command configured to enable delivery at the delivery location. Other embodiments of this aspect include corresponding computer systems, apparatus, and computer programs recorded on one or more computer storage devices, each configured to perform the actions of the methods.

Implementations may include one or more of the following features. The delivery system as may include: at least one trailer configured to operably couple with the autonomous vehicle. The at least one trailer may include: at least one power supply. The at least one power supply may include: a replacement power supply for an autonomous vehicle power supply. The at least one power supply may include: at least one battery. The at least one trailer may include: a mast configured to mount a cargo box; a hitch cross configured to connect the trailer to a towing vehicle; a frame structure configured to operably couple with the mast at a first end, the frame structure configured to operably couple with the hitch cross at a second end; and a tie rod configured to operably couple with the mast at a third end, the tie rod configured to operably couple with the hitch cross at a fourth end, where the mast, the hitch cross, the frame structure, and the tie rod are configured to form rigid elements of a 4-bar linkage, the 4-bar linkage maintaining may include pitch between the cargo box and a cargo hold of the towing vehicle. The at least one trailer may include: at least two wheels decoupled from the 4-bar linkage, the at least two wheels bearing a load in the trailer. The at least one trailer may include: swing arms configured to operably couple with wheels, the wheels bearing a load in the trailer. The at least one trailer may include: shocks configured to operably couple with wheels, the wheels bearing a load in the trailer. The at least one trailer may include: springs surrounding the tie rod, the springs buffering fore and aft motion of the frame structure. The at least one trailer may include: a steering damper operably coupled with the frame structure. The delivery system as may include: at least one scheduler communicatively coupled with the at least one autonomous vehicle, the at least one scheduler communicating a delivery schedule to the at least one autonomous vehicle controller. The delivery system as may include: at least one scheduler communicatively coupled with the at least one long haul vehicle, the at least one scheduler communicating a delivery schedule to the at least one long haul vehicle controller. Implementations of the described techniques may include hardware, a method or process, or computer software on a computer-accessible medium.

One general aspect includes a method for managing a delivery of goods autonomously. The method also includes determining, by an autonomous vehicle, an issue with the autonomous vehicle. The method also includes if the issue is autonomous vehicle disability, requesting, by the autonomous vehicle, assistance from a delivery truck, the delivery truck configured to carry the autonomous vehicle. The method also includes if the issue is autonomous vehicle transportation needs for making at least one delivery, requesting, by the autonomous vehicle, the delivery truck that meets first pre-selected delivery criteria. The method also includes if the issue is that the autonomous vehicle needs more of the goods to deliver, requesting, by the autonomous vehicle, the delivery truck containing the goods that meet second pre-selected delivery criteria. Other embodiments of this aspect include corresponding computer systems, apparatus, and computer programs recorded on one or more computer storage devices, each configured to perform the actions of the methods.

Implementations may include one or more of the following features. The method as where the first pre-selected delivery criteria may include: a proximity of the delivery truck to the autonomous vehicle, and the proximity of the delivery truck to at least one delivery destination of the goods. The second pre-selected delivery criteria may include: substantial proximity of the delivery truck to at least one delivery destination of the goods. The method as may include: summoning the delivery truck based on a state table, the state table configured to direct the autonomous vehicle to summon the delivery truck under pre-selected conditions. The method as may include: updating the state table dynamically. The state table may include: a set of pre-selected states. The method as may include: receiving amendments to the state table from a user or a remote operator. The method as may include: directing, by the autonomous vehicle, the delivery truck to open at least one door to a cargo area in the delivery truck; directing, by the autonomous vehicle, a lift device within the delivery truck to locate the autonomous vehicle; and commanding, by the autonomous vehicle, the lift device to lift the autonomous vehicle into the delivery truck. The method as may include: labeling the goods electronically with at least one characteristic of the goods. The method as may include: scanning, by the autonomous vehicle, the at least one characteristic; and determining a route to at least one delivery destination based on the at least one characteristic. The method as may include: moving the goods from the autonomous vehicle to the delivery truck autonomously using delivery arms in the autonomous vehicle. The method as may include: positioning a loading device within the delivery truck to deliver the goods to the autonomous vehicle. The method as may include: opening, by the autonomous vehicle, autonomous vehicle doors of the autonomous vehicle to open towards truck doors of the delivery truck. The method as may include: moving, by the autonomous vehicle, the goods from the delivery truck to the autonomous vehicle. The method as may include: moving, by the autonomous vehicle, the goods from an autonomous vehicle trailer to the delivery truck. The method as may include: moving, by the delivery truck, the goods from an autonomous device trailer to the delivery truck. The method as may include: navigating the autonomous vehicle to at least one delivery destination. Implementations of the described techniques may include hardware, a method or process, or computer software on a computer-accessible medium.

One general aspect includes a method for managing a pickup of goods autonomously. The method also includes determining, by an autonomous vehicle, an issue with the autonomous vehicle. The method also includes if the issue is autonomous vehicle disability, requesting, by the autonomous vehicle, assistance from a truck, the truck configured to carry the autonomous vehicle. The method also includes if the issue is autonomous vehicle transportation needs for making at least one pickup, requesting, by the autonomous vehicle, the truck that meets first pre-selected pickup criteria. The method also includes if the issue is that the autonomous vehicle needs more space to hold the goods that have been picked up, requesting, by the autonomous vehicle, the truck that meet second pre-selected pickup criteria. Other embodiments of this aspect include corresponding computer systems, apparatus, and computer programs recorded on one or more computer storage devices, each configured to perform the actions of the methods.

Implementations may include one or more of the following features. The method as where the first pre-selected pickup criteria may include: a substantial proximity of the truck to the autonomous vehicle, and the substantial proximity of the truck to at least one pickup destination. The second pre-selected pickup criteria may include: substantial proximity of the truck to at least one pickup destination. The method as may include: summoning the truck based on a state table, the state table configured to direct the autonomous vehicle to summon the truck under pre-selected conditions. The method as may include: updating the state table dynamically. The state table may include: a set of pre-selected states. The method as may include: receiving amendments to the state table from a user or a remote operator. The method as may include: directing, by the autonomous vehicle, the truck to open at least one door to a cargo area in the truck; directing, by the autonomous vehicle, a lift device within the truck to locate the autonomous vehicle; and commanding, by the autonomous vehicle, the lift device to lift the autonomous vehicle into the truck. The method as may include: scanning, by the autonomous vehicle, an electronic label on the goods, the electronic label having at least one characteristic; and determining a route to at least one delivery destination based on the at least one characteristic. The method as may include: moving the goods from the autonomous vehicle to the truck autonomously using delivery arms in the autonomous vehicle. The method as may include: positioning a loading device within the truck to receive the goods from the autonomous vehicle. The method as may include: opening, by the autonomous vehicle, autonomous vehicle doors of the autonomous vehicle to open towards truck doors of the truck. The method as may include: moving, by the autonomous vehicle, the goods to the truck from the autonomous vehicle. The method as may include: moving, by the autonomous vehicle, the goods from an autonomous vehicle trailer to the truck. The method as may include: moving, by the truck, the goods from an autonomous device trailer to the truck. The method as may include: navigating the autonomous vehicle to at least one delivery destination. Implementations of the described techniques may include hardware, a method or process, or computer software on a computer-accessible medium.

### BRIEF DESCRIPTION OF THE DRAWINGS

The present teachings will be more readily understood by reference to the following description, taken with the accompanying drawings, in which:

FIG. 1A is a pictorial representation of unattended delivery of a regularly-shaped package with hidden or no security features;

FIG. 1B is a pictorial representation of unattended delivery of a regularly-shaped package with visible security features;

FIG. 1C is a pictorial representation of unattended delivery of an irregularly-shaped package with hidden or no security features;

FIG. 1D is a pictorial representation of unattended delivery of an irregularly-shaped package with visible security features;

FIGS. 2A and 2B are pictorial representations of unattended delivery of a package using a crane deployment mechanism;

FIGS. 2C and 2D are pictorial representations of unattended delivery of a package using a delivery arms or a forklift deployment mechanism;

FIGS. 3A and 3B are pictorial representations of unattended delivery of a package using a robotic arm and package release mechanisms deployment mechanism;

FIG. 4 is a pictorial representation of unattended delivery of a package using a ramp deployment mechanism;

FIGS. 5A-5D are pictorial representations of unattended delivery of a package using an exemplary autonomous vehicle, side door delivery, and a retractable package release mechanism;

FIGS. 5E and 5F are pictorial representations of unattended delivery of a package using an exemplary autonomous vehicle, side door delivery, and a retractable arms/ropes deployment mechanism;

FIG. 5G is a pictorial representation of unattended delivery of a package using an arm/sail deployment mechanism;

FIGS. 6A and 6B are pictorial representations of unattended delivery of a package using an open/convertible, tiltable exemplary autonomous vehicle, rear delivery, a wheeled delivery container, and a retractable ramp deployment mechanism;

FIGS. 7A-7N are schematic diagrams of an exemplary configuration of an unattended delivery/pickup apparatus of the present teachings;

FIGS. 8A-8C are schematic diagrams of a second configuration of an unattended delivery/pickup apparatus of the present teachings;

FIGS. 9A-9D are schematic diagrams of a third configuration of an unattended delivery/pickup apparatus of the present teachings;

FIGS. 10A-10E are flowcharts of the method of the present teachings for unattended delivery of a package;

FIG. 11 is a schematic block diagram of the system of the present teachings for unattended delivery of a package;

FIG. 12 is a pictorial representation of the trailer of the present teachings towed by a towing vehicle over challenging terrain;

FIG. 13 is a pictorial representation of the trailer of the present teachings towed by a towing vehicle over relatively smooth terrain;

FIGS. 14A and 14B are schematic diagrams of a configuration of the trailer of the present teachings being towed by a towing vehicle over challenging terrain and relatively smooth terrain, respectively;

FIGS. 15A and 15B are schematic perspective diagrams of a configuration of the trailer of the present teachings illustrating the connection to the towing vehicle and the wheel connections, respectively;

FIG. 16 is a schematic perspective diagram of a configuration of the connection to the towing vehicle;

FIG. 17 is a schematic perspective diagram of a configuration of the trailer of the present teachings;

FIG. 18 is a schematic perspective diagram of a configuration of the mast and frame of the trailer of the present teachings;

FIGS. 19A and 19B are schematic diagrams of a configuration of the tie rod and springs of the present teachings;

FIGS. 19C and 19D are cross section diagrams of a configuration of the 4-bar linkage of the present teachings;

FIG. 20 is a perspective schematic diagram of a configuration of the mounted tie rod of the present teachings;

FIGS. 21A and 21B are pictorial representations of a secure delivery container of the present teachings, open and closed, with visible security and grasping features;

FIGS. 21C-21E are pictorial representations of security features of the secure delivery container of the present teachings;

FIGS. 21F and 21G are pictorial representations of other features of the secure delivery container of the present teachings;

FIGS. 22A-22D are pictorial representations of another configuration of a collapsible secure delivery container of the present teachings with compact security features;

FIG. 22E shows pictorial representations of another configuration of a collapsible secure delivery container of the present teachings with security and grasping features;

FIG. 22F shows pictorial representations of the configuration of FIG. 22E also including shock absorbing features;

FIGS. 22G-22M are pictorial representations of yet another configuration of a collapsible/stackable secure delivery container of the present teachings with partially-visible security features;

FIGS. 22N and 22O are pictorial representations of a configuration of an irregularly-shaped secure delivery container of the present teachings, closed and open, with partially-visible security features;

FIGS. 23A-23B are exploded and cross section diagrams of an exemplary configuration of collapsible cargo box of the present teachings;

FIG. 24 is an exemplary collapsed cargo box of the present teachings;

FIGS. 25A-25D are pictorial and schematic diagrams of an exemplary configuration of an open-topped cargo container of the present teachings;

FIG. 26 is an exemplary configuration of an exemplary open-bottomed cargo lift of the present teachings; and

FIGS. 27A-27D are schematic block diagrams of cargo truck/autonomous vehicle use cases.

### DETAILED DESCRIPTION

The autonomous vehicle (AV), delivery container, and optional trailer of the present teachings can, separately or in combination, enable unattended delivery of packages. The AV can safely deploy its contents, and the contents can be housed in a reusable secure delivery container. In an aspect, the AV can include autonomous navigation features such as, for example, but not limited to, sensors, lights, day and night operation, requesting remote control monitoring in high risk areas, and autonomous navigation of discontinuous surface features. Other autonomous navigation features can include user-defined operating routes, manual operation, autonomous driving to a charging station, no chaperone required, and wireless connection between the AV and a central station. In an aspect, the AV can open its doors automatically, including doors with keycard access, require no full-time remote operator. In an aspect, the AV can navigate around objects and navigate on both pedestrian and vehicular roadways. In an aspect, the AV can include the ability to traverse rough terrain.

The delivery container can include, for example, but not limited to, environmental shielding and theft protection, for example. In an aspect, the bottom, sides, and top of the delivery container can include waterproof material, and the inside of the container can include insulation. The delivery container can include cameras, sensors, communications, audio and visual output, battery power, and security features. In an aspect, the cameras can show who is tampering with the container, and the sensors can detect the environment of the container. Communications means can be used to communicate with the owner of the box, and can include Bluetooth and wifi. If the container is tampered with by an unauthorized user, the container can automatically protect itself from being moved. Audio output, for example, and an accelerometer can be used to discourage would-be thieves from moving the container without permission. The container can include GPS that can be used to track the container. The container can be collapsible, and can be returned to the supplier for reuse.

The trailer can include additional storage to the autonomous vehicle, additional power supplies, and stabilization features that can enable increased speed of the autonomous vehicle. The trailer can include a means for connection to the autonomous vehicle that can coordinate the movement and orientation between the autonomous vehicle and the trailer. The trailer can be open or closed.

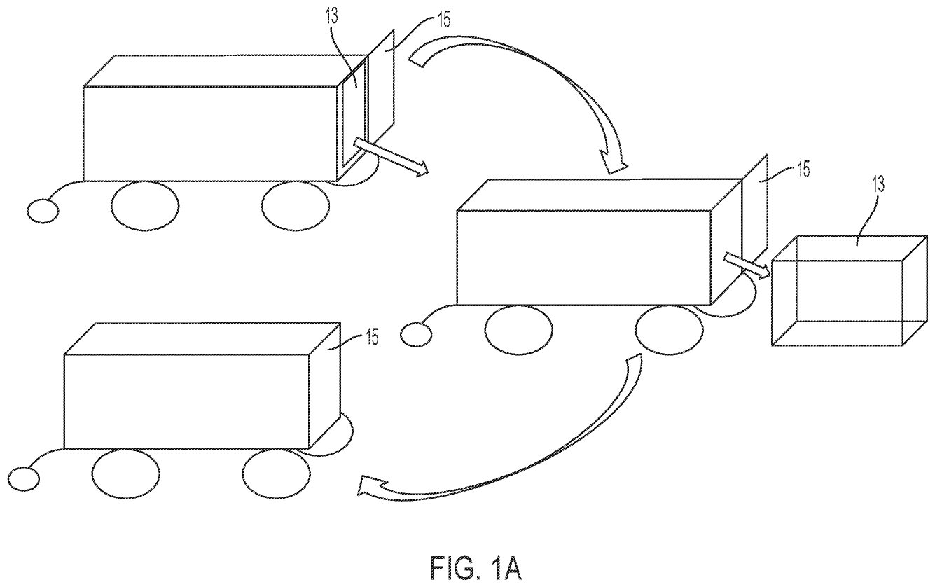

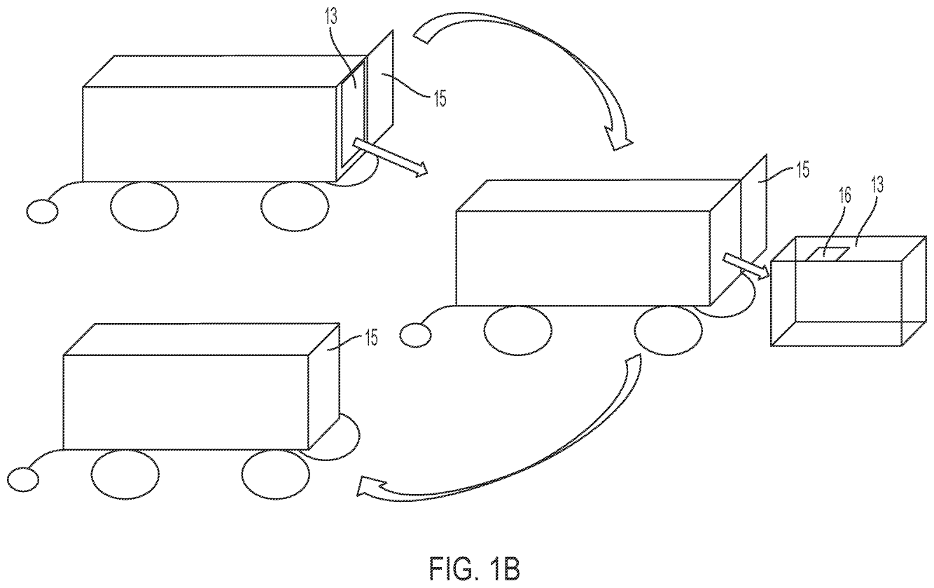

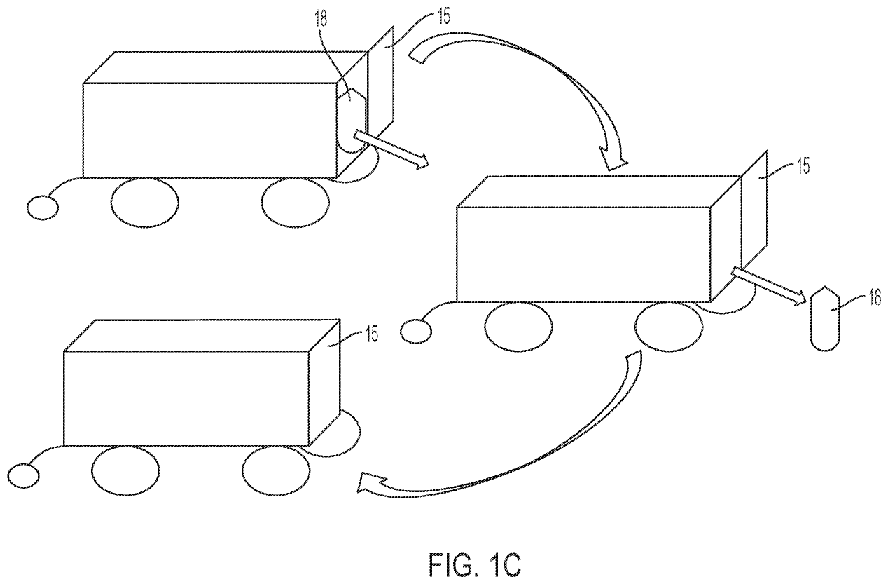

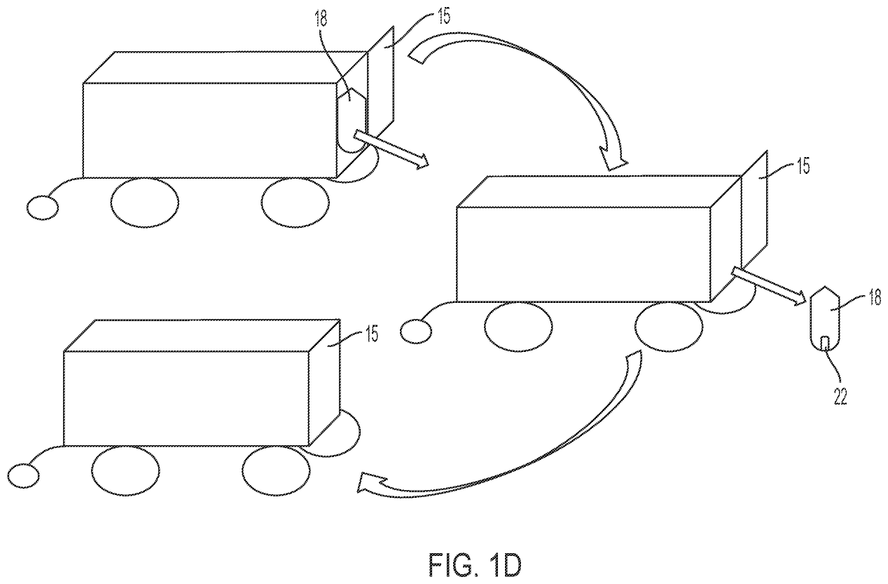

Referring now to FIGS. 1A-1D, an apparatus of the present teachings for accomplishing unattended delivery and/or pickup of cargo can include, but is not limited to including, at least two major parts: an autonomous vehicle (AV) having a cargo area and, possibly optionally, secure cargo container 13 containing the cargo to be delivered or picked up. The AV can be outfitted in various ways to move the cargo from inside the AV cargo area to a delivery location without the assistance from the desired recipient or provider of the cargo. In an aspect, providing unattended delivery or pickup (also referred to herein as no-touch cargo manipulation) from/to an autonomous vehicle (AV) includes managing balance of the AV as the cargo is being lowered, managing space considerations in the cargo box, determining autonomously when to open and close door(s) 15, and determining autonomously when the cargo has been successfully moved from the AV to its desired location or from the target location to the AV.

Continuing to refer to FIGS. 1A-1D, with respect to managing weight and balance considerations, in some configurations, the AV automatically shifts its weight to balance the various positions that the cargo takes while it is being moved from the AV to the desired delivery location. In some configurations, on-board weights are automatically shifted within the cargo box to advantageously balance the cargo. In some configurations, the cargo weight is limited based at least on the weight of the AV itself, and the weight distribution of the AV. Other means of weight management are contemplated by the present teachings.

Continuing to refer to FIGS. 1A-1D, with respect to managing space considerations, in an aspect, the apparatus that achieves unattended delivery/pickup is positioned advantageously within the cargo area of the AV to maximize free space for one or more delivery containers positioned in the cargo area. In an aspect, the cargo area itself is shaped to accommodate the expected cargo load. For example, as described herein, the cargo area can be square, rectangular, open-topped, or many other geometric possibilities. Delivery containers 18 can be sized and shaped according to what they are to carry, can include delivery mechanisms 22, and can be delivered from an appropriately-sized cargo area.

Continuing to still further refer to FIGS. 1A-1D, with respect to determining autonomously when to open and close the doors of the cargo area, or otherwise initiate delivery/pickup of the cargo, in an aspect, the AV is equipped with sensors, processors, controllers, and actuators that manage the AV's arrival at the desired location, the AV's manipulation of the cargo, and the AV's completing the process and moving to another location, possibly to make another delivery or pick up more cargo to deliver. In an aspect, when the AV arrives at a deployment location, the arrival triggers a cargo manipulation process. In one aspect, the cargo manipulation process includes the AV's controller commanding a door actuator(s) to open at least one door on the AV. Doors can be positioned on any part of the AV—front, rear, sides, top, or bottom. The doors and the cargo manipulation mechanisms can be operably coupled so that the same actuator(s) can control both the status of the doors and the extension and retraction, or other movement, of the cargo manipulation mechanism. The doors and cargo manipulation mechanism can move simultaneously.

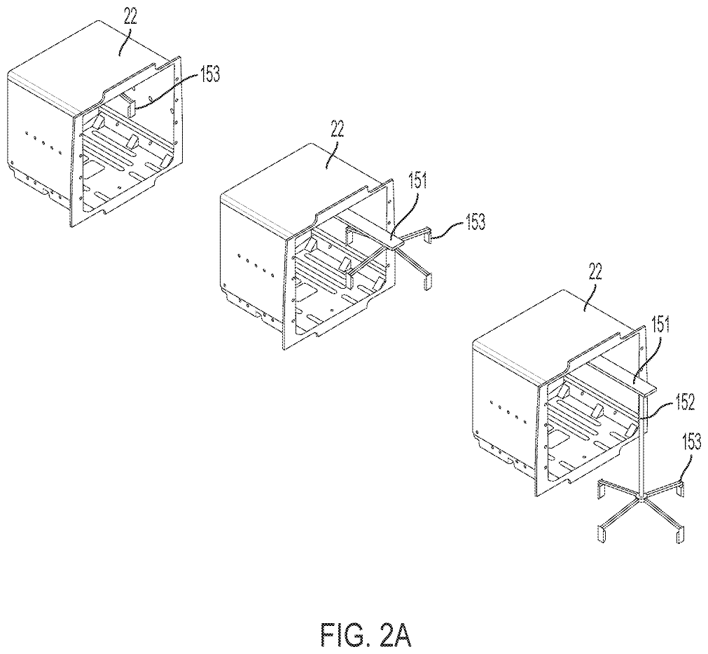

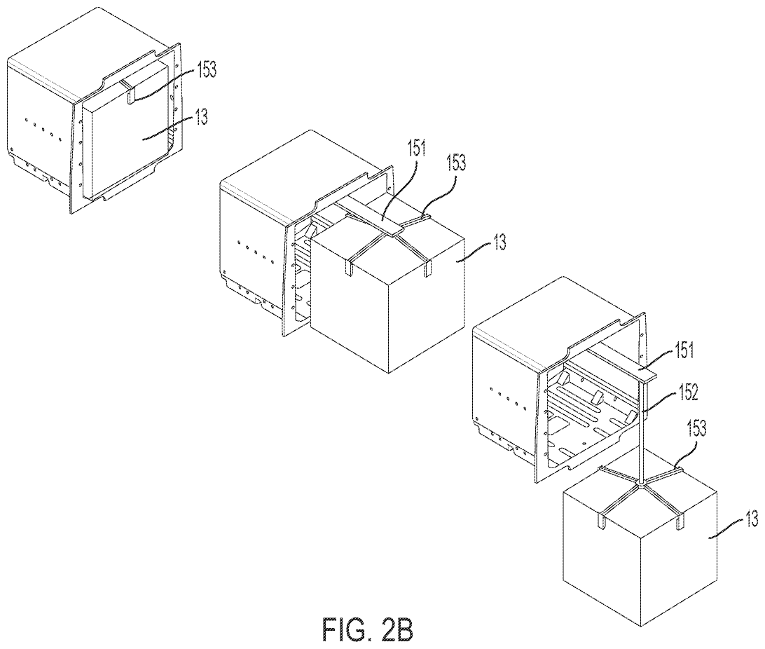

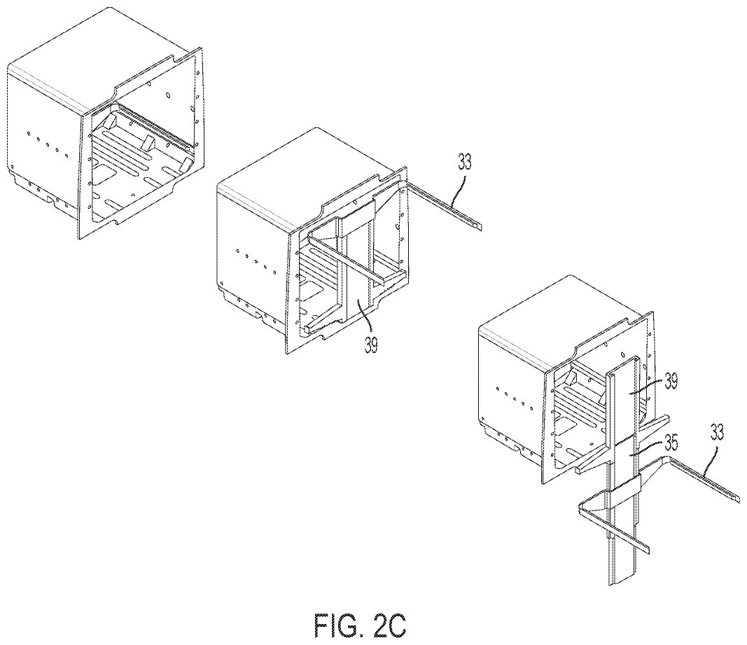

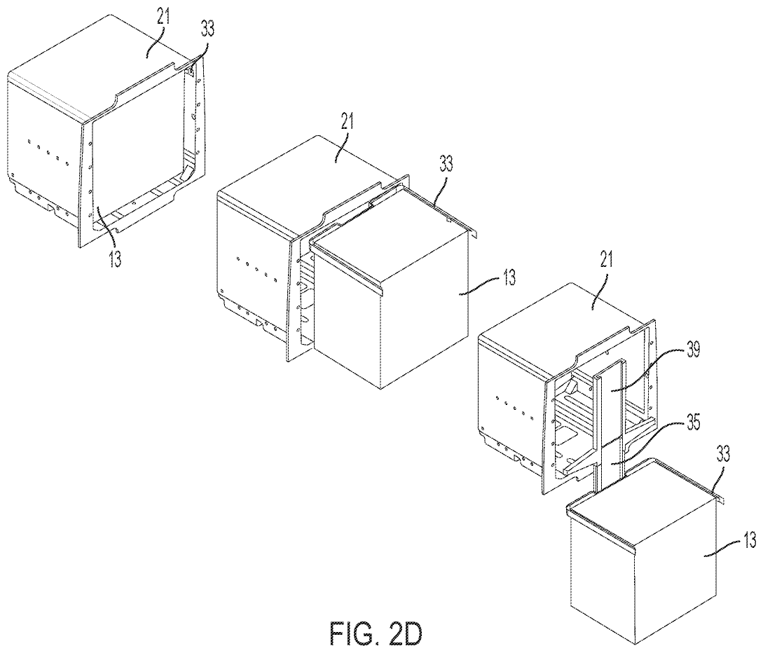

Referring now to FIGS. 2A-2B, a first exemplary configuration in which a no-touch, unattended cargo drop can be accomplished includes a crane-like apparatus attached to the interior of the cargo box. In an aspect, the apparatus includes package release mechanisms 153 that hold cargo 13 (FIG. 2B) while the crane lowers cargo 13 to the ground. At least one door of the cargo box can automatically open, package release mechanisms 153 can grab cargo 13 (FIG. 2B) and exit a cargo door with cargo 13 (FIG. 2B) in tow, and the crane can lower cargo 13 (FIG. 2B) to a surface. Package release mechanisms 153 can release their hold on cargo 13 (FIG. 2B), the crane can be raised to a storage level, and the crane and package release mechanisms 153 can be returned to the cargo box for storage. In an aspect, the crane can be attached to the outside of the AV, and can be deployed from there to retrieve cargo 13 (FIG. 2B) from inside the cargo box or the ground, for example. In some configurations, the externally-stored crane can enter the cargo box from a first door, and exit the cargo box with cargo 13 (FIG. 2B) in tow from another door. In some configurations, a door from which cargo 13 (FIG. 2B) exits can be determined when the AV arrives at the desired destination and can depend upon the current conditions as sensed by the sensors mounted upon the AV. Sensors inside the cargo box can determine the size of cargo 13 (FIG. 2B). In an aspect, sensed and other data are used to direct the crane to be positioned so that package release mechanisms 153 can properly grab cargo 13 (FIG. 2B), whether vertically, horizontally, or both. In some configurations, the crane-to-cargo connection mechanism includes suction cups, magnets, or any releasable connector. In an aspect, telescoping arm 151 is stored in a retracted position as the AV transports cargo 13 (FIG. 2B) to a desired destination. In an aspect, telescoping arm 151 is moved by an actuator, possibly the actuator used to open and close the AV door from which cargo 13 (FIG. 2B) emerges. In an aspect, telescoping arm 151 extends, causing cargo 13 (FIG. 2B) to be moved outside the cargo box, to a pre-selected length of lowering device 152, to a length determined by the position of cargo 13 (FIG. 2B), or to a length supplied by a user remotely, for example. When cargo 13 (FIG. 2B) has been deployed, in an aspect, the actuator raises package release mechanisms 153, retracts arm 151, and closes the door(s). In an aspect, a controller operably coupled with sensors that detects the position of cargo 13 (FIG. 2B) determines if manipulation of cargo 13 (FIG. 2B) has completed by accessing default timing values, or by determining, based on sensor information, if cargo 13 (FIG. 2B) has reached a desired surface and the manipulation mechanism has disengaged with cargo 13 (FIG. 2B). In an aspect, a deployment location is requested by a user, and the vertical distance from the cargo area to the deposit surface is determined by sensors on the AV. For example, the crane can automatically discontinue its downward movement when some resistance is met equivalent to the resistance that would be encountered if cargo 13 (FIG. 2B) reached a surface. In another aspect, the crane is lowered a preselected distance. In another aspect, passive restraint is used to gently place cargo 13 (FIG. 2B) at the desired location. In another aspect, springs are used to cushion placement of cargo 13 (FIG. 2B).

Continuing to refer to FIGS. 2A and 2B, when the AV reaches the desired destination, in an aspect, commands received from the AV processors instruct the controls within the cargo box to open the proper cargo box doors. In an aspect, when the AV reaches the desired destination, commands are received from a remote controller that opens/closes doors and ejects cargo 13 (FIG. 2B), for example, from the cargo box. In an aspect, the AV provides status information about the delivery/pickup on a status area located upon the AV, for example, for even when the intended recipient is not at the delivery location, others at the location might be interested in the status of the AV. In an aspect, the AV provides the status information to the receiver/provider of cargo 13 (FIG. 2B) by a text, email, website posting, automated phone call, or any other electronic means. In an aspect, the AV provides status information to a remote controller, and possibly logs status information. Status information output can be controlled by user-managed settings, default settings, or dynamically-determined settings, possibly based on the availability of network access. In an aspect, the AV determines environmental conditions, for example, rain or snow, and automatically determines when a delivery/pickup is ill-advised at the time the AV arrives at the destination. In an aspect, the AV informs the user of the inclement conditions, and/or requests help from a remote controller, or other alternative actions. In some configurations, the AV deploys an environmental barrier to protect cargo 13 (FIG. 2B). The barrier can include, for example, but not limited to, a waterproof cover, a UV protective barrier, and/or a thermal barrier. In some configurations, the environmental barrier is built into the cargo container, for example.

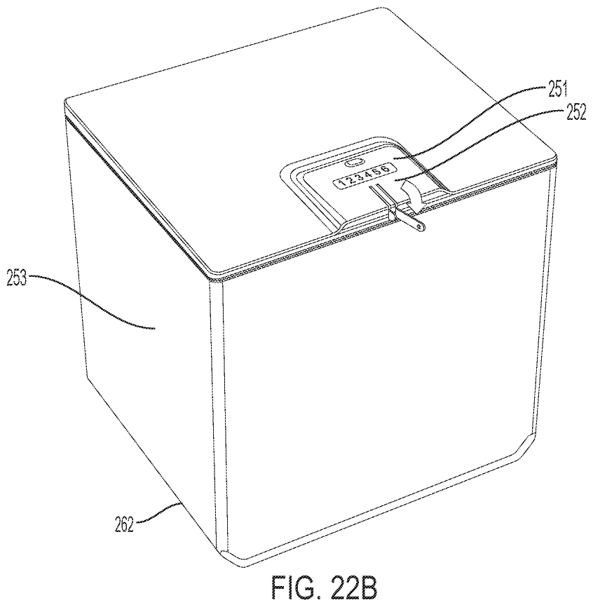

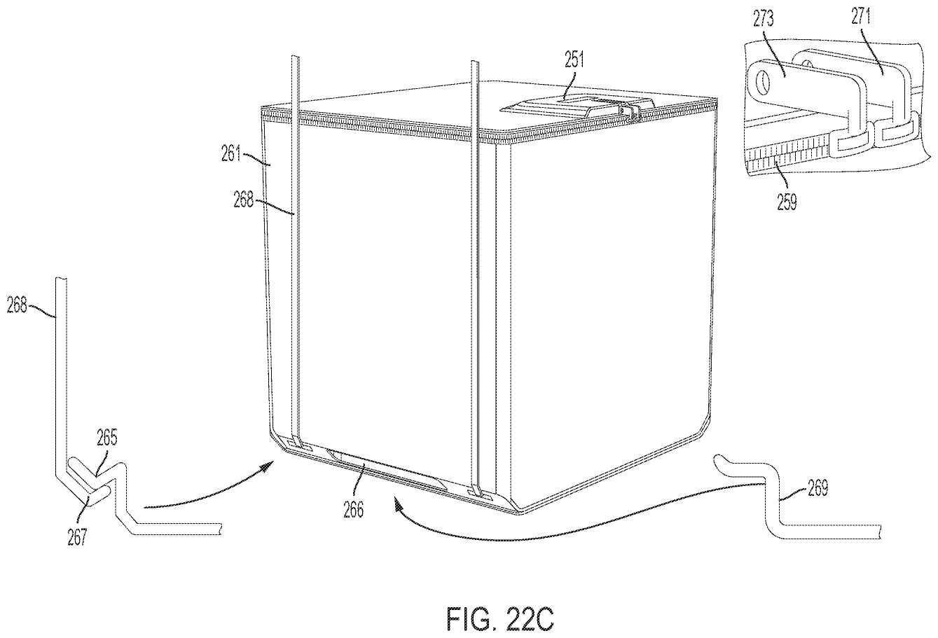

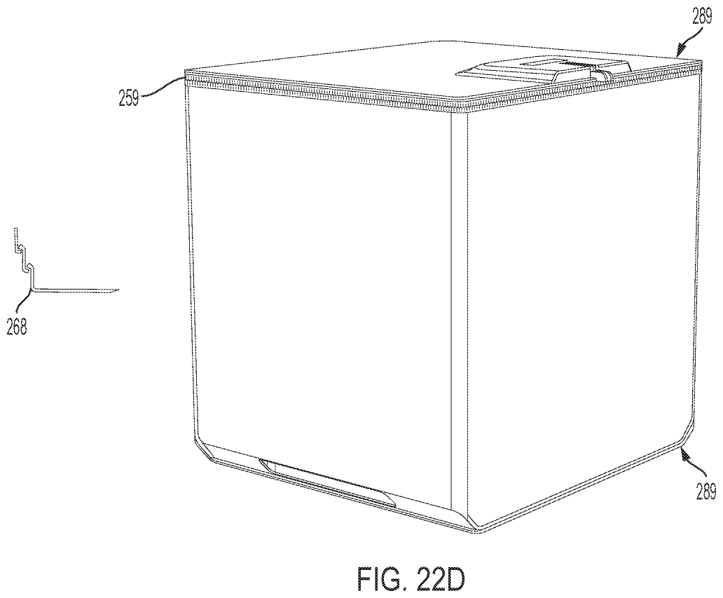

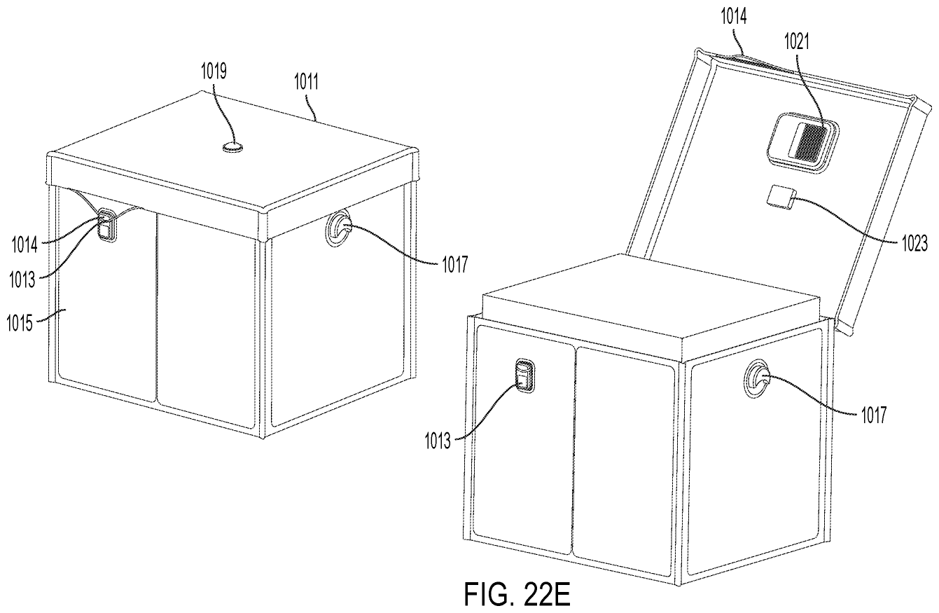

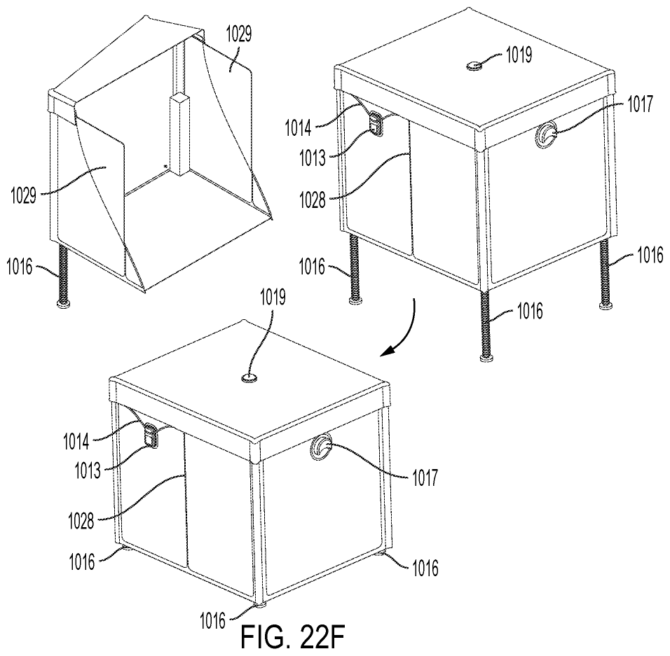

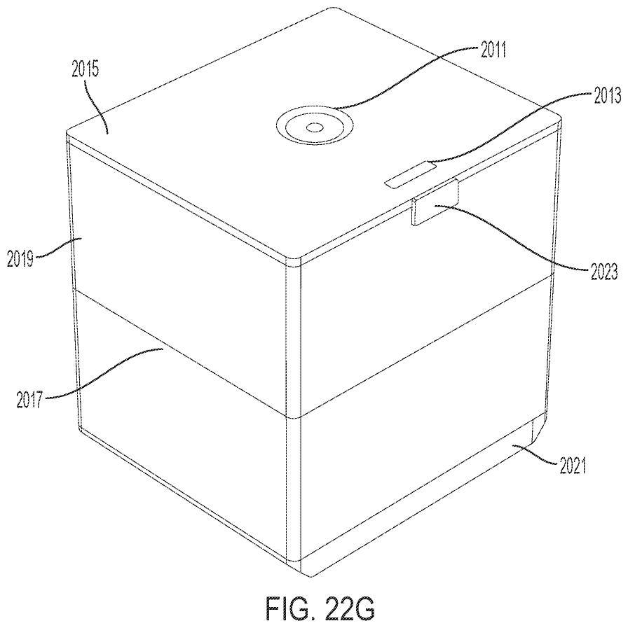

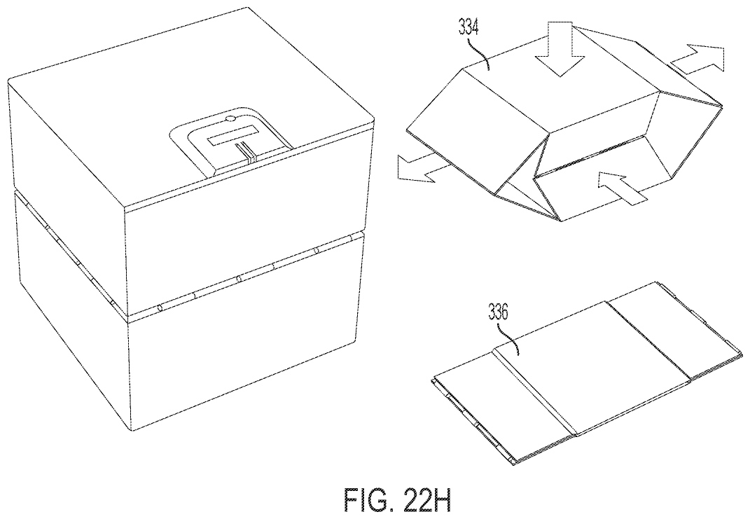

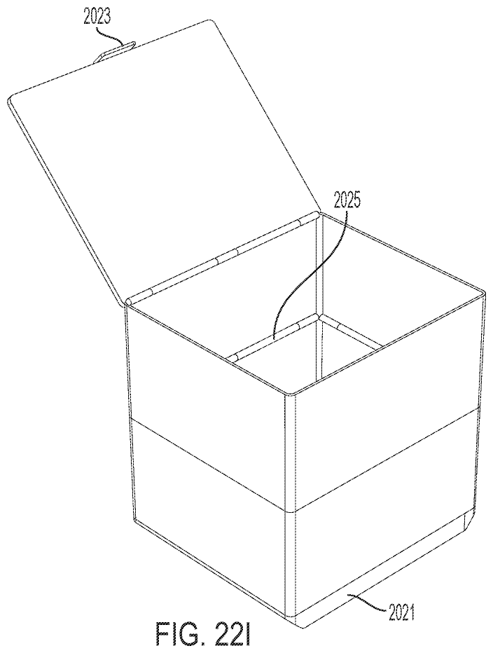

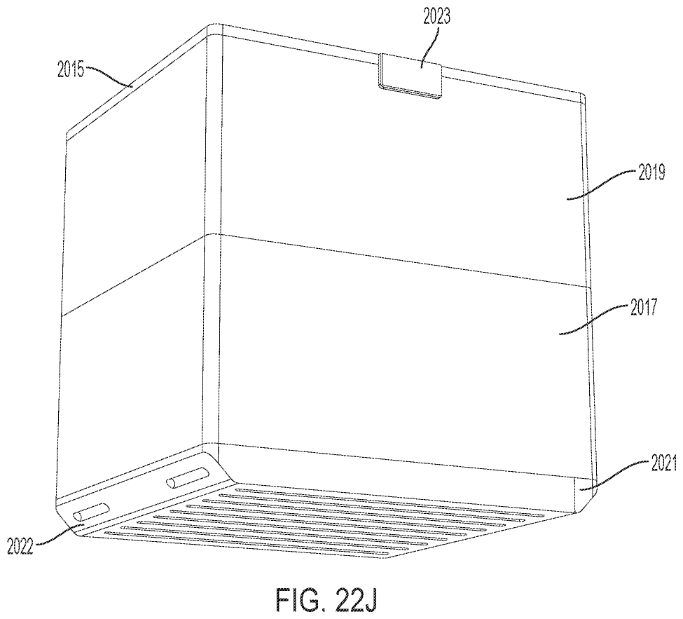

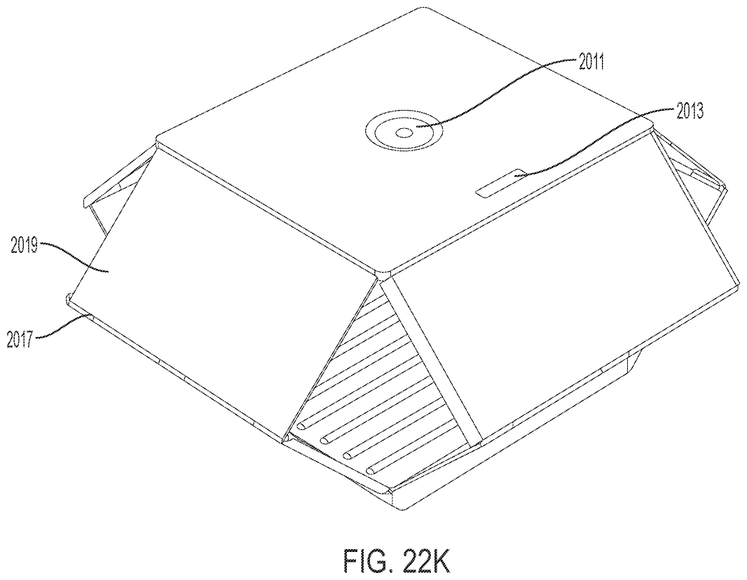

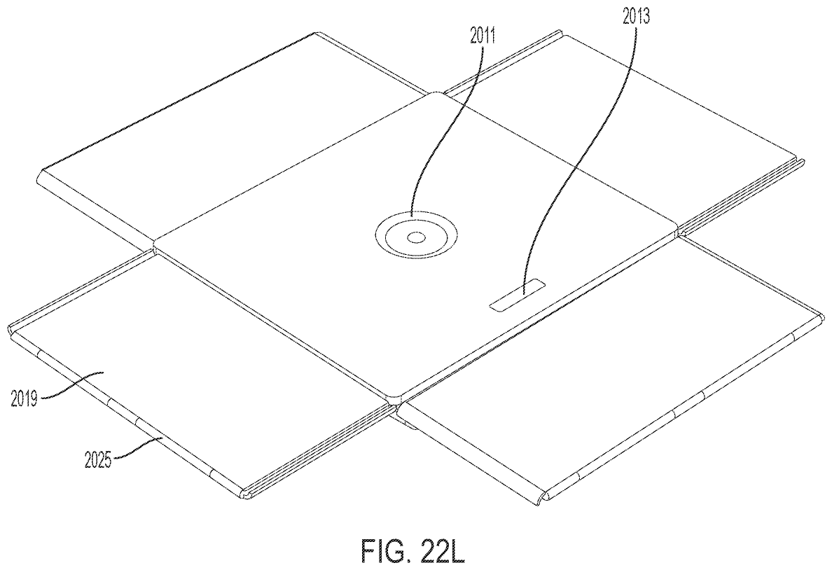

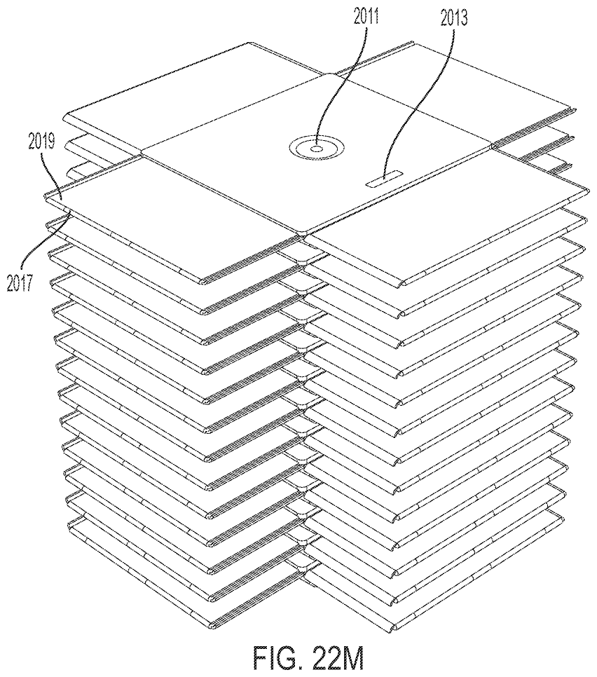

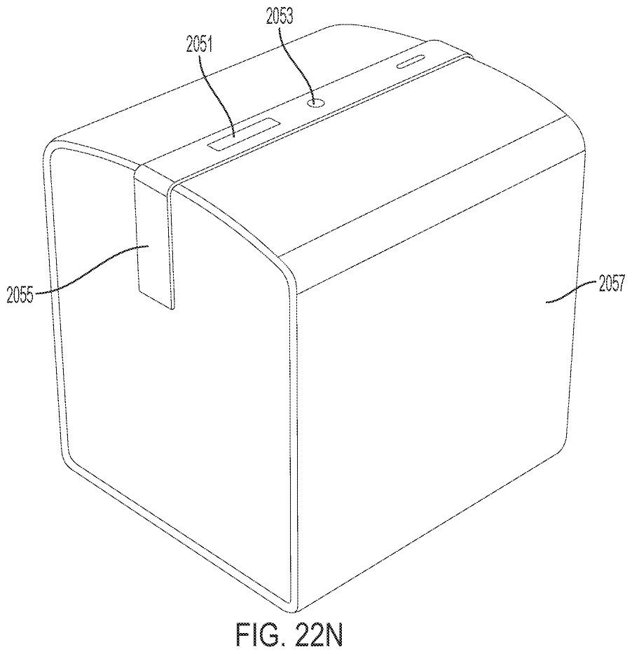

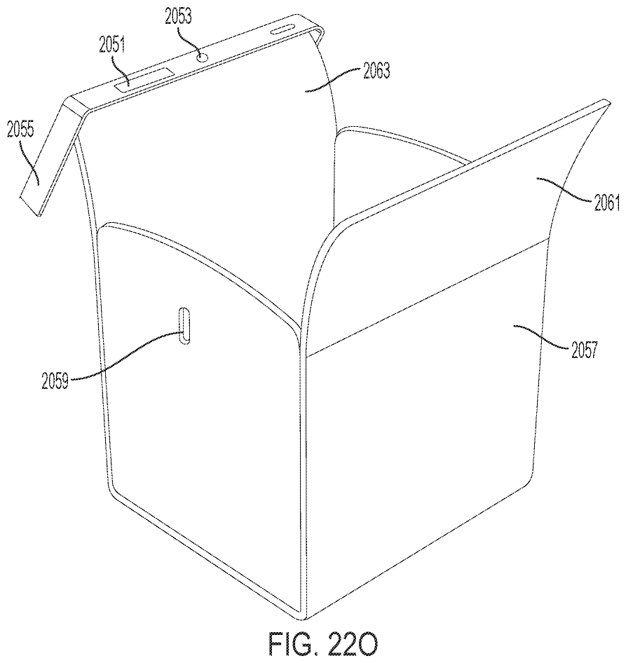

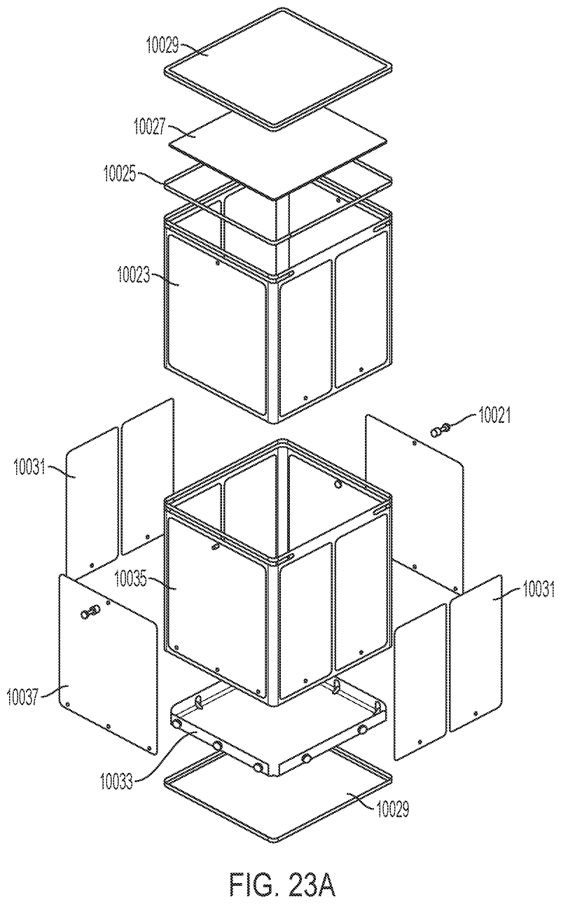

Referring now to FIGS. 2C and 2D, a second exemplary configuration in which no-touch, unattended cargo manipulation is accomplished includes arms 33 riding upon telescoping lift having, for example, but not limited to, first part 39 slidably coupled with second part 35, deployed from the cargo box within which cargo 13 (FIG. 2D) can rest during transport. In an aspect, arms 33 lower cargo 13 (FIG. 2D) onto a surface clear of the AV. Arms can be positioned to deploy cargo 13 (FIG. 2D) from the sides, front, or rear of the AV. Regardless of the operating location of arms 33, an actuator propels the telescoping lift from the cargo box. For example, the telescoping lift is stored in retracted position as the AV transports cargo 13 to a desired destination. The telescoping lift is moved by an actuator, possibly the actuator used to open and close the AV door(s) from which cargo 13 (FIG. 2D) emerges. The telescoping lift can move outside of the cargo box, causing cargo 13 (FIG. 2D) to be moved outside the cargo box. In an aspect, arms 33 include a telescoping feature, and can deploy cargo 13 (FIG. 2D) to a pre-selected length, to a length determined by the position of cargo 13 (FIG. 2D), or to a length supplied by a user remotely, for example. The telescoping lift is directed to move towards the surface. When the surface is reached, arms 33 are directed to release cargo 13 (FIG. 2D). When cargo 13 (FIG. 2D) has been deployed, the actuator causes the telescoping lift to raise arms 33, and be retracted into the cargo box. The actuator can, optionally, close the door(s) while arms 33 are being retracted. In an aspect, a controller operably coupled with sensors that detect the position of cargo 13 (FIG. 2D) determines if manipulation of cargo 13 (FIG. 2D) has completed by accessing default timing values, or by determining, based on sensor information, if cargo 13 (FIG. 2D) has reached a desired surface and the manipulation mechanism has disengaged with cargo 13. In an aspect, the deposit location is requested by a user, and the vertical distance from the cargo area to the deposit surface is determined by sensors on the AV. For example, arms 33 automatically discontinue their downward movement when some resistance is met equivalent to the resistance that would be encountered if cargo 13 (FIG. 2D) reached a surface. In an aspect, arms 33 are lowered a preselected amount. In an aspect, passive restraint is used to gently place cargo 13 (FIG. 2D) at the desired location. In an aspect, shock absorbers 1016 (FIG. 22G) are used to cushion placement of cargo 13 (FIG. 2D).

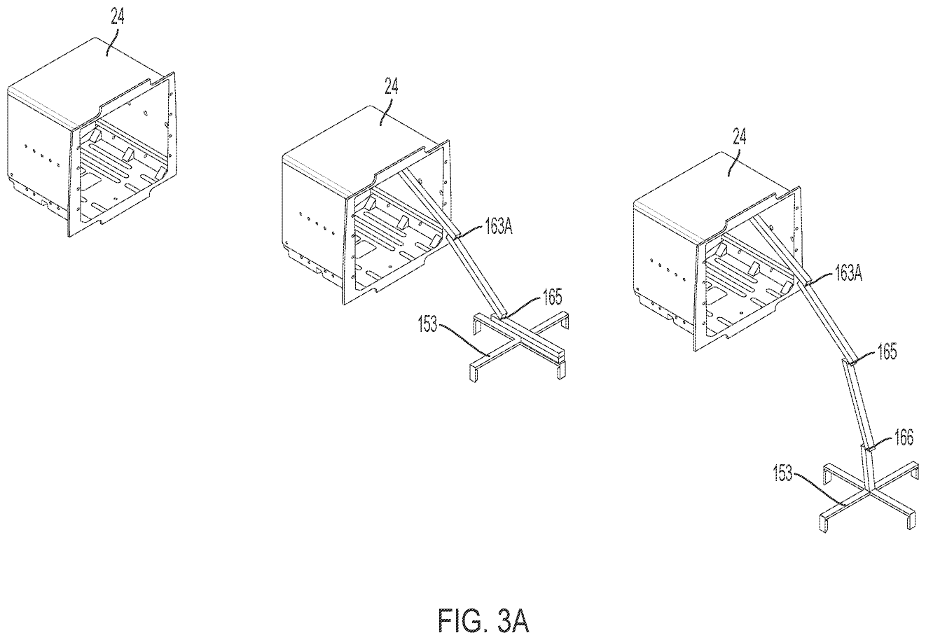

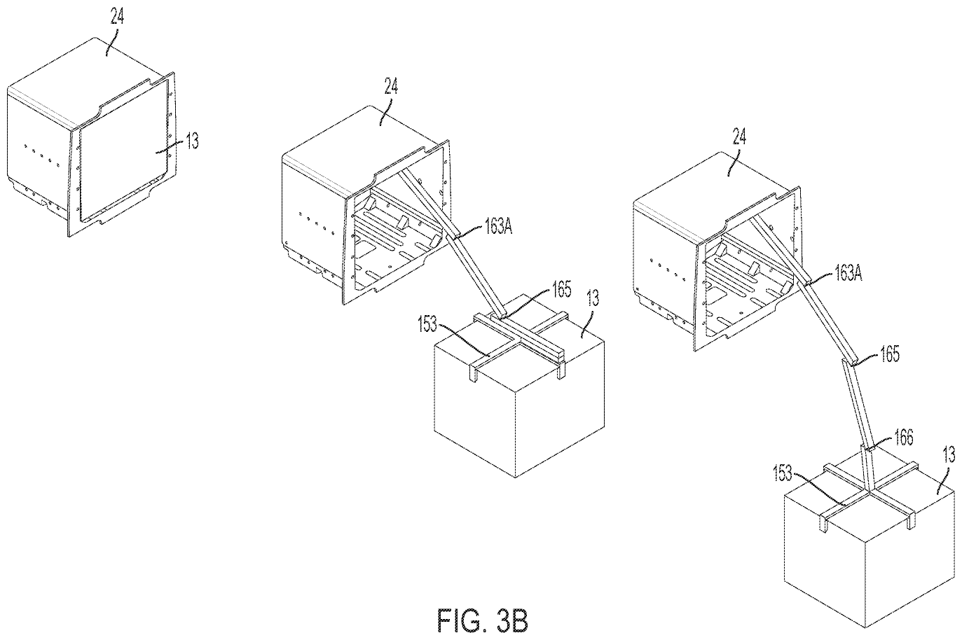

Referring now to FIGS. 3A and 3B, in a third exemplary configuration, an articulated arm reaches into the cargo box, or is deployed from the cargo box, grabs cargo 13 (FIG. 3B), and lowers cargo 13 (FIG. 3B) a desired amount. The articulated arm is automatically stored after depositing cargo 13 (FIG. 3B). The articulated arm includes a robotic arm, for example, with the number of degrees of freedom based at least upon the storage location of the arm. The number of degrees of freedom is based on the aspects of motion of the articulated arm. For example, at a joint, the arm may be able to move up/down and/or right/left. The more ways the arm can move, the higher the number of degrees of freedom. The articulated arm can be stored within the cargo box, or attached to the external features of the AV, for example. The articulated arm can include a plurality of joints, depending upon desired flexibility of the arm. In an aspect, the arm includes a shoulder joint located at the junction of the arm and the cargo box, elbow joint 163A, wrist joint 165, and hand 166, which can grasp and hold package release mechanisms 153 holding cargo 13 (FIG. 3B) until being commanded by a controller to release the hold as described herein.

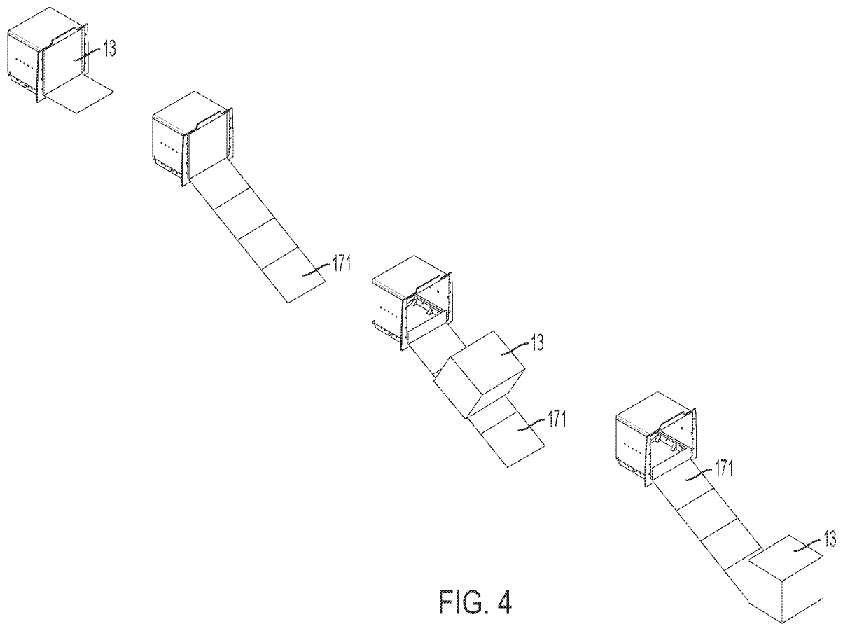

Referring now to FIG. 4, in a fourth exemplary configuration, ramp 171 is extended from an opening in the cargo box. Ramp 171 can include features that can enable cargo 13 to slide on ramp 171 towards the surface. The features can include, but are not limited to including, ball bearings, rollers, and/or treads. The treads can include a “moving sidewalk” apparatus, for example. In an aspect, ramp 171 includes an apparatus that grabs cargo 13. For example, ramp 171 includes a moveable hook, and cargo 13 includes a compatibly-positioned/sized coupling for the hook. Force can be provided to cargo 13 to propel cargo 13 towards ramp 171. For example, a retractable arm as described herein can be used to push cargo 13 out of the cargo box to land upon any features that might be present, and travel down ramp 171 onto the surface.

Referring now to any of FIGS. 2A to FIG. 4, other configurations are contemplated by the present teachings. For example, in an aspect, an arm can be connected, possibly removably, to a backstop, which itself can be connected to a platform or shelf. Alternatively, the backstop and platform or shelf can be a single article. Still further, the arm, backstop, and platform or shelf can be a single article. The arm, backstop, and platform or shelf can be retracted into the cargo box for storage after the cargo has been deployed. The backstop can engage with a lowering/raising means such as, for example, but not limited to, a linear actuator. In an aspect, forks can retract into the backstop, and can extend into a compatible pallet that can support the cargo. The pallet can be deployed with the cargo at a desired destination. In this configuration, the cargo can be placed atop the pallet, and the forks can extend into the pallet cavities to support the pallet and cargo. The entire structure can be pushed outside the cargo box and lowered to the surface. In an aspect, the forklift-like device can include a plurality of forks coupled with a carriage that can ride along at least one mast to move the cargo from the cargo box to a surface. The forks, carriage, and mast can be sized to fit into the cargo box. When the cargo is deployed, the forks, carriage, and mast, holding the cargo, can be moved outside the cargo box. A deployment post can include, for example, a telescoping feature, and can operably couple with the mast. The mast can also include a telescoping feature. The forks can operably couple with the mast interface. The mast interface can ride up and down the mast, regardless of the telescoping status of the mast. A controller can manage the deployment of the deployment post. When deploying cargo, sensors can inform the controller when the deployment post has reached a desired extension, and can then begin lowering the forks (and cargo) and telescoping the mast parts. Alternatively, the weight of the cargo can provide the force to lower the cargo. The drop of the cargo can be cushioned by a form of shock absorbers on the forks. In another aspect, the platform can engage with a track that can be built into the cargo box, for example, or can be coupled with the platform. The track can be activated to move the platform out of the cargo box. The track can include crawler treads that can be activated to move the platform to/from the cargo box. In some configurations, no backstop is required. In this case, the platform can engage with the deployment mechanism when it has sufficiently cleared the cargo box. Other methods of moving the platform horizontally and/or vertically are contemplated by the present teachings.

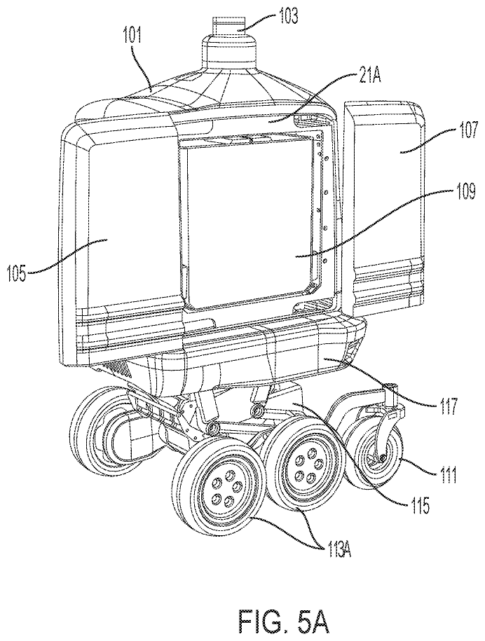

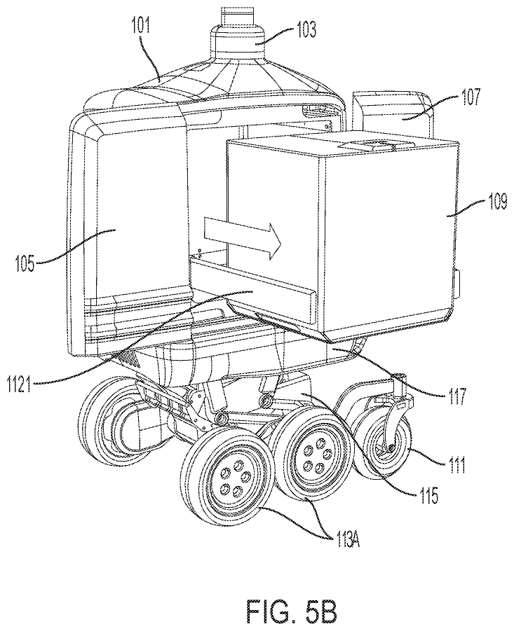

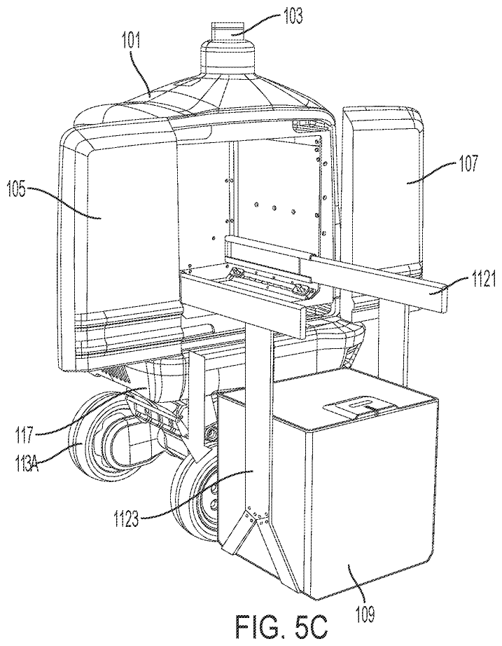

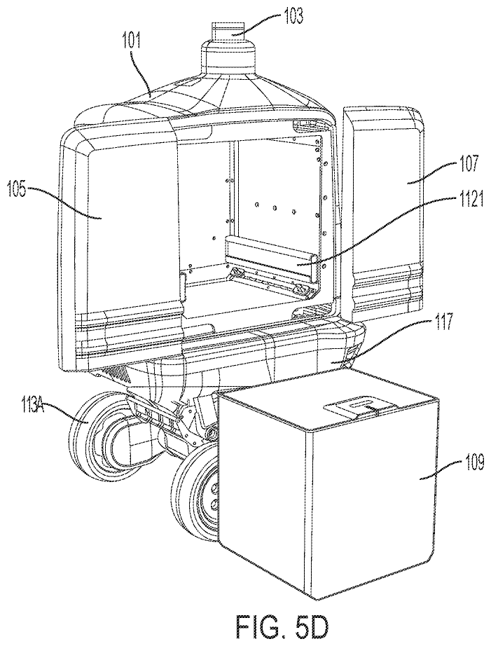

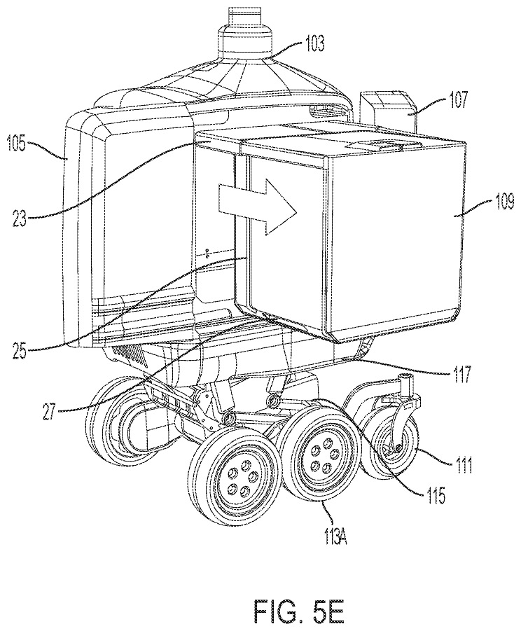

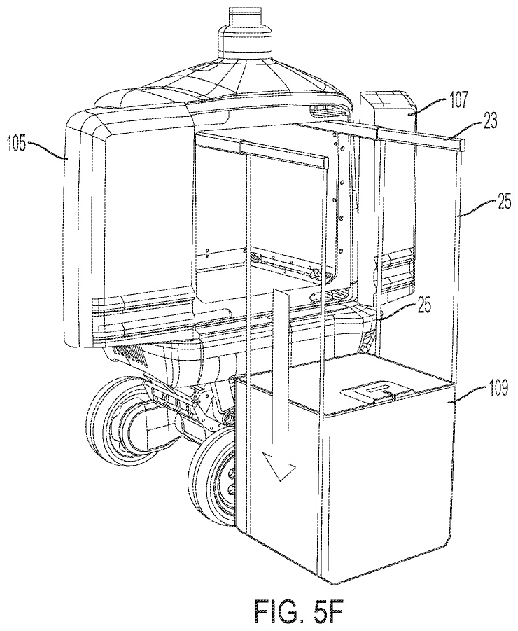

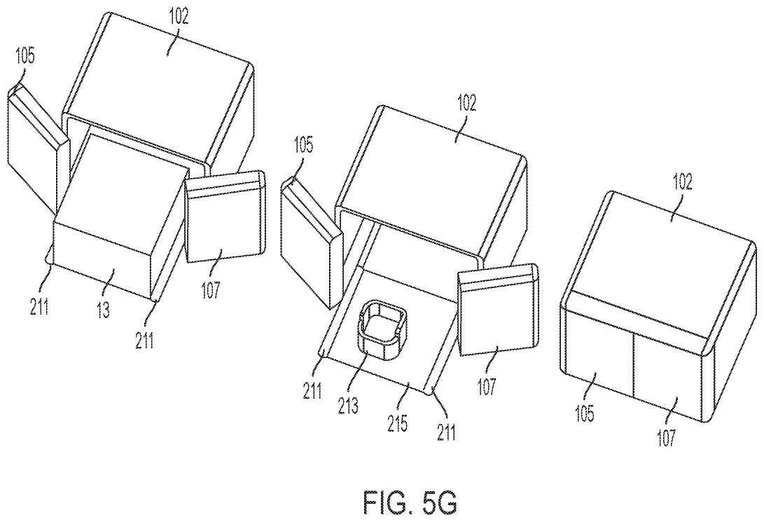

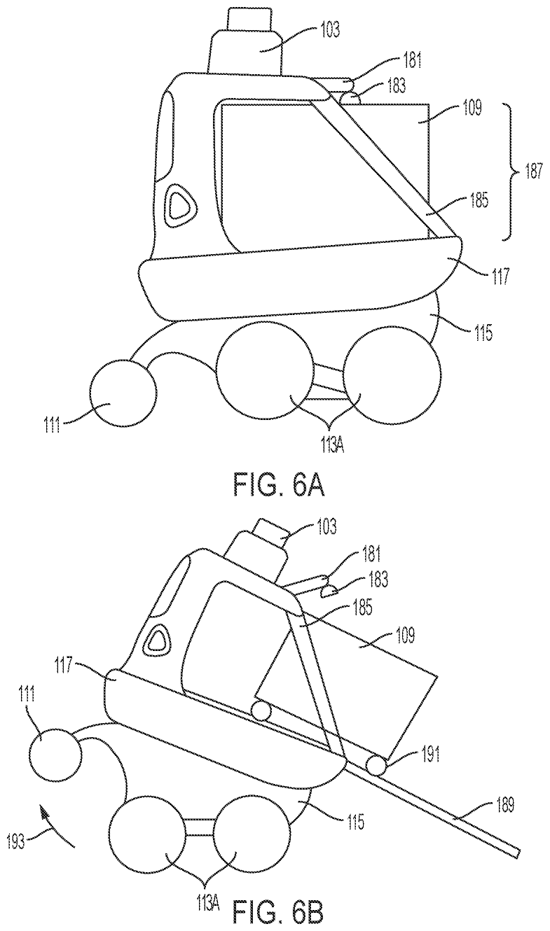

Referring now to FIGS. 5A-6B, exemplary configurations of an AV that can be used to implement the system of the present teachings are shown. The exemplary AV is described in detail in U.S. patent application Ser. No. 16/435,007, entitled System and Method for Distributed Utility Service Execution, filed Jun. 7, 2019 ('007), U.S. patent application Ser. No. 16/926,522, entitled System and Method for Real Time Control of an Autonomous Device, filed Jul. 10, 2020 ('522), U.S. patent application Ser. No. 16/035,205, entitled Mobility Device, filed on Jul. 13, 2018 ('205), U.S. patent application Ser. No. 15/787,613, entitled Mobility Device, filed on Oct. 18, 2017 ('613), and U.S. patent application Ser. No. 15/600,703, entitled Mobility Device, filed on May 20, 2017 ('703), all of which are incorporated herein by reference in their entirety. While exemplary AV configurations are shown, other AV configurations are contemplated to implement the unattended cargo manipulation of the present teachings. AV 101 can include sensors 103 that, along with processors 117, enable the AV to autonomously navigate. Wheels 113A are controlled by powerbase 115 that interfaces with processors 117 with respect to direction and speed of wheels 113A. Casters 111 enable AV 101 to travel over varying types of terrain.

Referring now to FIGS. 5A-5D, in a fifth exemplary configuration, AV 101 delivers cargo 109, transported in cargo hold 21A, through a side opening. In an aspect, AV 101 includes at least one door that opens to an area wide enough to permit cargo 109 to pass unobstructed through the opening in AV 101. In an aspect, the door(s) can open side to side, up and down, and/or diagonally, for example. In an aspect, a single door is used. The single door can move to either side, away from the ground, or towards the ground. The single door can also move diagonally, or at any other angle with respect to the surface. In an aspect, as shown, two doors are used. In an aspect, AV 101 includes arm-like features 1121 (FIG. 5B) that grasp delivery container 109 and guide it through the door opening and clear of AV 101. Arm-like features 1121 (FIG. 5B) can, for example, include robotic arms whose force against delivery container 109 can automatically be adjusted based at least on sensor input from the reaction of delivery container 109 to the pressure from arms 1121 (FIG. 5B). In an aspect, cables, straps, cords, bands, or belts, for example, can be cinched around a surface of delivery container 109, and delivery container 109 can be moved outside the cargo box to clear AV 101. Package release mechanisms 1123 (FIG. 5C) can surround delivery container 109 partially or completely. Delivery container 109 can be released from package release mechanisms 1123 (FIG. 5C) by, for example, but not limited to, decoupling package release mechanisms 1123 (FIG. 5C) from delivery container 109. For example, delivery package release mechanisms 1123 (FIG. 5C) can terminate in temporary connectors such as, for example, but not limited to, hooks that engage with recesses 2022 (FIG. 22J), VELCRO® strips, or magnets. In an aspect, the temporary connectors are disengaged when delivery package release mechanisms 1123 (FIG. 5C), for example, move away from delivery container 109. Delivery package release mechanisms 1123 (FIG. 5C) include, for example, spacers (not shown) that can be activated when delivery container 109 reaches a surface. In an aspect, the spacers force package release mechanisms 1123 (FIG. 5C) to release delivery container 109. If package release mechanisms 1123 (FIG. 5C) surround delivery container 109, spacers (not shown) cause delivery container 109 to tilt forward and slide from its engagement with package release mechanisms 1123 (FIG. 5C) while package release mechanisms 1123 (FIG. 5C) are retracted towards arms 1121 (FIG. 5C). After package release mechanisms 1123 (FIG. 5C) are fully retracted into arms 1121 (FIG. 5D), in an aspect, arms 1121 (FIG. 5D) are drawn into the cargo area of AV 101, leaving delivery container 109 available for pickup.

Referring now to FIGS. 5E-5F, in a sixth exemplary configuration, AV 101 includes arms 23 and ropes 25, similar to package release mechanisms 1123 (FIG. 5C). Arms 23 may extend from any location on cargo box 21. For example, arms 23 can extend from the upper corners of cargo box 21 as shown. Arms 23 can extend from anywhere along the top, edges, or bottom of the cargo hold. Arms 23 can extend to their full length from the cargo hold, or any shorter length, depending upon, for example, the size and weight of delivery container 109. Arms 23 can be constructed of flexible, semi-rigid, or rigid weight-bearing material, the material possibly being selected for holding up to a pre-selected maximum cargo weight. Ropes 25 can be flexible enough to retract and store compactly, but can retain a measure of rigidity, if needed. Ropes 25 can fully surround the ground-facing surface of delivery container 109, or can terminate in connectors as discussed herein. Ropes 25 can include, but are not limited to including, cables, cords, lines, strands, chains, or strings. Arms 23 can include telescoping features made from fiberglass, aluminum, steel, or other suitable material. In an aspect, the extension of arms 23 is actuated by the same mechanism as actuates the opening of doors 105/107. Ropes 25 are extended to enable delivery container 109 to reach a desired surface near AV 101, if necessary. Other aspects are contemplated that hold delivery container 109 as it is moved out of the cargo hold. Ropes 25 extend from arms 23 to enable delivery container 109 to be deployed to a surface. When the surface is reached, ropes 25 are disengaged from delivery container 109. Sensor data received from sensors 103 associated with delivery container 109, ropes 25, and arms 23, for example, can trigger the disengagement of ropes 25 from delivery container 109. Ropes 25 can be temporarily connected to delivery container 109, and the connection can be automatically released when delivery container 109 has reached its desired position. Disconnected cables 25 are retracted, and arms 23 and cables 25 can be repositioned inside of the cargo hold, and doors 105/107 are closed. A sanitizing sequence can be optionally activated.

Referring now to FIG. 5G, in an aspect, cargo box 102 includes rollers 211 that pinch delivery container 13 between them, and/or unwind sail 215 between them. Rollers 211 emerge from the cargo area when door(s) 105/107 open, and return to the cargo area as door(s) 105/107 are closed. Delivery container 13/213 travels upon sail 215 if sail 215 is deployed. Sail 215 is retracted into rollers 211 to leave delivery container 13/213 at its desired destination. The AV can accommodate non-uniformly-shaped delivery container 213 at least by positioning sensors within the cargo box 102 to determine enough dimensional data, including weight, to adjust the deployment apparatus properly.

Referring now to FIGS. 6A and 6B, in a sixth configuration, the AV includes an open cargo area, or a cargo area that can be either open or closed, and can include support structure 185. The AV can also include autonomy sensors 103 and processors 117, and powerbase 115 to drive wheels 113A. In an aspect, the cargo area includes a cap (not shown) that can be retracted and stored, for example, a canvas “convertible” top. The hardware to retract the top can be mounted to the top of the cargo area, in which case the retracted top can rest upon the top of the cargo area. The hardware to retract the top can be mounted to the bottom of the cargo area, in which case the top can be stored, after retraction, under the cargo area. The cargo area can include open area 187, with no “convertible” aspect. Further, the AV can include a tilting capability in which the cargo area can accommodate tilt 193 with respect to wheels 111/113 and powerbase 115 of the AV. In the sixth configuration, the cargo area includes capture device 181 to secure delivery container 109. Capture device 181 can include, but is not limited to including, hooks, suction cups, arms, or any other device 183 that can grab and retain cargo 109. The AV includes ramp 189 or other similar means to automatically deploy delivery container 109. If ramp 189 is used, ramp 189 is stored on the floor of the cargo area, either within the cargo area or outside of the cargo area. Ramp 189 can be extendable, and can include telescoping sections and rollers or tracks, for example. In an aspect, ramp 189 extends directly from the AV, and accomplishes tilt 193 along with the AV when the AV is tilted to encourage delivery container 109 to exit the cargo area. Rollers/tracks on the box-facing side of ramp 189 can also encourage delivery container 109 to exit. Further, the rollers/tracks can include breaking mechanisms that can be automatically controlled to push delivery container 109 away from the AV and stop or even reverse the movement of delivery container 109 of away from the AV. Other deployment means can include runners that can, when deployed, conform to the geometry of delivery container 109. The runners can be deployed from either side of the cargo area, and can create, when deployed, a shell-like form around the side edges of delivery container 109. When delivery container 109 leaves the runners, the runners are retracted and stored either within the cargo hold or outside of the cargo hold. In some configurations, delivery container 109 is placed in a wheeled container within the cargo hold. Wheeled delivery container 109 is configured to enable a temporary attachment to capture device 181/183. When wheeled delivery container 109 is used, capture device 181/183 receives assistance from automatic breaking of the wheels 191. In an aspect, the capture device 181/183 can consist solely of braking cables, for example, coupled with wheels 191 of wheeled delivery container 109. The braking cables can be deployed and retracted from inside or outside the cargo area, either from the sides, top, or bottom of the cargo container. In some configurations, instead of tilting, the AV lowers itself to ground level to deploy delivery container 109. In an aspect, the cargo hold area includes sensors (not shown) that detect, for example, but not limited to leaks, hazardous odors, and hazardous cargo. For non-hazardous spills and/or for protecting successive cargo shipments from possible contamination from previous shipments, the cargo hold can include automatic sanitation features (not shown) that can be deployed by the AV controller, after delivery container 109 has exited the cargo hold. When hazardous odors and/or hazardous cargo are detected, the AV can seal the cargo hold, not deploying delivery container 109. The AV can trigger well-known hazmat protocols and provide data about delivery container 109 to officials, for example, through wireless communications available on the AV or associated with delivery container 109.

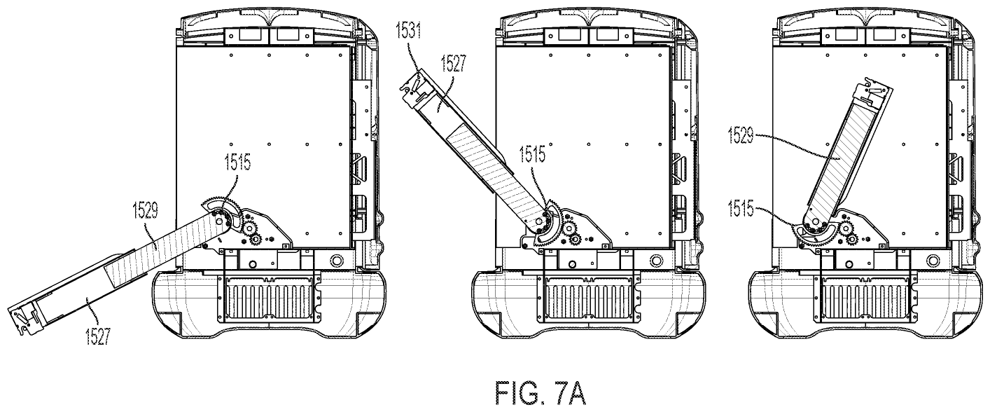

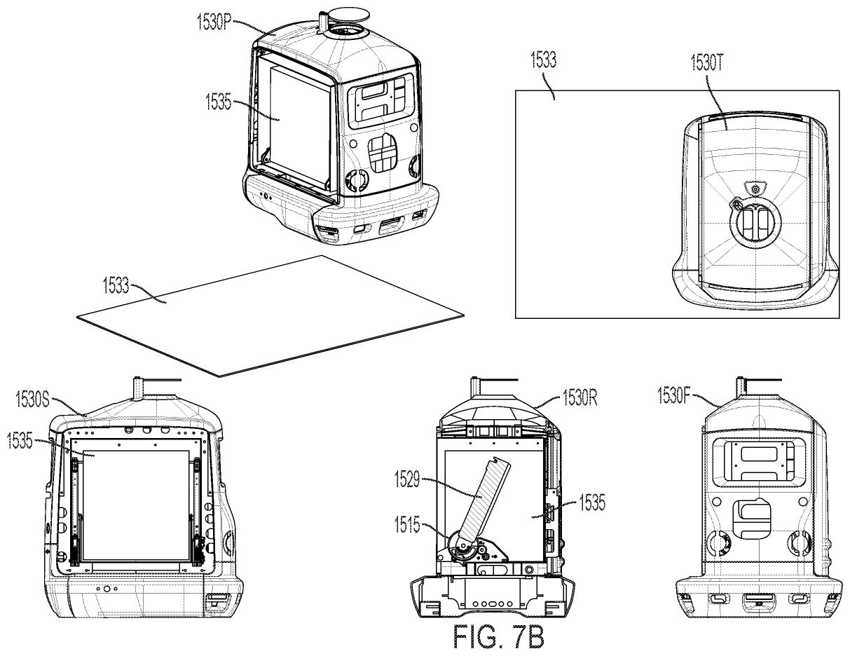

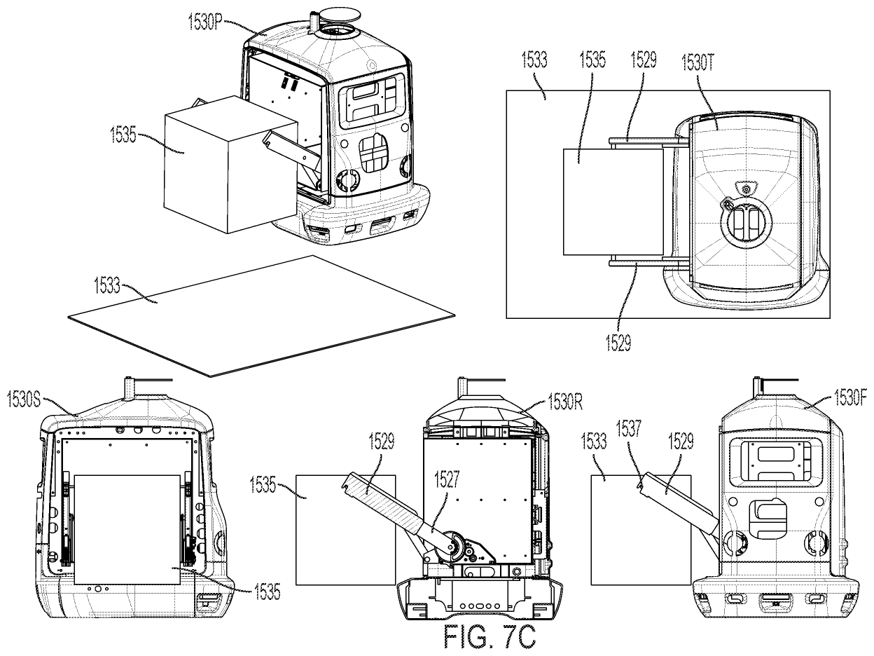

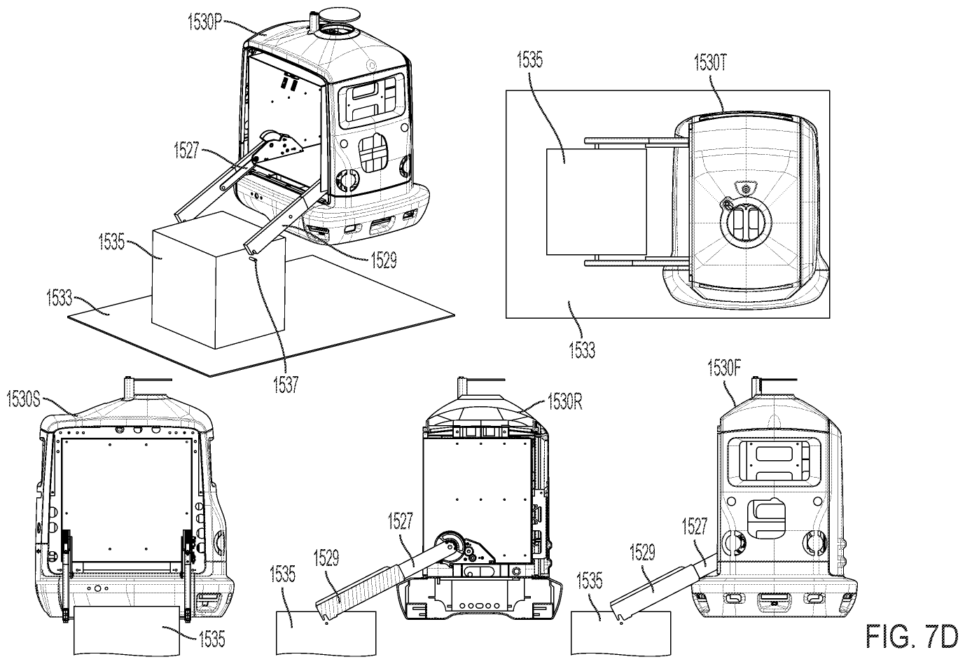

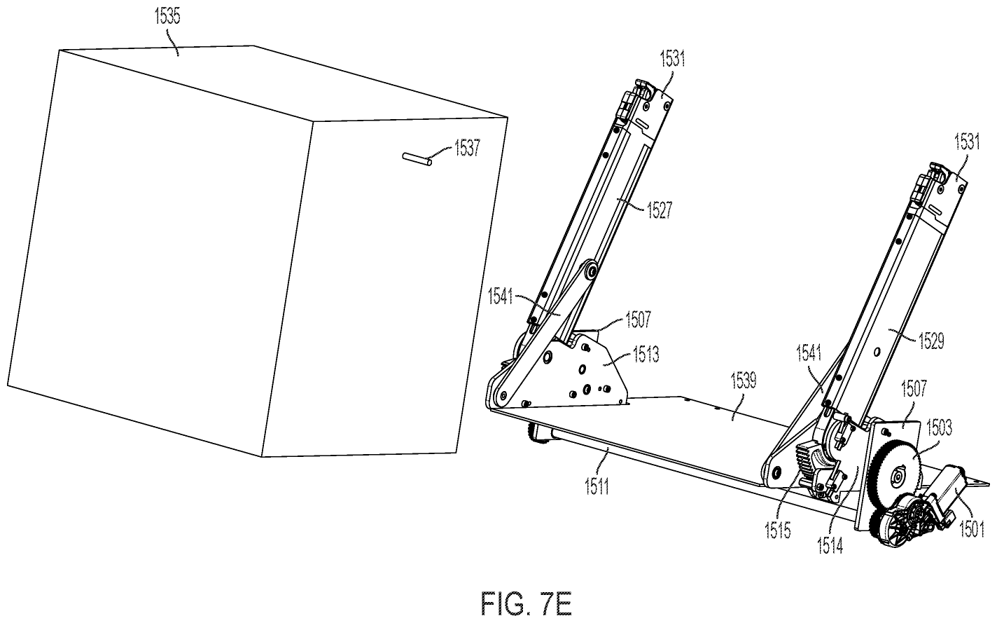

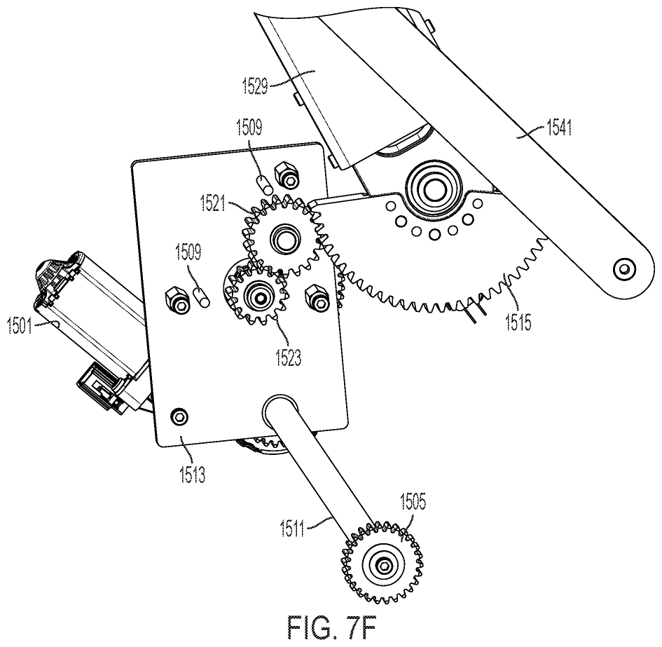

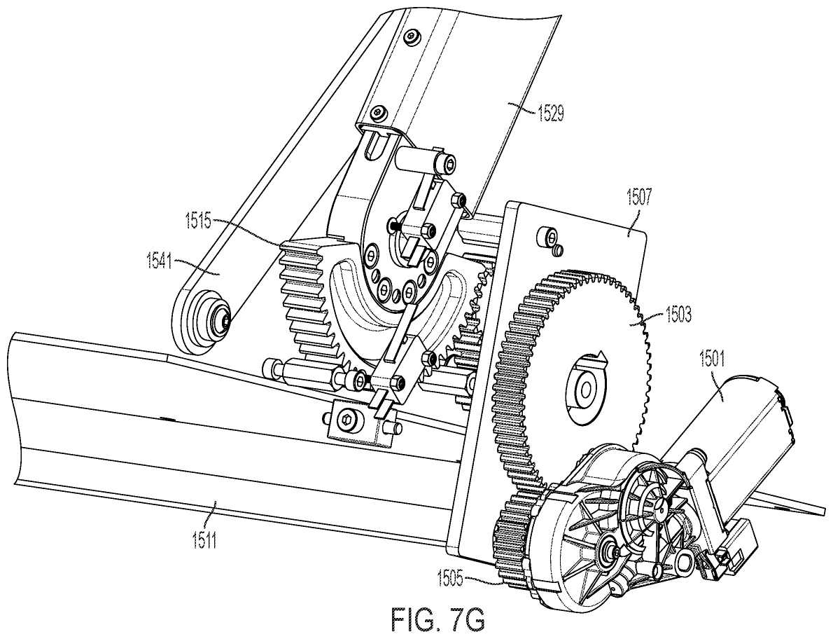

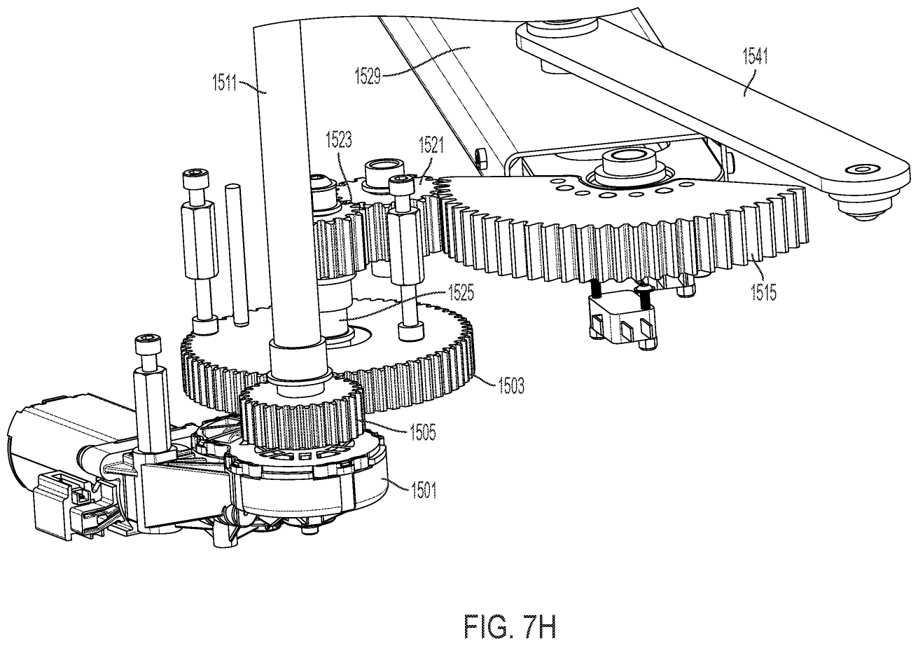

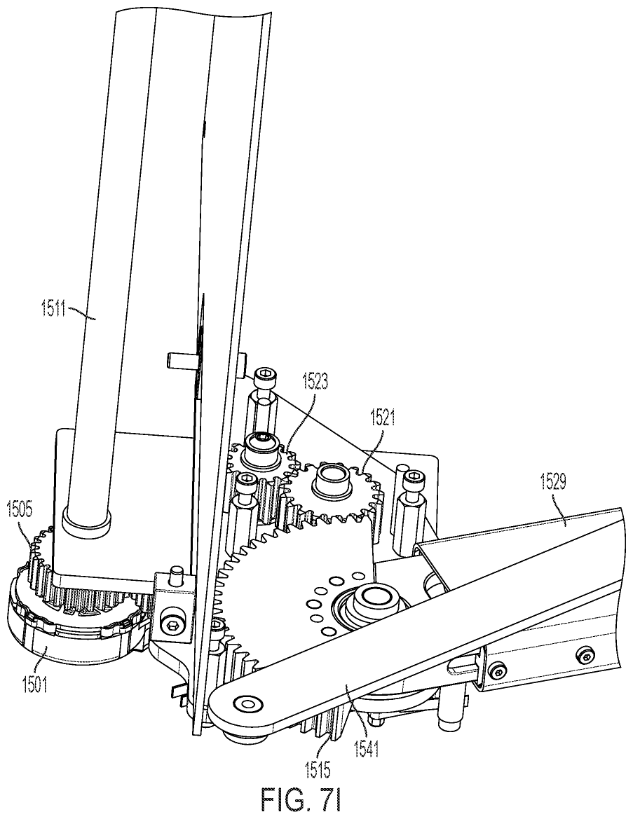

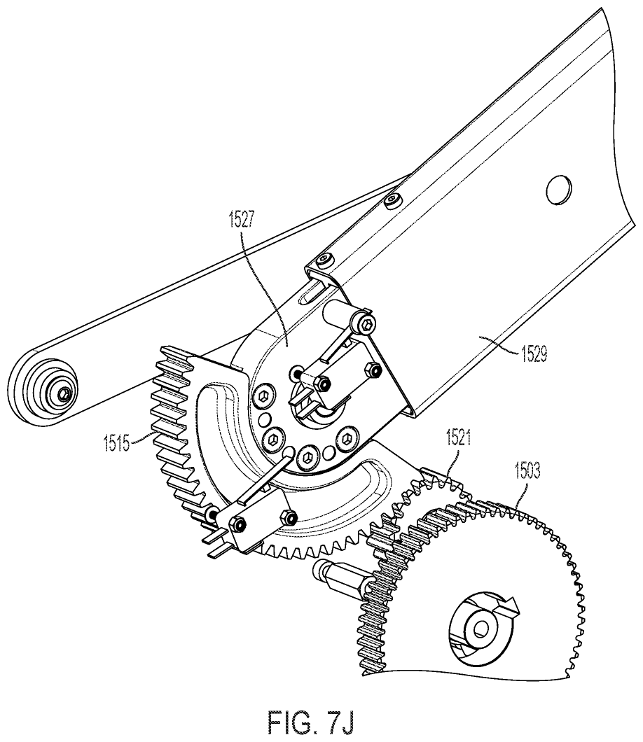

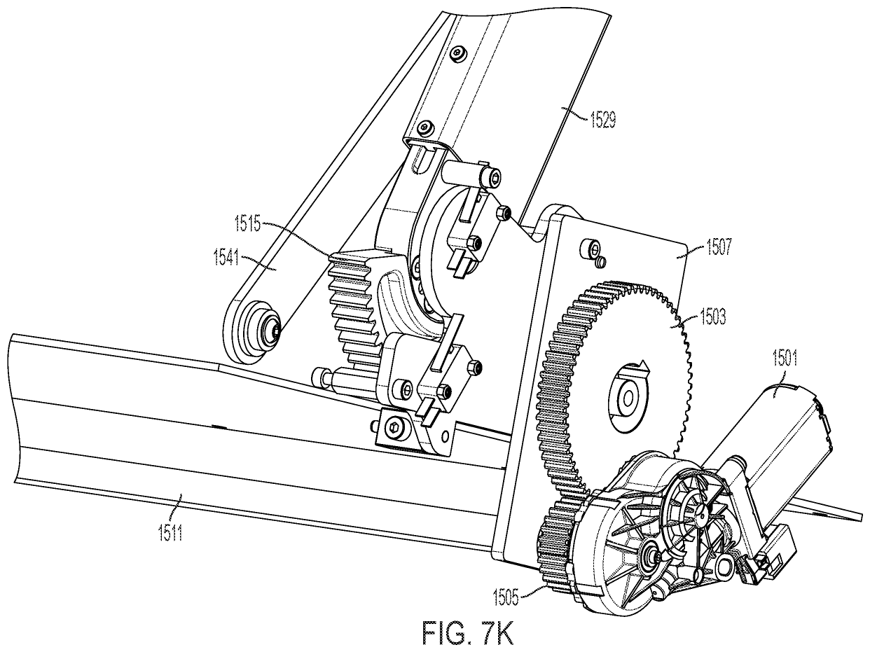

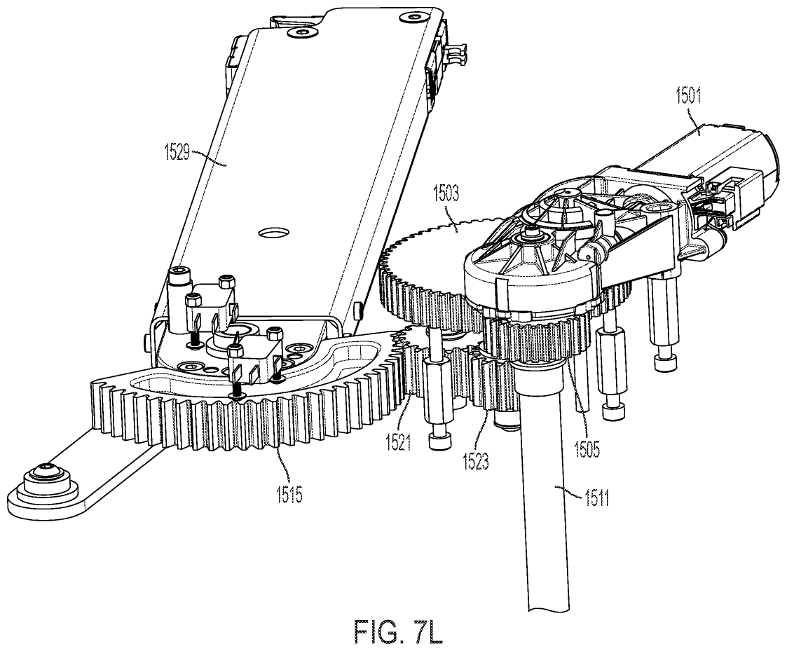

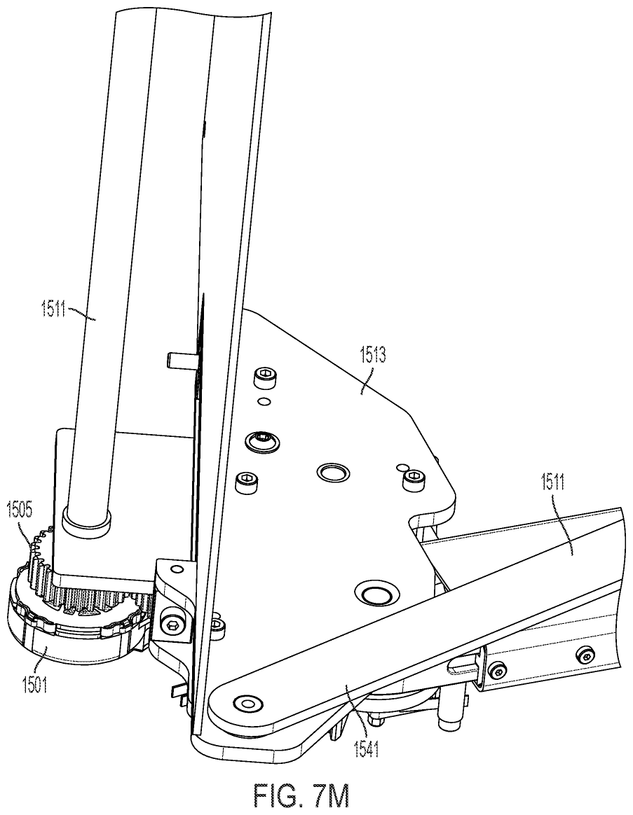

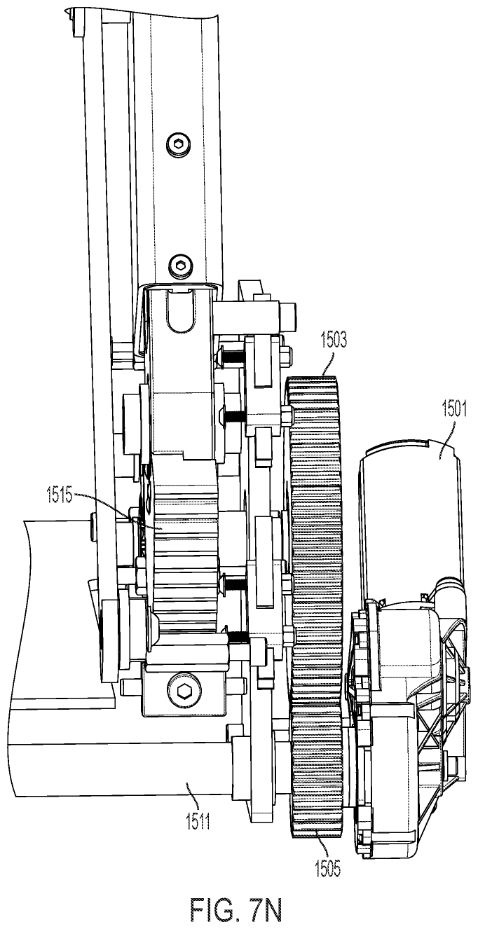

Referring now to FIGS. 7A-7D an autonomous cargo transport device, excluding wheels and powerbase, is illustrated. The wheels and powerbase can be provided in any conventional manner. The cargo transport device includes swing arms and a grab/release device on each arm. The grab/release device, upon contact, engages with a pins located on a cargo box. The engagement is stable until a trigger action that enables the grab/release device to disengage with the cargo box. A trigger action can include an instruction issued by a controller in the powerbase, in the cargo transport device, from a remote command center, from a user's cell phone, or from another source of commands that would control the grip/release device. The arms include at least one extension tube 1529 and base plate 1527. Base plate 1527 hosts rotary latch 1531, an exemplary grip/release device. Base plate 1527 is completely retracted into extension tube 1529 when stored within the cargo transport device as shown in FIGS. 7A and 7B. In FIG. 7B, various views of the autonomous device are shown, some relative to ground 1533. For example, perspective view 1530P, top view 1530T, front view 1530F, rear view 1530R, and side view 1530S illustrate an exemplary device with an opening to deploy cargo on the side of the device. Cargo box 1535 is shown stored in the transport device alongside the arms. The exemplary autonomous device includes, for example, sensors that can be used to drive the autonomous device to a target delivery/pickup location. Further, the sensors can be used to detect identifying information associated with the cargo box. The base of extension tube 1529 rests in sector gear 1515.

Continuing to refer to FIGS. 7A-7D, to deploy the arms, sector gear 1515 is rotated. At the same time, base plate 1527 lengthens as it telescopes from within extension tube 1529, as shown in FIGS. 7A and 7C. When a cargo box is to be deployed, rotary latch 1531 is operably coupled with box pin 1537 (FIG. 7C). As arms move, cargo box 1535 moves due to pressure from the arms at rotary latch 1531 on box pin 1537 as shown in FIG. 7C from various angles as discussed with respect to FIG. 7B. FIGS. 7B-7D show a deployment in which the cargo box is released at the level of the ground upon which the autonomous device is also resting. The illustrated system can deploy the cargo box at any height that the geometry of the transport device and the rotation distance of sector gear 1515 allows. When the autonomous device determines that the cargo box has reached its target destination, rotary latch 1531 is released and the arms are retracted. The target destination can be determined by any of several methods including, but not limited to, sensors that detect the distance to the ground, sensors that detect when the cargo box exerts a back-pressure indicating that it has reached a surface, sensors that detect fiducials, or a remote indication by a user or remote operator that the cargo box has reached its target, among other ways.

Referring now to FIGS. 7E-7N, schematic perspective diagrams provide details about a first configuration of a lift/lower mechanism of the transport device. As shown in FIG. 7E, bottom panel 1539 is provided as a resting platform for cargo box 1535 as it is being transported to its destination. Gear mounting bracket 1507 and sector gear mounting brackets 1513/1514 are operably coupled with a chassis mounting components that are mounted to bottom panel 1539. Between sector gear mounting brackets 1513/1514 is sector gear 1515 that is driven by motor 1501 (through a gear train described herein) to rotate the arms. The arm and arm brace 1541 (FIG. 7E) are operably coupled with and rotate with sector gear 1515 between standoffs that limit arm rotation. Motor 1501 rotates geared cross shaft 1511 at the same time as it rotates sector gear 1515. Specifically, motor 1501 rotates gear 1505 (FIG. 7H) that is operably coupled with and rotates cross shaft 1511 (FIG. 7H). Gear 1505 (FIG. 7H) also rotates gear 1503 (FIG. 7H) and drive shaft 1525 (FIG. 7H). Drive shaft 1525 (FIG. 7H) rotates pinion gear 1523 (FIG. 7H) that drives gear 1521 (FIG. 7H), that drives sector gear 1515.

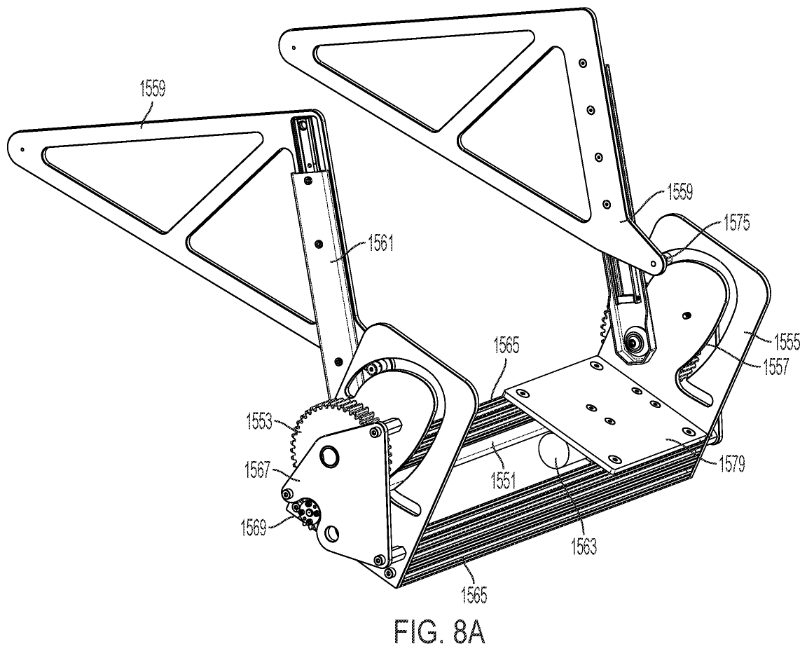

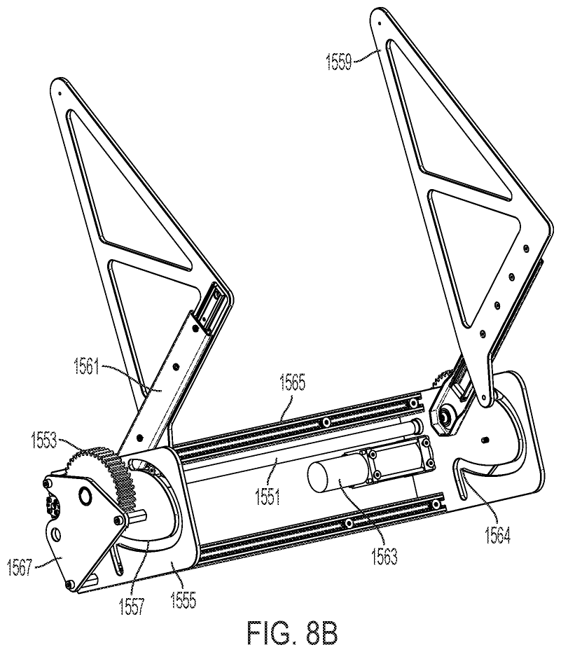

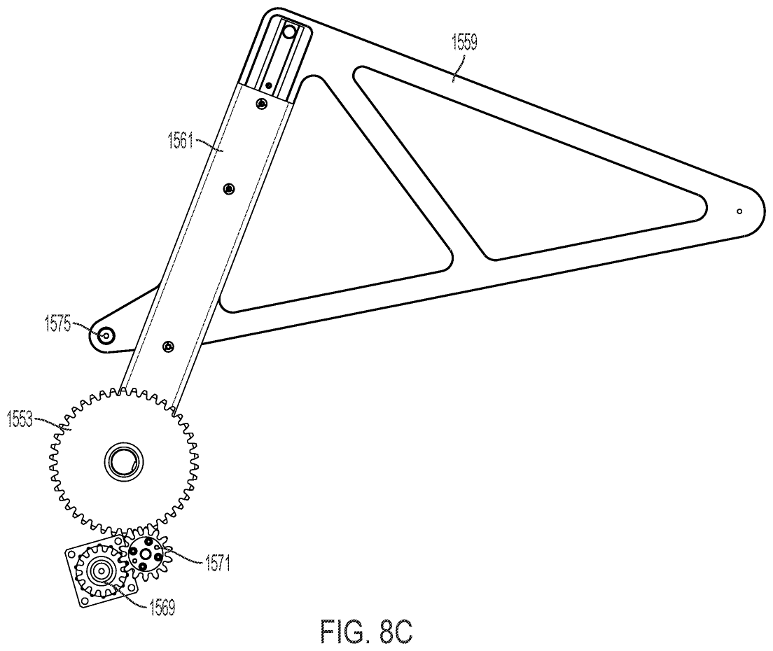

Referring now to FIGS. 8A-8C, schematic perspective diagrams provide details about a second configuration of a lift/lower mechanism of the transport device. In the second configuration, motor 1563 (FIG. 8A) rotates drive gear 1571 (FIG. 8C) that rotates spur gear 1553 and cross shaft gear 1569 (FIG. 8C). Cross shaft 1551 rotationally couples the movement of the arms. Spur gear 1553 drives extension tubes 1561. Extension tubes 1561 are slidingly coupled with arms 1559 which rotate and extend to move the cargo box into or out of the autonomous vehicle. Arms 1559 include cam followers 1575, and cam followers 1575 travel in channel 1557 to guide and limit arm 1559 and cargo box travel. In some configurations, channel bends 1564 provide a holding force on the cargo box. The shape of cam channel 1557 and the presence and location of channel bends 1564 can vary from configuration to configuration. In some configurations, the gears are sandwiched between roller guide plate 1555 and roller guide support plate 1567. In some configurations, motor plate 1579 enables mounting of motor 1563 to the arm configuration through framing members 1565. In some configurations, framing members 1565 include T-slotted framing, for example. Other configurations are contemplated by the present teachings.

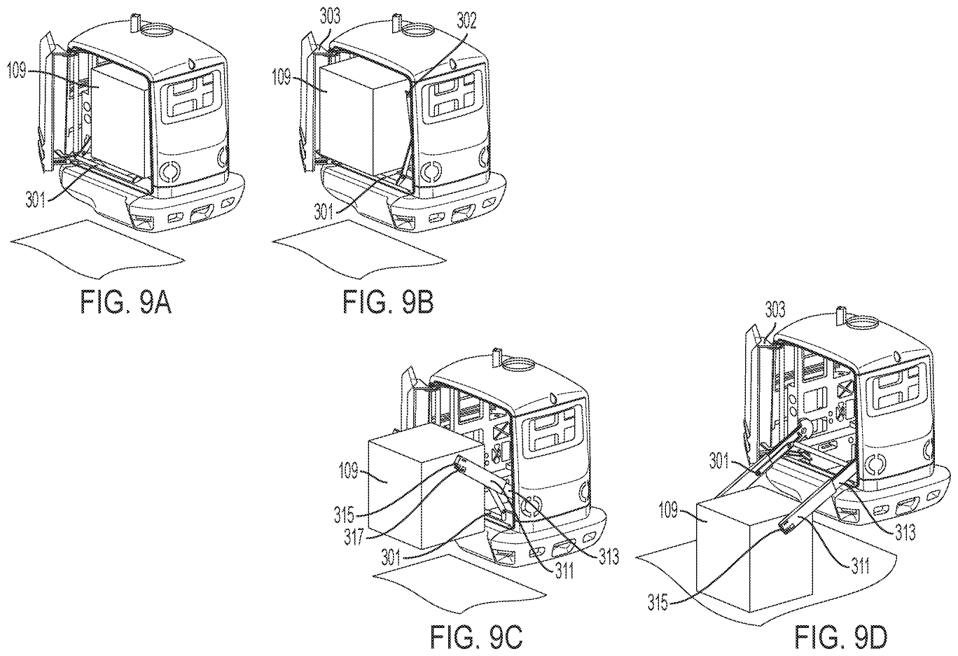

Referring now to FIGS. 9A-9D, in another configuration, an extension rotation linkage can be used to perform an unattended manipulation of cargo container 109 that has been transported in an AV to a desired location. Deployment begins by commanding door(s) 303 to unlatch and open (FIG. 9A), which, in an aspect, substantially simultaneously moves cargo container 109 onto linkage arms 301. At a pre-selected point in the process, linkage arms 301 (FIG. 9B) rotate about pivot point 302, extending and rotating at the same time due to second sliding linkage 313 (FIG. 9C). As linkage arms 301 rotate, cargo container 109 is lifted out of the cargo hold. Second sliding linkage arm 311 (FIG. 9C) is operably coupled at pin recess 315 (FIG. 9C) with pin 317 (FIG. 9C). As linkage arm 301 and second linkage arm 311 are rotated, cargo container 109 is moved away from the interior of the cargo hold and deployed. At this time, the motion of the linkage extends to move cargo container 109 outside of the AV's ground footprint while the arms are rotating. When linkage arms 301/311 reach their maximum rotation, or when sensor information directs a controller to cease rotation of linkage arms 301/11, pins 317 are released by an electromechanical latch at the end of each second linkage arm 311. In an aspect, cargo container 109 continues to descend to the surface after pins 317 are released and cargo container 109 is successfully deployed by the AV. Linkage arms 301/311 can reverse their movement and retract into the cargo hold as the door(s) close and latch shut.

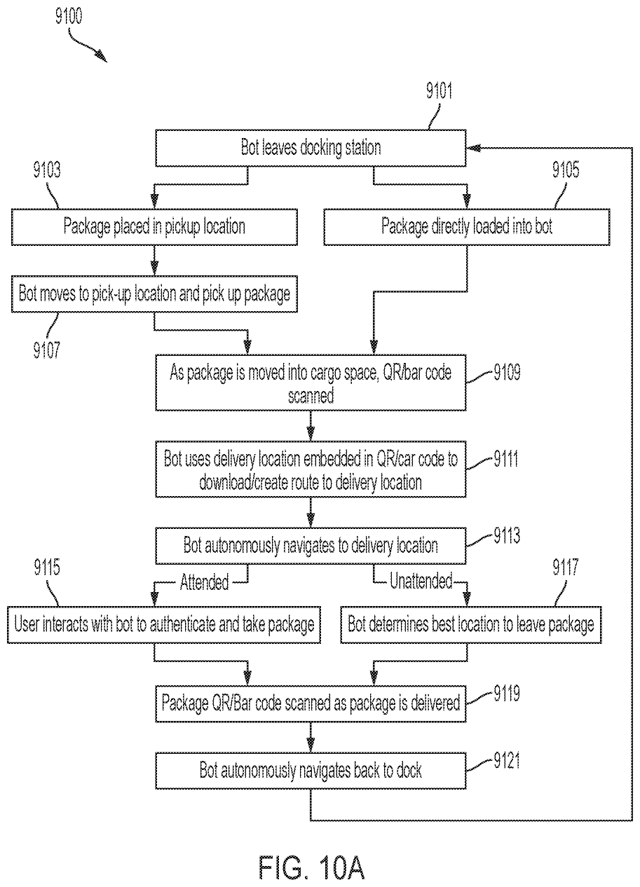

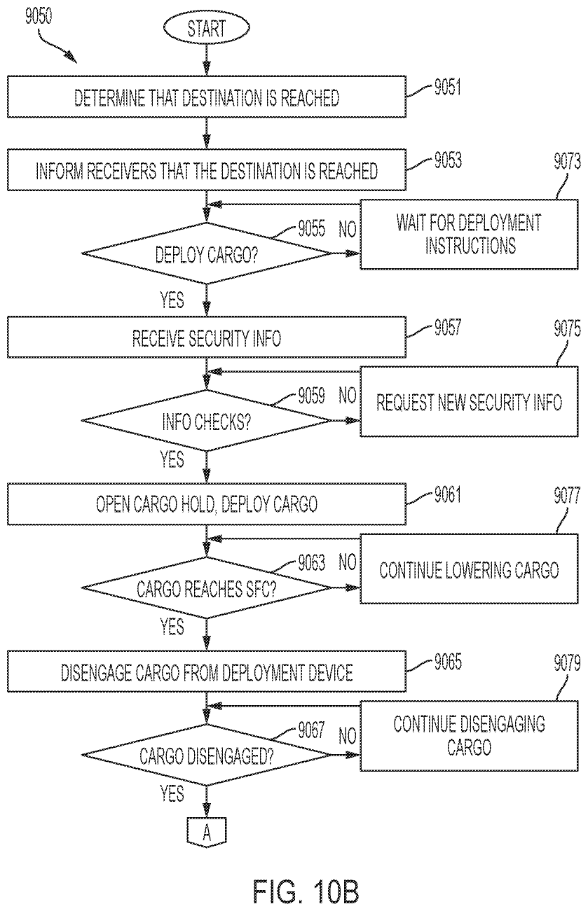

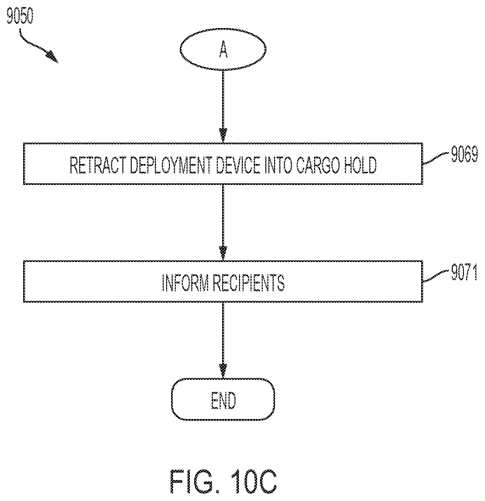

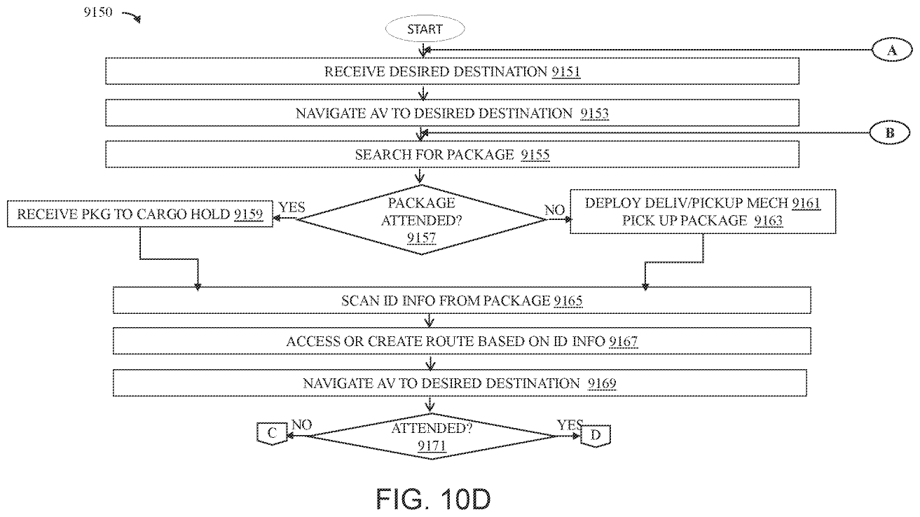

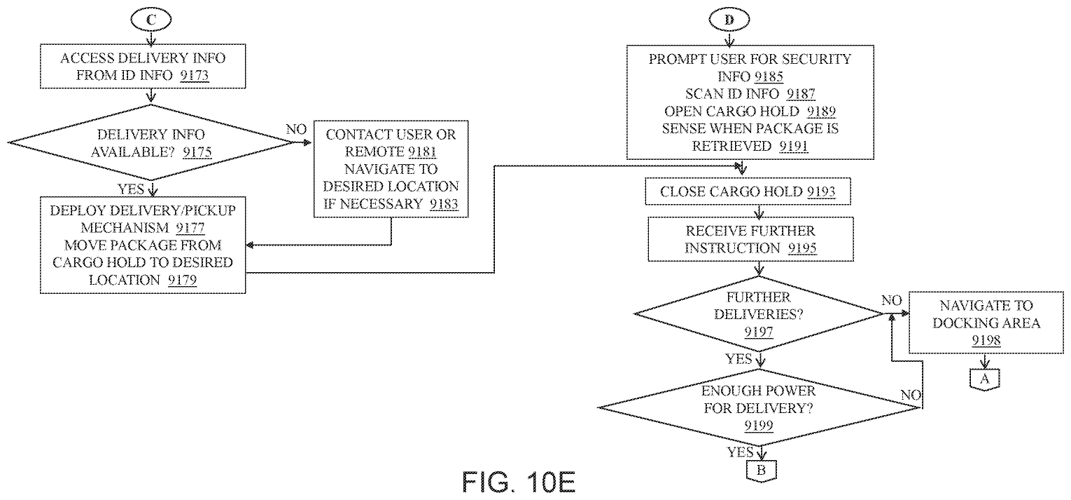

Referring now to FIG. 10A, an exemplary method for unattended delivery and pickup relies on identifying features on the cargo box or package, for example, to indicate the target travel destination to the autonomous device. Method 9100 includes, but is not limited to including, the autonomous device's leaving 9101 the docking station either housing the cargo box or package or heading to pick up the cargo box or package. If 9105 the cargo box or package is being loaded directly into the cargo area of the autonomous device, as the package is moved into the cargo space, method 9100 includes scanning 9109A the identifying feature. For example, the package can be manually positioned in the cargo area, or the package can be loaded automatically by a robot, for example. If 9103 the package has been placed in a pickup location, method 9100 includes moving 9107 the autonomous device to a target pickup location and scanning 9109A the identifying feature. In some configurations, a user requesting the package pickup can send the request through a handheld/tablet/desktop device, for example, to the autonomous vehicle indicating the target location where the package will be located. The user can remain present at the target location and load the package, or the user can deposit the package at the target location, and in both cases the autonomous vehicle can scan the package for destination and other types of information, for example. Method 9100 can include using 9111 the package information to determine a target location. The target location can be determined by contacting a remote operator, by contacting the owner of the package, or by creating an initial route automatically, or possibly a combination of ways. Method 9100 can include autonomously navigating 9113A to the target location according to the initial route and avoiding obstacles detected in real-time along the route. For attended delivery, method 9100 can include, when reaching the target location, enabling 9115A user interaction with the autonomous vehicle. The user interaction can include entering a security code, for example, either directly into the autonomous device, or through an application interface residing on a handheld, tablet, laptop, or the like. The user entry can enable the doors of the autonomous vehicle to open, for example, and the cargo box and/or package to be provided to the user. If the delivery/pickup is unattended, method 9100 includes determining 9117A by the autonomous device, where to deposit the cargo. For example, if the surface at the target location is determined by the autonomous device to have issues such as moisture or other challenging characteristics, the autonomous device searches for a better place to deploy the cargo during a delivery. In some configurations, the autonomous device includes environmental and image sensors that can provide surface and other information to the autonomous device. The autonomous device uses such data in its navigation, and can take the extra step of determining a delivery location based on the data. In either the attended or the unattended case, method 9100 includes scanning 9119 by the autonomous device identification associated with the package or cargo box. The autonomous device can use the data from the identification information to inform the recipient, for example, that the package has been delivered, the environmental conditions, the time of day, and any other information that might be useful to the recipient. The autonomous device in some configurations can inform a remote controller that it has completed a delivery or pickup, and can receive a next route, if any. In one scenario, method 9100 includes navigating 9121 of the autonomous device to a docking station. The autonomous device can route itself elsewhere, to further deliveries (if the autonomous device has multiple cargo bays) and/or pickups. The autonomous device can determine from a daily task list where to go next, or can receive commands from a remote operator (either a human or a computer) after each delivery/pickup.

Referring now to FIGS. 10B and 10C, in one aspect, method 9050 of the present teachings contemplates unattended delivery of cargo by an AV, and can include determining 9051 (FIG. 10B) that a desired destination is reached and informing 9053 (FIG. 10B) pre-selected recipients that the desired destination is reached. The desired destination can be selected by at least one of the recipients and transmitted to a deployment manager. In an aspect, a recipient can include the person who purchased the cargo that is destined for unattended delivery. In an aspect, a recipient can include a remote controller of the AV. In an aspect, through appropriate sensors and on-board processing, the AV can determine if it has reached the desired destination. In an aspect, a remote controller can either partially or completely navigate the AV to the desired destination. If 9055 (FIG. 10B) instructions to deploy cargo are not received, method 9050 can include waiting 9073 (FIG. 10B) for deployment instructions. If 9055 (FIG. 10B) instructions to deploy cargo are received, method 9050 can include remotely receiving 9057 (FIG. 10B) security information associated with the cargo from a recipient. If 9059 (FIG. 10B) the security information is incorrect, method 9050 can include requesting 9075 (FIG. 10B) new security information. If 9059 (FIG. 10B) correct security information is received, method 9050 can include opening 9061 (FIG. 10A) the cargo hold associated with the cargo, the cargo being associated with the recipient and the provided security information, method 9050 including deploying the cargo. If 9063 (FIG. 10B) the cargo is not deployed, method 9050 can include continuing 9077 (FIG. 10B) to deploy the cargo. If 9063 (FIG. 10B) the cargo has reached a deployment surface, method 9050 can include disengaging 9065 (FIG. 10B) the cargo from the deployment device. If 9067 (FIG. 10B) the cargo is not disengaged from the deployment device, method 9050 can include continuing 9079 (FIG. 10B) to disengage the cargo from the deployment device. If 9067 (FIG. 10B) the cargo is disengaged from the deployment device, method 9050 can include retracting 9069 (FIG. 10C) the deployment device into the cargo hold, and informing 9071 (FIG. 10C) the recipients.

Referring now to FIGS. 10D and 10E, when the package self-identifies, in an aspect, routing information is included on the package, or can be derived from information on the package. In an example, the identifying information on the package includes the address of the recipient. With the address, the autonomous vehicle determines a route in the way that has been described herein and elsewhere, for example, '007, '522, '205, '613, and '703. The identifying information on the package can include, for example, but not limited to, a bar code (UPC, EAN), a QR code, an RFID label, a pharmacode, or a shipping label. The autonomous vehicle of the present teachings can perform both deliveries and pickups at both vendor and customer locations. For example, the autonomous vehicle could be docked at a vendor location, and could pick up a package at the vendor that has been ordered by a customer. The autonomous vehicle could travel to the package's destination location, drop off the package (either autonomously, semi-autonomously, or recipient pickup), possibly pick up other package(s) at the same location, or travel to another location to pick up other package(s), deliver the package(s) that are being carried anywhere, to a desired customer location or to a desired vendor location, possibly ending up at a docking station to recharge and/or swap power supplies such as batteries. Method 9150 for autonomous pickup and delivery, executed from the point of view of the autonomous vehicle, includes receiving 9151 a desired destination. A remote operator, a user, a self-identified package, or a vendor can provide the desired destination, for example. The user can access an application on a handheld device, for example, and summon the autonomous vehicle to a location. The autonomous vehicle can locate the package associated with the summons, for example. A vendor such as a drug store can provide a package including a prescription and provide the desired destination. Alternatively, the prescription package can self-identify. The remote operator can manage a delivery schedule and provide that to the autonomous vehicle periodically or at check-in points or at check in times, for example. The autonomous vehicle can determine its route and desired destinations during its duty cycle by gathering directions from remote operators, users, vendors, and packages themselves. Method 9150 includes navigating 9153 to the desired destination. As described herein, the autonomous vehicle begins with a route and changes the route dynamically, depending upon sensor input and what obstacles are in the path of the autonomous vehicle. Method 9150 includes searching 9155 for the package. The autonomous vehicle includes sensors and machine learning models that enable locating the package. If 9157 the package is attended, method 9150 includes receiving 9159 the package into the cargo hold of the autonomous vehicle. The autonomous vehicle can receive communications from the package provider at the desired location that enables the autonomous vehicle to enact attended reception processes. Steps that lead up to receiving the package include receiving identifying information from the package provider, the identifying information causing the cargo hold to open for the package provider to deposit the package. If 9157 the package is unattended, method 9150 includes deploying 9161 a delivery/pickup mechanism from the autonomous vehicle and using the delivery/pickup mechanism to retrieve 9163 the package. The delivery-pickup mechanism can include such devices as are described herein. Method 9150 includes scanning 9165 identifying information from the package, if available. If available, the identifying information, possibly in the form of a code, is processed by the autonomous vehicle to parse out information that is included in the code. For example, the identifying information could include a destination address, a description of the contents of the package, security codes required before the package is released from the cargo hold, contact information for the intended recipient, or directions to contact a remote control operator. In an aspect, identifying information includes route information that the autonomous vehicle could use to optimize route creation, and/or seek help from a recipient and/or remote operator with navigation. Method 9150 includes accessing or creating 9167 a route based on the identifying information, present or not, for when the identifying information is not present, the autonomous vehicle seeks navigation help from a remote operator, for example. Method 9150 includes navigating 9169 to the desired destination determined based on the identifying information. If 9171 the desired destination is unattended, method 9150 includes accessing delivery information from identifying information. The delivery information, if available, can include whether to deliver the package to a specific location, such as a front porch, or to a secure area. The secure area could need a passcode, which could be part of the identifying information, enabling the autonomous vehicle to open the secure area using the passcode. The delivery information, if available, could include where to deliver the package if environmental conditions are a concern, such as rain or snow. The delivery tote itself could be weatherproof. If 9175 delivery information is available, method 9150 includes deploying 9177 the delivery/pickup mechanism having the package in the grasp of the mechanism (through means described herein), and moving 9179 the package from the cargo hold to the desired location. If 9175 there is no delivery information available, method 9150 includes contacting 9181 the recipient or a remote operator for instructions, navigating 9183 to the instructed location, deploying 9177 the delivery/pickup mechanism, and moving 9179 the package from the cargo hold to a desired location. If 9171 the desire destination is attended, method 9150 includes prompting 9185, by the autonomous vehicle, the recipient who is attending the delivery for identifying information. The prompting can happen on a face of the autonomous vehicle, and information could be provided into a keypad or verbally, or through biometric means, for example, on the autonomous vehicle cargo box. In an aspect, the prompting can happen on a computer application, verbally, visually, or biometrically, for example. Method 9150 includes scanning 9187 the package for identifying information before the package is retrieved by the recipient. Such scanning enables the autonomous vehicle to track deliveries, inform the vendor and others who might be interested, and create/update a log file. Method 9150 includes opening 9189 the cargo hold so that the recipient can retrieve the package, and sense 9191 when the package is retrieved. Whether or not the delivery is attended, method 9150 includes closing 9193 the cargo hold (if there are no packages to be received and scanned at the location), and receiving 9195 further instructions from, for example, a remote control operator, a delivery truck, a vendor, or a summoning user. If 9197 there are further deliveries or other work to be performed by the autonomous vehicle, and if 9199 the autonomous device has enough power for another delivery, method 9150 includes returning to step 9155. If 9197 there are no further deliveries, method 9150 includes navigating 9198 the autonomous vehicle to a docking area and returning to step 9151.

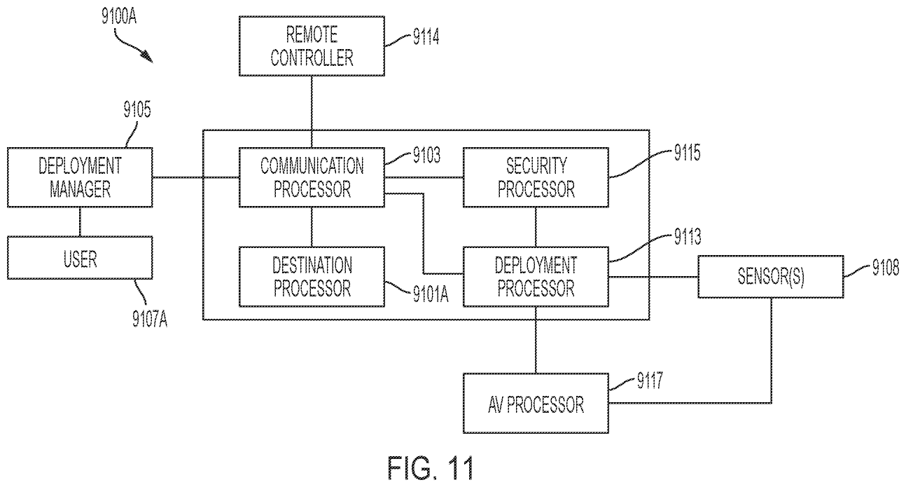

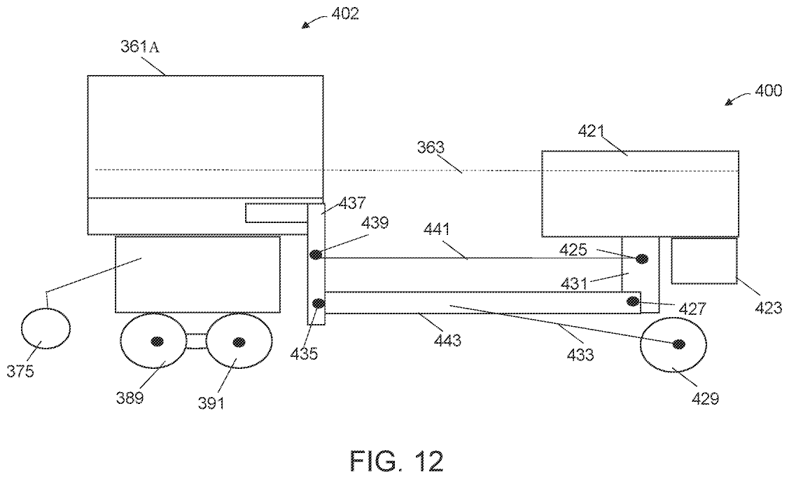

Referring now to FIG. 11, in one aspect, system 9100A of the present teachings for unattended manipulation of cargo by an AV can include destination processor 9101A configured to determine that desired destination 9109 has been reached, and to inform, through communications processor 9103, pre-selected recipients 9107A/9114 that desired destination 9109 has been reached. Desired destination 9109 can be selected by at least one of the recipients 9107A/9114 and transmitted to deployment manager 9105. In an aspect, a recipient can include user 9107A, who is expecting the cargo that is destined for unattended delivery/pickup. In an aspect, a recipient can include remote controller 9114 of the AV. In an aspect, remote controller 9114 can either partially or completely navigate the AV to desired destination 9109. In an aspect, the AV can navigate itself to desired destination 9109. Deployment processor 9113 can receive, from communications processor 9103, instructions that user 9107A/9114 desires the cargo to be delivered to desired destination 9109, and can trigger security processor 9115 to request and receive security information associated with the cargo from a recipient. Because there is no recipient present to enter security information, the request to receive security information can be transmitted, by communications processor 9103, to one or more recipients. In an aspect, the recipient can, in advance of the delivery, provide alternative means for unattended delivery/pickup. Alternative means can include, but are not limited to including, providing, to the sender of the cargo, one or more designated ways that security processor 9115 can receive security information through, for example, communication processor 9103. Security processor 9115 can receive security information from communications processor 9103, and check that the security information is associated with the cargo in an expected way. In an aspect, security information is gathered by sensors 9108. The security information can include a password, a cargo identification, a customer identification, or any combination of recipient-specific information. The security process can be as extensive as necessary to protect the cargo, for example, a two-factor authentication can be required. Security processor 9115 can notify the recipient or designate if the security information is incorrect, and can request further security information. When the security information has been verified, security processor 9115 can trigger deployment processor 9113 to open the cargo hold associated with the cargo associated with the recipient and the provided security information. Deployment processor 9113 can initiate deployment of the cargo. Various deployment methods have been contemplated by the present teachings and discussed herein. For example, deployment processor 9113 can direct AV controller 9117 to open the doors of the cargo hold and propel the delivery container, cradled by a deployment device, outside of the cargo hold. Deployment processor 9113 can direct AV controller 9117 to move the delivery container to a surface. Depending upon the delivery destination, the surface can be above or below the level of the cargo hold. When the surface is below the cargo hold, deployment processor 9113 can direct AV controller 9117 to lower the delivery container to the surface. When the delivery container has reached the surface, whether above or below the level of the cargo hold, deployment processor 9113 can direct AV controller 9117 to disengage the deployment device from the delivery container. Methods for disengagement have been discussed herein. Sensors can indicate when disengagement is complete. At this time, deployment processor 9113 can direct AV controller 9117 to retract the deployment device into the cargo hold and close the door(s) of the cargo hold. Retraction can take different forms, depending upon the nature of the deployment device. Various retraction techniques have been discussed herein. After retraction is complete, deployment processor 9113 can direct AV controller 9117 to inform the recipients of a completed unattended cargo deployment. In an aspect, alternative delivery destinations can be selected in case, for example, the AV is not able to navigate to the desired delivery destination, or an inclement environment exists at the desired delivery destination, among other reasons.

A trailer of the present teachings can enhance the utility of a delivery/pickup vehicle by (1) providing additional storage space, (2) providing additional energy storage or power supplies, (3) maintaining a consistent pitch between the cargo section of the delivery vehicle and the cargo section of the trailer, regardless of the underlying terrain or the delivery vehicle wheel configuration, and (4) buffering vertical and horizontal movement of the trailer. The trailer can be used to increase carrying capacity of the delivery/pickup vehicle which can include manually driven and autonomous vehicles. The trailer can be left behind with the delivery, for example, or can be used to deploy the cargo in, for example, but not limited to, a secure delivery container, or can be used for cargo pickup. The trailer can include suspension to provide a relatively smooth ride for the cargo, even over uneven terrain. For example, a mountain bike-type suspension can be used in conjunction with a sling arm connected to the wheels of the trailer. The trailer may include wheels that are relatively large when compared with a standard roadside curb, which may facilitate the trailer's climbing such a curb. The trailer can further include supplemental power supplies that are, in some configurations, wired to the towing vehicle, and can possibly extend the range of an autonomous vehicle. Storing the supplemental batteries underneath the trailer frame may provide a lower center of gravity for the trailer. A configuration of the trailer can include storage locations for supplemental power sources for the towing vehicle. For example, supplemental batteries can be stored underneath a trailer frame, for example. In an aspect, the supplemental power supplies can power such devices as sensors and lights on the trailer. In an aspect, the trailer includes at least one sensor that assists the autonomous vehicle in evaluating its environment. The at least one sensor can include, for example, but not limited to, ultrasonic, short range radar, and/or cameras. The sensor(s) can be located at the rear of the trailer, on the cargo box, and/or on the sides of the trailer and cargo box. In an aspect, the trailer includes a linkage that enables the payload of the trailer to pitch with the cargo box of the autonomous vehicle. The linkage can include a 4-bar linkage, for example. The trailer, in some configurations, stabilizes the autonomous vehicle at relatively higher speeds. In some configurations, the trailer includes at least one processor that performs, for example, sensor processing and power control, among other actions in support of either manual or autonomous navigation. The trailer can be connected to a towing vehicle such as, for example, but not limited to, an autonomous device. In an aspect, the hitch between the trailer and the towing vehicle includes, for example, but not limited to, a 4-bar cross hitch or a standard ball hitch. In an aspect, the tie rod is connected to the hitch by a spherical end. In an aspect, a steering damper provides a resistance to yaw motion between the trailer and the autonomous device. The steering damper can include, but is not limited to including, a hydraulic cylinder or an oil-filled cylinder, including a needle valve that can be used to adjust the resistance.

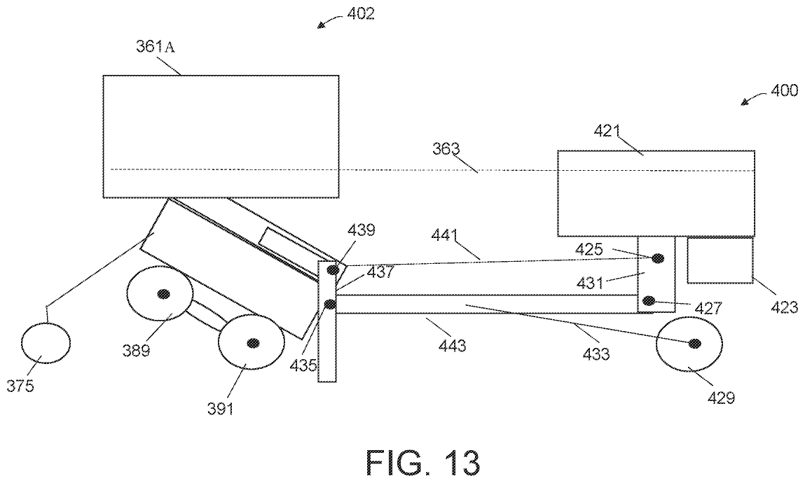

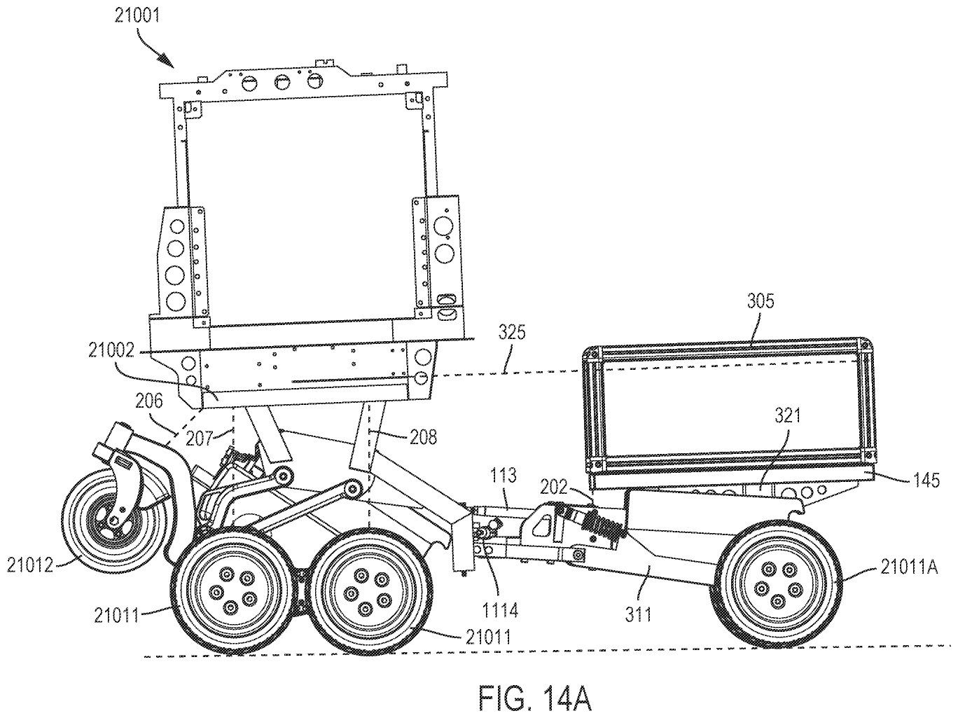

Referring now to FIGS. 12 and 13, a simplified version of a trailer of the present teachings including certain features is shown. For example, trailer 400 includes storage space 421 that can be used to carry cargo. The cargo can include, but is not limited to including, loose items, bagged items, boxed items, and/or a secured delivery container. Storage space 421 can be open, covered, partly covered, and/or convertibly covered. Storage space 421 can provide secure storage that can be locked and unlocked remotely or locally. Storage space 421 may have some or all of the feature of the cargo section of the delivery vehicle as described in U.S. patent application Ser. No. 16/926,522 entitled System and Method for Real time Control of an Autonomous Device, filed Jul. 10, 2020, and incorporated herein by reference in its entirety.

Continuing to refer to FIGS. 12 and 13, trailer 400 can also provide storage or mounts, for example, outside of the cargo area, for power supplies 423. In an aspect, power supplies 423 such as batteries or fuel cells can be used to power devices found on trailer 400 such as sensors and lights. In an aspect, power supplies 423 can provide supplemental power to the vehicle that is enabling the movement of trailer 400. In an aspect, power supplies 423 can be wired to the towing vehicle, can be replacement batteries that can be swapped with the batteries on the towing vehicle, and/or can power devices on the trailer. In an aspect, power supplies 423 can include, but are not limited to including, batteries, fuel cells, solar collection devices, and wind collection devices. Power supplies 423 can be mounted under, above, within, or beside storage space 421.

Continuing to refer to FIGS. 12 and 13, a feature of trailer 400 is that the cargo section carried by trailer 400 maintains the same pitch as the cargo section carried by the towing vehicle. To enable a linkage between trailer 400 and the towing vehicle that supports pitch consistency, trailer 400 is connected to the towing vehicle to form a 4-bar linkage that includes four rigid elements: tie rod 441, trailer frame structure 443, mast 431, and hitch cross 437 hitching the trailer to the towing vehicle. The rigid elements are arranged in a vertical plane. Here, vertical plane means a plane that is perpendicular to a plane defined by the drive wheels of the towing vehicle or the base of the storage space 421. The storage space, or cargo section, 421 is rigidly mounted to the mast 431 and thus maintains a fixed orientation with respect to the mast orientation.

Continuing to still further refer to FIGS. 12 and 13, the tie-rod and trailer base structure are each connected to mast 431 by pivots (425, 427) that allow rotation in the vertical plane. In an aspect, the trailer-mast pivot 427 and the tie-rod-mast pivot 425 only allow motion in the vertical plane. The tie-rod and trailer base structure are connected to the cross-hitch on the tow vehicle with pivots 439,435 that allow rotation in both the vertical and horizontal planes. In an aspect, the tie-rod—hitch-cross pivot 439 and/or the trailer plate—hitch-cross pivot 435 are universal joints, pillow block bearings, elastic couplings, or other mechanical joints that allow rotation in two orthogonal planes. The four-bar linkage comprising the tie-rod 441, mast 431, trailer base structure 443, and hitch-cross 437 form a parallelogram where the opposite pairs of bars are always parallel. In this case, hitch-cross 437 and mast 431 are always parallel, so that the pitches of hitch cross 437 and therefore cargo section 421 are always the same as cargo section 361A in towing vehicle 402 which is rigidly connected to hitch-cross 437.

Continuing to refer to FIGS. 12 and 13, when the terrain is challenging or variable such as, but not limited to, including steps, uneven ground or soft-ground, each tire 429 can independently adjust through swing arm 433. The swing arms 433 may include a spring/damper or shock absorber to form the suspension of the trailer. The base of the cargo section 421 is decoupled from the vertical motion of the tire 429, and decoupled from the 4-bar linkage. The pitch of the cargo section 421 is tied to the pitch of the cargo section of the towing vehicle through the 4-bar linkage.

Continuing to refer to FIGS. 12 and 13, illustrations of a towing vehicle and trailer of the present teachings are shown. Towing vehicle 402 in the illustration is configured to adjust to the terrain by employing different numbers of drive wheels. In FIG. 1A, towing vehicle 361A is shown with four (two not shown) drive wheels 389/391 making ground contact for the purpose of navigating challenging terrain. The four-bar linkage that includes tie-rod 441, trailer frame structure 443, mast 431, and hitch cross 437 can maintain consistent pitch 363 between the cargo in towing vehicle 402 and trailer 400, while tire 429 maintains ground contact through swing arm 433. In FIG. 13, towing vehicle 402 is shown with four (two not shown) drive wheels 389/391, only one (drive wheel 391) of which is making ground contact. Caster 375 provides the required balance for standard driving on relatively smooth terrain where only two drive wheels are required. Tie rod 441 and trailer frame structure 443, connected to mast 431, can maintain consistent pitch 363 between the cargo in towing vehicle 402 and trailer 400, while tire 429 maintains ground contact through swing arm 433.

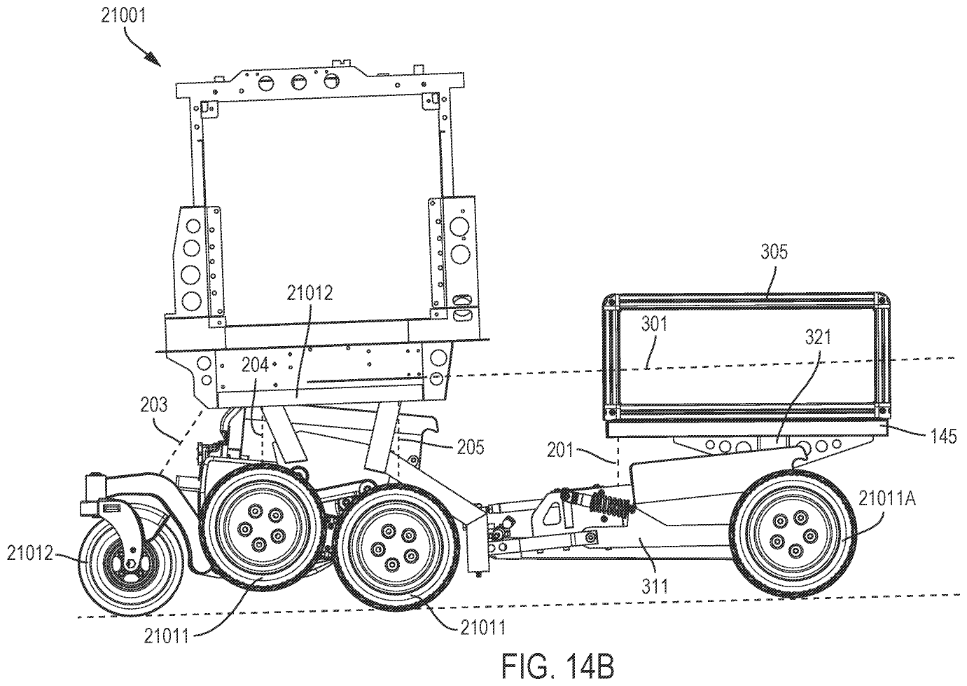

Referring now to FIGS. 14A and 14B, a configuration of the trailer of the present teachings embodying the features described herein is shown. The present teachings are not limited to the configurations shown in FIGS. 14A and 14B. These configurations, and other drawings herein, are provided for illustrative purposes only. Towing vehicle 21001 includes a cargo area that rests on platform 21002. In FIG. 14A, towing vehicle 21001 is configured for challenging terrain, deploying four (only two are shown) drive wheels 21011, and retracting caster 21012 as it is not needed in this situation. In FIG. 14B, towing vehicle 21001 is configured for smooth terrain, deploying two (only one is shown) drive wheels 21011, along with caster 21012 as it is needed in this situation. Tie rod 113 and spar (not shown), connected to mast 321, are angled to maintain consistent pitch 325 (FIG. 14A) and 301 (FIG. 14B) between the cargo in towing vehicle 21001 and trailer 305, while trailer tire 21011A maintains ground contact through swing arm 311. A distance between the cargo box of trailer 305 (FIG. 14A) and a platform (not shown) above tie rod 113 can be seen to be lower than distance 201 (FIG. 14B) between the cargo box of trailer 305 and a platform (not shown) above tie rod 113. Other such comparisons include distance 206 (FIG. 14A) compared to distance 203 (FIG. 14B), in the autonomous vehicles is in 4-wheel mode (FIG. 14A) in which caster 21012 is lifted, versus standard mode (FIG. 14B) in which caster 21012 rests on the surface. In 4-wheel mode (FIG. 14A), distance 207 is greater than distance 204, i.e., the front wheel is on the surface in 4-wheel mode and lifted in standard mode. Although the distances vary in each case, the pitch of the cargo box remains the same in each case (and the same as the pitch of the trailer). Distance 208 (FIG. 14A) versus distance 205 (FIG. 14B) illustrates why the pitch does not change from one mode to another, specifically, because the distance between the cargo box and the rear wheel changes, depending upon the mode. Nevertheless, in both situations, the pitch 325/301 of the cargo in both towing vehicle 21001 and trailer 305 is consistent. In an aspect, trailer 305 can include conventional steering damper 1114.

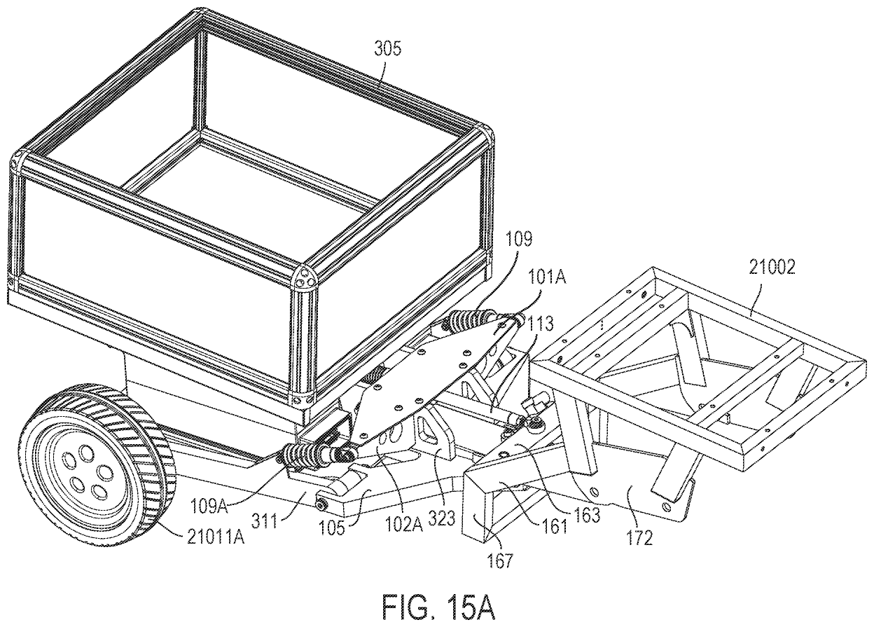

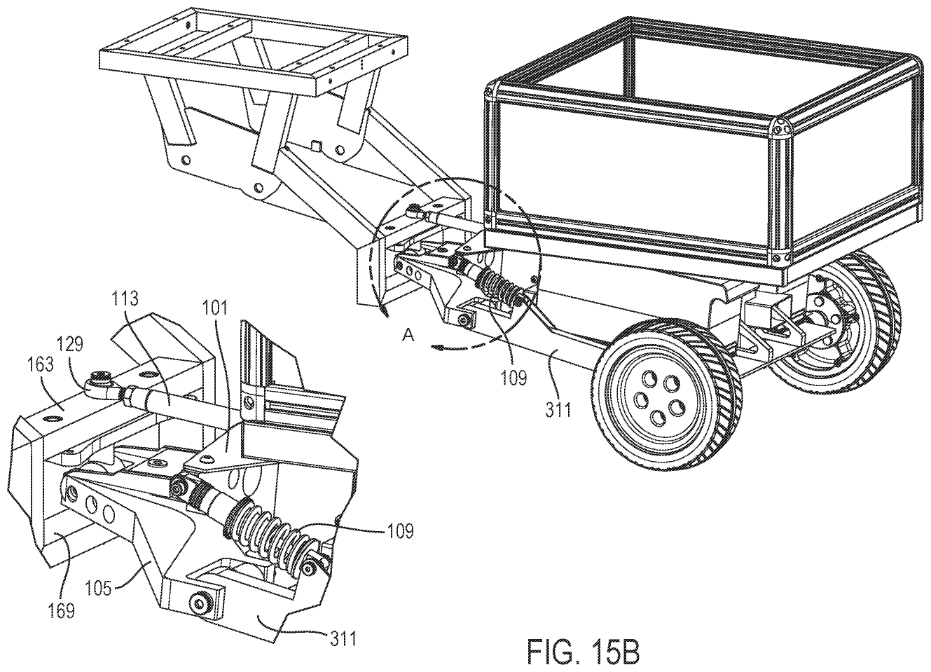

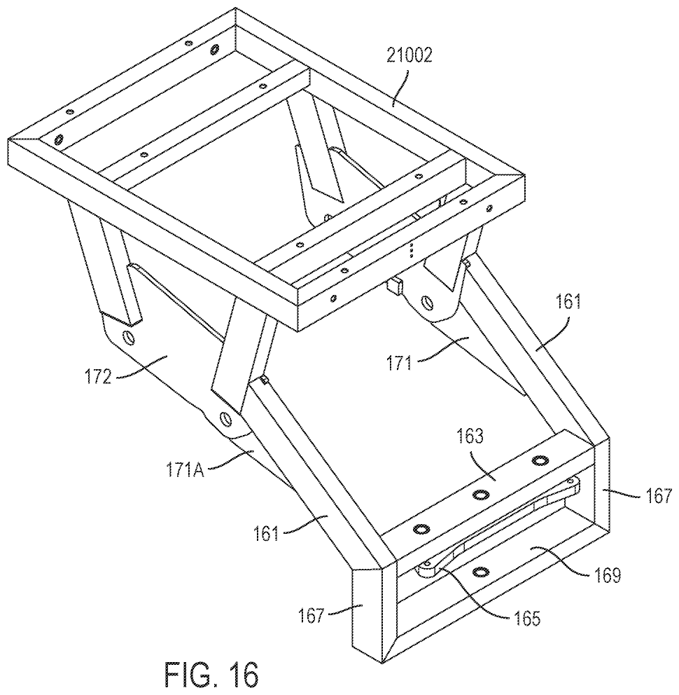

Referring now to FIGS. 15A and 15B, the trailer of the present teachings can include wheels 21011A coupled at their axles with swing arms 311. Swing arms 311 are pivotally connected to yoke halves 105 that meet at hitch cross 107. Yoke halves 105 are operably coupled with trailer frame plates 323, which themselves are operably coupled with shock tower brace 101A and shock mounts 102A. Swing arms 311 can also provide mounting features for shocks 109A, which are also coupled with shock mounts 102A. Shocks 109A can include any kind of movement buffering and absorption device including, but not limited to, springs and dampers.

Referring now to FIG. 16, the trailer of the present teachings can be hitched to a towing vehicle by a configuration of braces. The braces act as an interface between the trailer and platform 21002 and wheels of the towing vehicle. One such brace configuration includes hitch pin sleeve 169 that provides a means for coupling the hitch pin of the trailer with the brace configuration. Hitch tubes 167 operably couple hitch pin sleeve 169 with hitch crossmember tube 163. Hitch crossmember tube 163 provides a means for coupling the tie rod and spar to the brace configuration, coupled together with the hitch pin. A second set of hitch tubes 161 operably couple the hitch brace configuration with the wheel configuration and platform of the towing vehicle. In an aspect, hitch plates 171A and 4-bar interface plates 172 provide the interface between the hitch brace configuration and the towing vehicle.

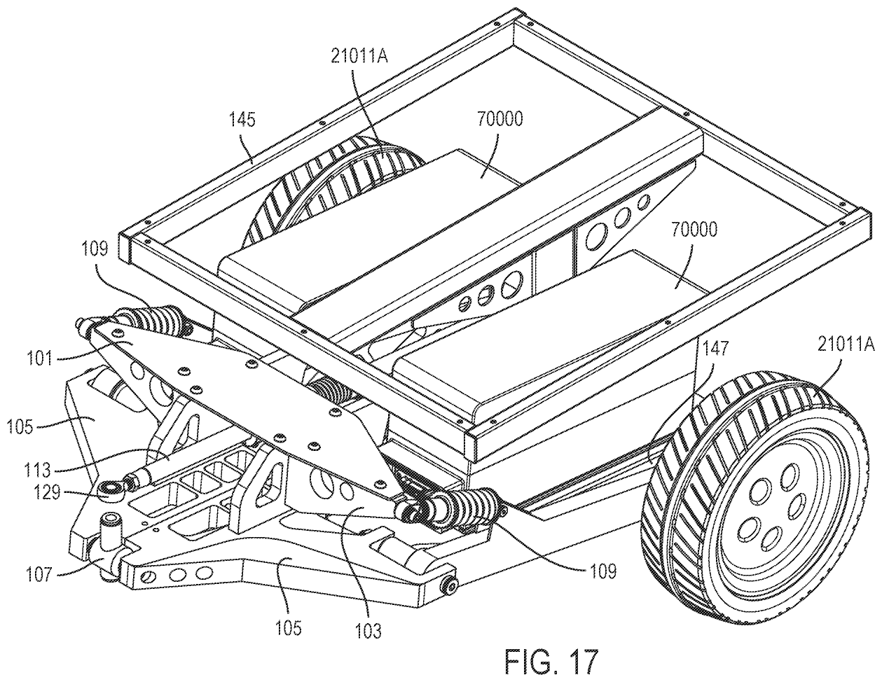

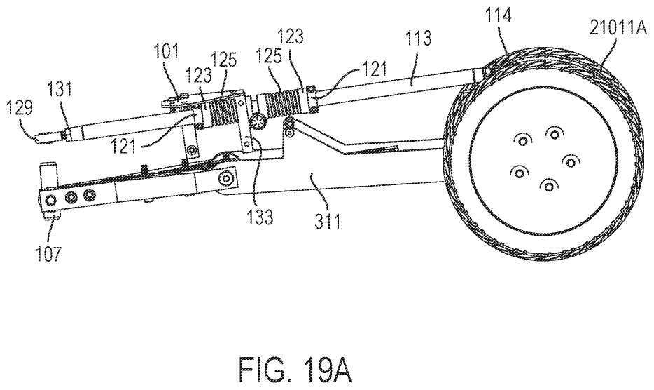

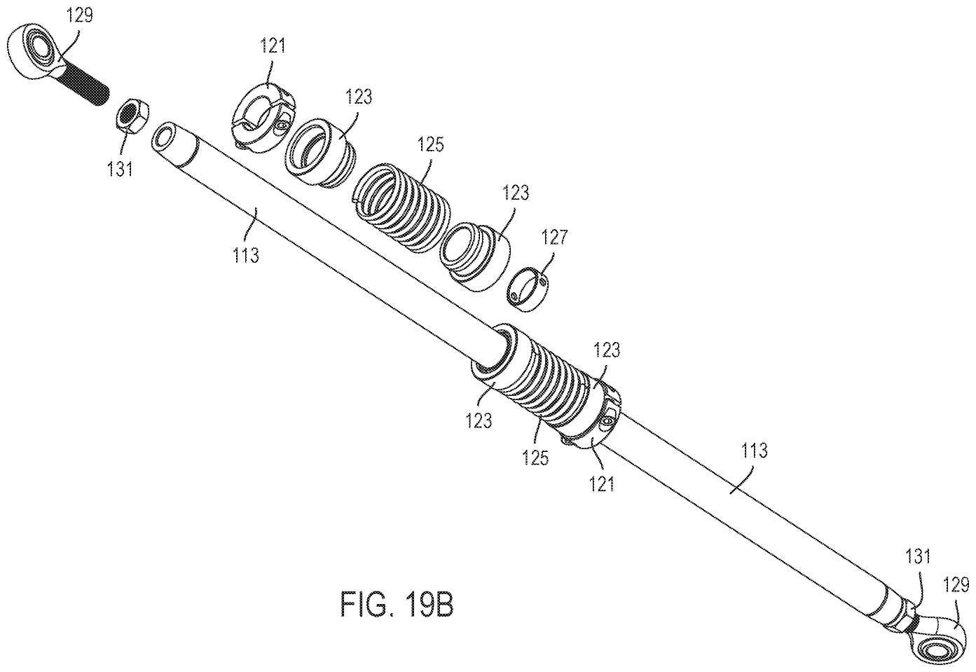

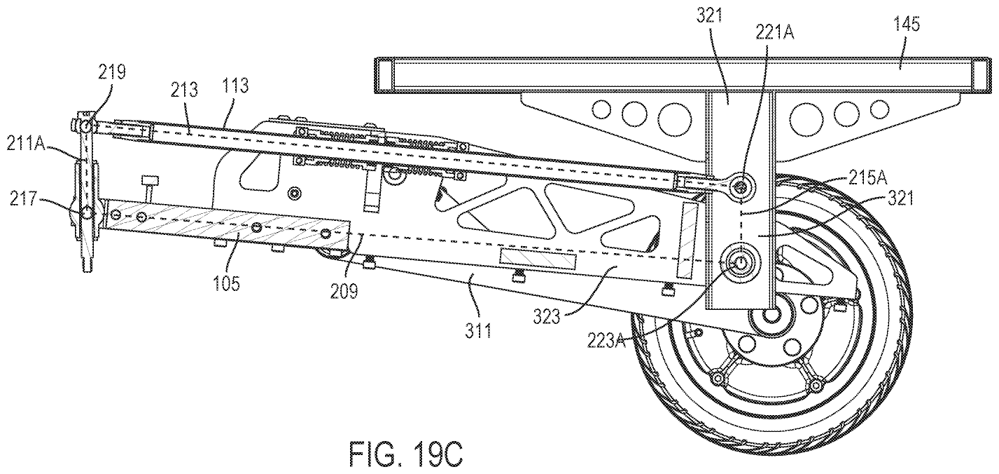

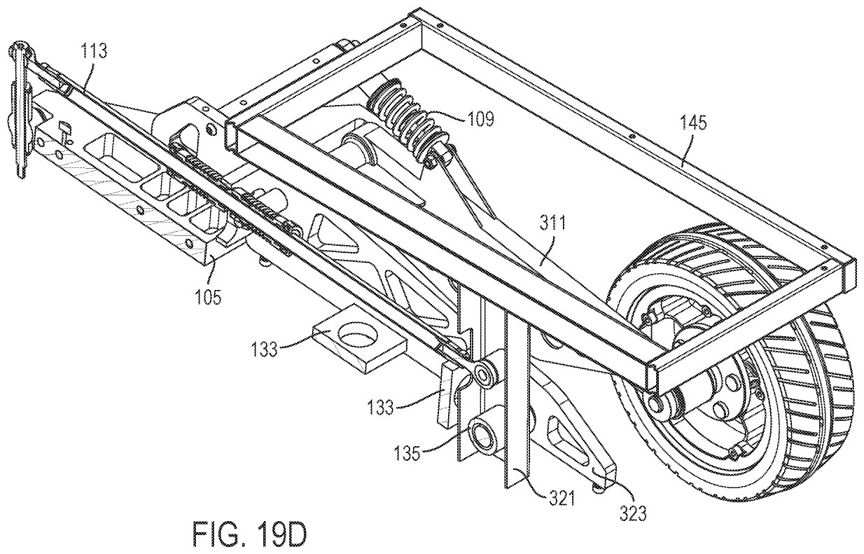

Referring now to FIG. 17, an exemplary trailer is shown without the cargo bed to illustrate features such as supplemental batteries. Tie rod 113 includes rod end 129 that operably couples (using nut 131 (FIG. 19A)) with hitch cross 107 using a hitch pin (not shown). Note that any type of hitch can be used, including, but not limited to, various kinds of ball hitches, hitch crosses, hook hitches, circular hitches, or pin hitches. The trailer includes batteries 70000 that can be stored under platform 145, for example. Batteries 70000 can be stored within a cargo container (not shown), beside, in front or, or behind platform 145, or, in the case of a covered cargo container, atop the cargo container. Batteries 70000 can rest upon floor pan 147.

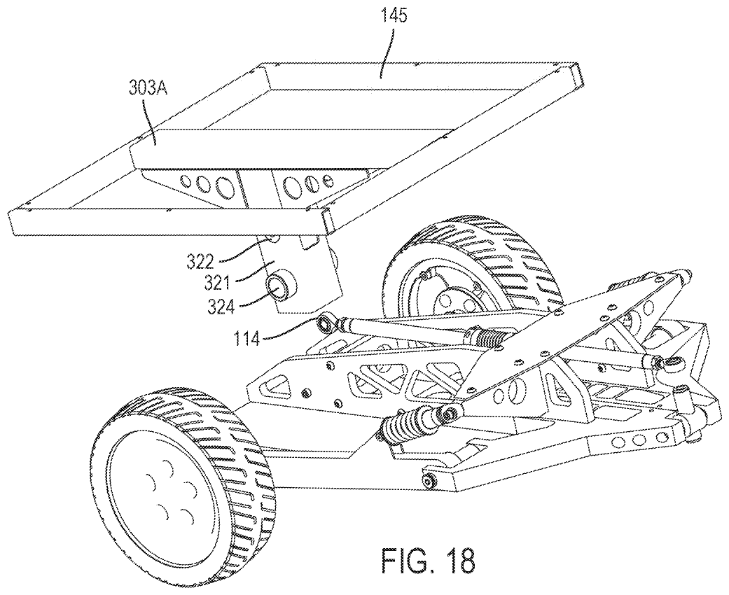

Referring now to FIG. 18, mast 321 provides rotation points 322/324 for the distal 4-bar pivot pins of tie rod distal end 114 and the trailer frame structure. Mast 321 and platform 145 can be operably coupled by mast-platform brace 303A.

Referring now to FIGS. 19A and 19B, in an aspect, tie rod 113 is surrounded by springs 125 that buffer pressures from trailer parts fore and aft of springs 125. Springs 125, kept in place by combinations of piece collars 121 and pitch spring cups 123, respond to the movement of the frame parts of the trailer when the trailer and towing vehicle stop and go at different rates. Between springs 125, and separating them to enable fore and aft movement buffering, is spring stop 127 (FIG. 19B).

Referring now to FIGS. 19C and 19D, a cross section illustrating the pivot points of the 4-bar linkage is shown. Rigid links of the 4-bar linkage can include hitch cross link 211A, tie rod link 213, mast line 215A, and frame structure link 209. Pivot points can include frame structure-hitch cross point 217, hitch cross-tie rod point 219, tie rod-mast point 221A, and mast-frame structure point 223A. As described herein, the 4-bar linkage can rotate vertically. Rotation can be enabled by for example, high load oil bearing 135 (FIG. 19D).

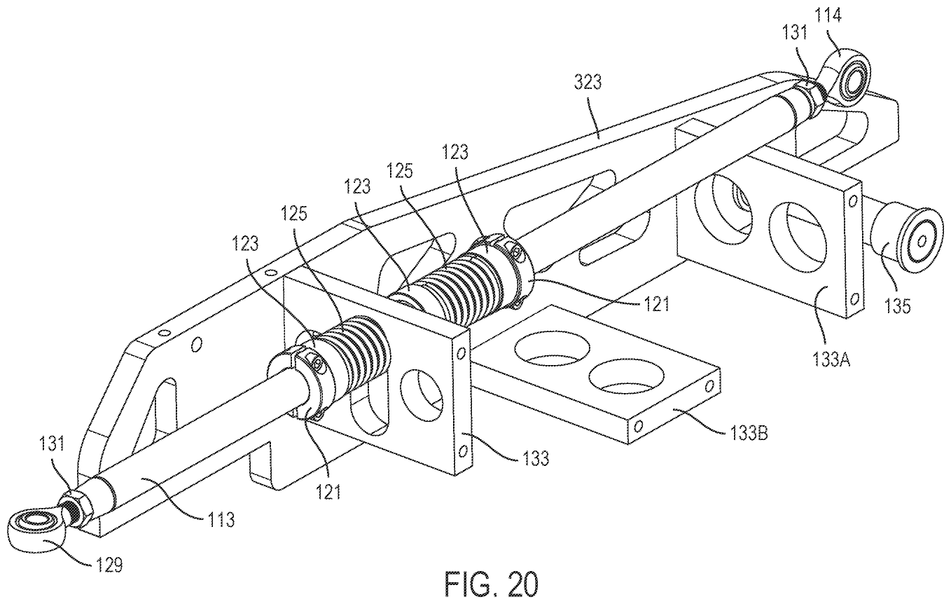

Referring now to FIG. 20, tie rod 113 can be mounted within a first trailer cross bridge 133, and stop a second trailer cross bridge 133A. A third trailer cross bridge 133B can operably couple trailer frame plates 323 that surround tie rod 113.

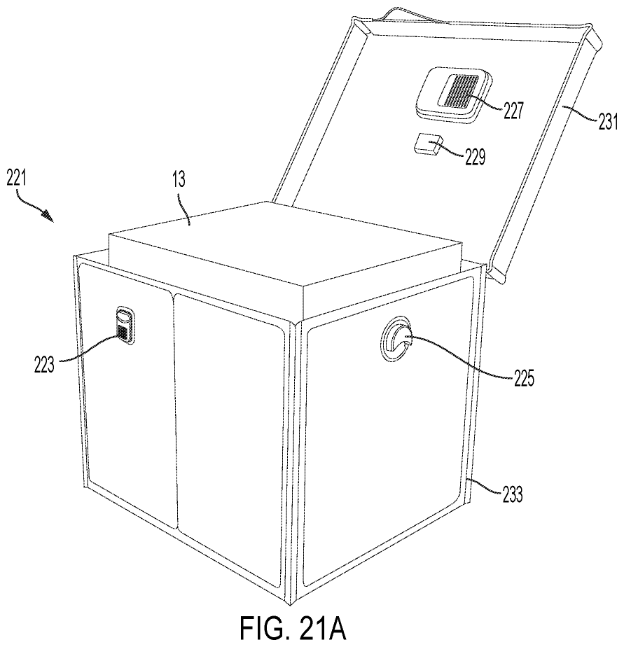

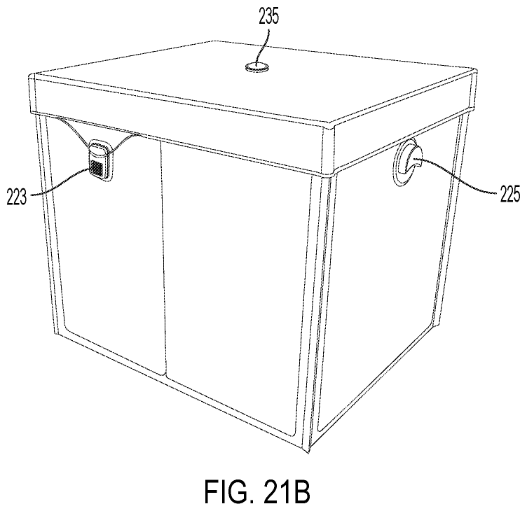

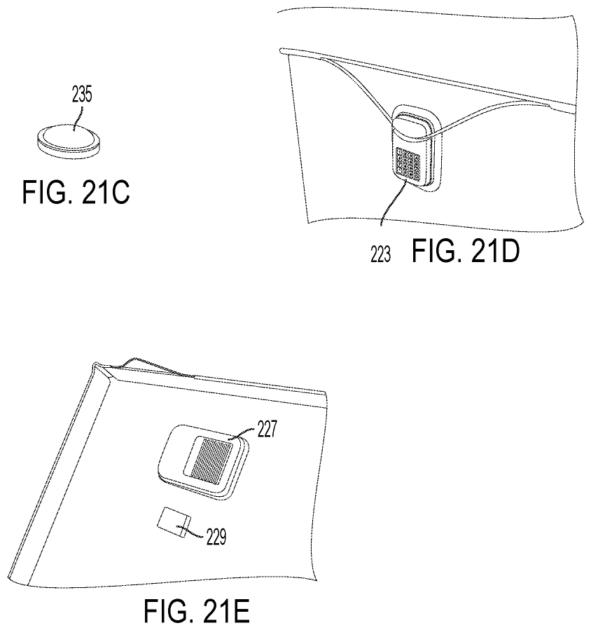

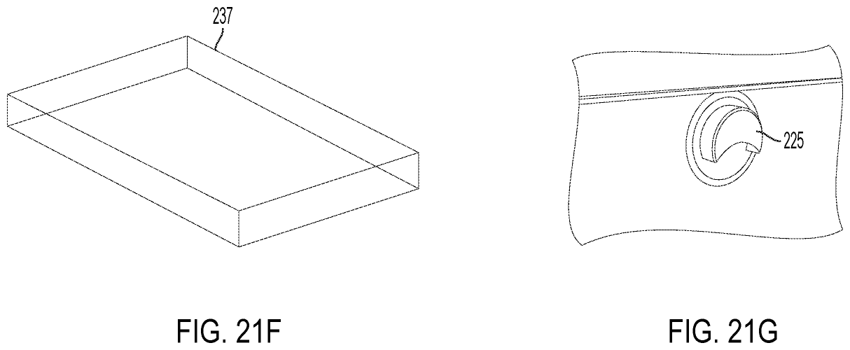

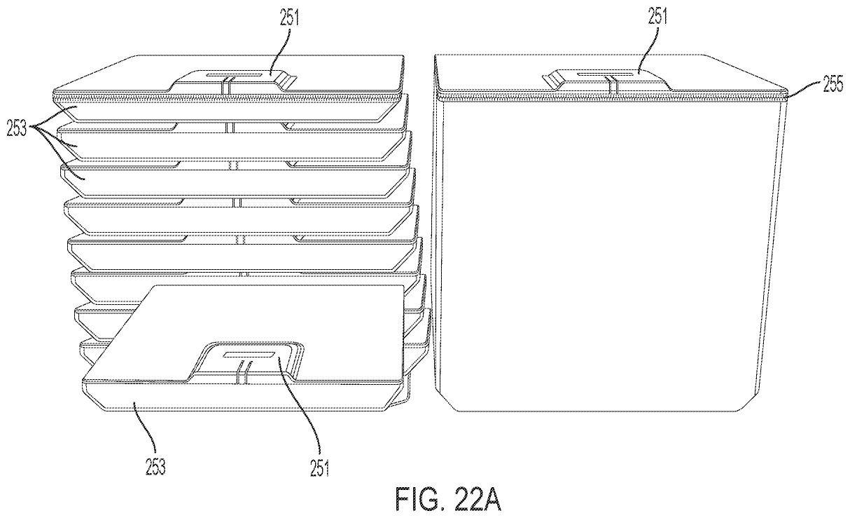

Referring now to FIGS. 21A-21G, one configuration of delivery container 221 can include a box in which cargo can be placed. Container 221 can be any shape, including, but not limited to, a non-uniform shape. Container 221 can be, for example, a grocery bag-shaped container. Container 221 can be fitted with devices that ensure the safety and protection of the contents. In one aspect, container 221 can include a device that can trigger container 221 to activate an unlock sequence. In one aspect, container 221 can include locking entry keypad 223, a finger swipe sensor, or a cell phone or other signal receiver, each of which can enable the user to unlock delivery container 221 using unlock protocols specific to the unlocking mechanism. Delivery container 221 can further include a sensor such as, for example, but not limited to, an imaging device such as, for example, camera 235. Camera 235 can provide a visual image of anything that enters the environment of delivery container 221. Camera 235 can deter malicious actors, and can possibly enable the identification of malicious actors should they tamper with delivery container 221. Camera 235 can be operably coupled with a communications system mounted upon delivery container 221 so that images can be transmitted in real time to anyone who has permission to monitor container 221. Alternatively, the collected images can be stored on board or remotely for later viewing. Camera 235 (FIG. 21C) can be capable of, for example, a 360° collection range. In some aspects, multiple cameras, possibly with different collection ranges, can be mounted in various positions on container 221. All cameras together, if there are multiple cameras, can image the environment around the circumference of delivery container 221. In some configurations, container 221 can include a multi-part cargo holder in which the multiple parts can be operably coupled to enclose cargo within container 221. In an aspect, container 221 can include top 231 and cargo holding area 233 (FIG. 21D), which each can take on any geometry and volume. Top 231 and cargo holding area 233 can be operably coupled by a fastener, the choice of which can depend upon the type of cargo and, for example, the desired security of the cargo. In an aspect, the fastener can include any, some, or all of a zipper, buttons, VELCRO® strips, wire, chain, straps, ropes, or glue. Container 221 can include locator device 229 (FIG. 21E) and/or theft alarm 227 (FIG. 21E). In an aspect, locator device can include a GPS or other location means, and theft alarm 227 can include, for example, but not limited to, a bike alarm, a projector alarm, and/or a panic button. Container 221 can include attachment point 225 (FIG. 21G) for subjecting container 221 to mechanical movement, and tray 237 (FIG. 21F) for positioning cargo within container 221. Configurations of varying sizes and shapes of containers, trays, and associated sensors and attachment points are contemplated by the present teachings.

Referring now to FIGS. 22A-22D, various possible configurations of the delivery container are shown. In one aspect, the delivery container can include a plurality of sections 253 (FIG. 22A), each available for separate secured storage, the entirety of the plurality of sections fitting into a pre-selected sized cargo hold area. Secured storage can be enabled by, for example, but not limited to, keypad area 251 that can include a plurality of security features. Keypad area 251 can be positioned anyplace on container 261 (FIG. 22C) and on individual sections 253 (FIG. 22A). Keypad area 251 can include battery case 252 (FIG. 22B) that can be used to power various features such as, for example, but not limited to, a light, a camera, and/or GPS. Keypad area 251 can include, for example, a keypad, RFID, and/or zipper stops among other features. Container 261 (FIG. 22C) can include flexible, foldable, and/or collapsible material that can enable compact storage of container 261 (FIG. 22C) when container 261 (FIG. 22C) is not in use or is partially in use. Container 261 (FIG. 22C) can include gripping accommodation 262 (FIG. 22B). Gripping accommodation 262 (FIG. 22B) can enable the use of, for example, but not limited to, a handle grip and/or a hook for grabbing and moving container 261 (FIG. 22C). Other means of attachment are contemplated by the present teachings.

Continuing to refer to FIGS. 22A-22D, the delivery container of the present teachings can take any geometry. The delivery containers shown herein are for exemplary purposes only. Further, the delivery containers' open/close mechanisms can include zippers 255 (FIG. 22A), VELCRO® strips, buttons, hooks, and/or other types of fasteners. If exemplary delivery container 261 (FIG. 22C) includes zipper 259 (FIG. 22C), keypad 251 can include zipper stops 271/273. Other fastener stops and attachments are contemplated by the present teachings. Delivery container 261 (FIG. 22C) can further include recesses 265/266 (FIG. 22C) that can be used to attach gripping devices 267 (FIG. 22C) and store handle(s) 269 (FIG. 22C), respectively, for example. Delivery containers of the present teachings can be constructed of flexible material that can collapse for storage or partial use. In an aspect, top and bottom 289 (FIG. 22D) of a delivery container of the present teachings can include rigid or semi-rigid material, for example, light plastic or plastic honeycomb. The delivery container can include telescopic edges 268 (FIG. 22D) that can enable container collapse.

Referring specifically to FIGS. 22E-22G, delivery containers of the present teachings can be constructed of panels, tucks, and flaps organized to enable folding 334 (FIG. 22G) of the delivery container. Delivery containers can be constructed of split panels that can allow folding of the delivery container into flat pattern 336 (FIG. 22G). In an aspect, the panels can be constructed of steel plates that can be split in the middle to enable folding, or can extend the full width of the delivery container if folding is not necessary. In one aspect, the delivery container can be constructed of laminated TPU fabric with steel security panels. The delivery container can include a security system for the delivery container, such as, for example, but not limited to, keypad lock 1013 (FIG. 22E). The security system can also include an imaging system such as, for example, but not limited to, camera 1019 (FIG. 22E), possibly imaging a 360°-radius around the delivery container. In an aspect, the delivery container can include at least one alarm 1023 (FIG. 22E). At least one alarm 1023 (FIG. 22E) can, among other things, generate a notification if the delivery container has been moved, if there is motion around the delivery container, or if there is tampering with the delivery container, for example. The delivery container can include electronics 1021 (FIG. 22E) that can control the features available on the delivery container and can transmit data that can notify the user or another remote system of the status of the delivery and of the delivery container itself. Electronics 1021 (FIG. 22E) can receive information that can be used to control the features included with the delivery container, from opening the delivery container to imaging the surroundings to generating notifications about the status of the delivery and the delivery container. The delivery container can include features that can enable automatic movement of the delivery container, for example, connection point 1017 (FIG. 22E) that can be used by a deployment mechanism that might be mounted within the cargo hold area. In an aspect, the delivery container can include top 1011 (FIG. 22E). In an aspect, top 1011 (FIG. 22E) can include electronics 1021 (FIG. 22E), at least one alarm 1023 (FIG. 22E), and an apparatus to pair top 1011 (FIG. 22E) and cargo hold 1015 (FIG. 22E). The apparatus can include connector 1014 (FIG. 22E) that can operably couple with security lock 1013 (FIG. 22E). Connector 1014 (FIG. 22E) can be released when security lock 1013 (FIG. 22E) is unlocked. The means of unlocking depends at least upon the type of lock and can take any of many conventional forms.

Referring now to FIG. 22F, in another configuration, shock absorbers can be mounted upon a delivery container to reduce the likelihood of damage to the contents of the delivery container and the delivery container itself. In an aspect, shock absorbers can include, for example, but not limited to, gas shocks, springs, and/or cushions. In an aspect, the shock absorbers can retract for storage into the delivery container. In an aspect, the delivery container can include panels 1029 that can reinforce the delivery container as well as enable, along with hinges 1028, collapsibility of the delivery container. In one aspect, the shock absorbers can include springs 1016. When the delivery container is deployed from a height, and gravity drawn or otherwise moved to a lower surface, shock absorbers 1016 can compress to absorb impact.

Referring now to FIG. 22G, an exemplary delivery container that can ride in the trailer of the present teachings can be fully collapsible and stackable. The delivery container can further include security features. In an aspect, the delivery container can include visible features such as openings for imaging and collecting security information. The visible features can be mounted anywhere on the delivery container. In an aspect, imaging feature 2011, security features 2013, and latch 2023 can be mounted upon and within top 2015 of the delivery container. Security feature 2013 can enable the disengagement of latch 2023 to open the delivery container. Top 2015 can include a secure area (not shown) in which can be located the electronics and communications systems that can automate the security features of the delivery container. In an aspect, the delivery container can include panels 2019/2017 that can enable collapsibility of the delivery container. The delivery container can include a feature that can be used to grasp the delivery container for deployment. In an aspect, the feature can include base 2021. Straps, ropes, and other devices can connect to base 2021. Panels 2019/2017 can be joined by hinges, for example, and can be used to fold the delivery container.

Referring now to FIGS. 22H-22M, in another configuration, the delivery container can include a fully collapsible and stackable delivery container. The delivery container can further include security features whose workings are predominantly hidden. In an aspect, the delivery container can include visible features such as openings for imaging and collecting security information. The visible features can be mounted anywhere on the delivery container. In an aspect, imaging feature 2011 (FIG. 22H) and security features 2013 (FIG. 22H) and latch 2023 (FIG. 22H) can be mounted upon and within top 2015 (FIG. 22H) of the delivery container. Security feature 2013 (FIG. 22H) can enable the disengagement of latch 2023 (FIG. 22H) to open the delivery container. Top 2015 (FIG. 22H) can include a secure area (not shown) in which can be located the electronics and communications systems that can automate the security features of the delivery container. In an aspect, the delivery container can include panels 2019/2017 (FIG. 22H) that can enable collapsibility of the delivery container. The delivery container can include a feature that can be used to grasp the delivery container for deployment. In an aspect, the feature can include base 2021 (FIG. 22H). Straps, ropes, and other devices can connect to base 2021 (FIG. 22H) at recesses 2022 (FIG. 22J), for example, as discussed herein. Panels 2019/2017 (FIG. 22H) can be joined by hinges 2025 (FIG. 221), for example, and can be used to fold as shown in FIG. 22K. When the box is completely folded as shown in FIG. 22L, a stack of the boxes as shown in FIG. 22M can be conveniently transported.

Referring now to FIGS. 22N and 22O, the delivery container of the present teachings can take on any shape. In an aspect, the delivery container can include a sectioned top configured with a latching strip. The sectioned top can include sections, a latching mechanism, and security features. In an aspect, the top can include two movable sections 2061/2063 (FIG. 22O). In an aspect, each of the moveable sections can form a single panel with a side of the delivery container. In an aspect, each moveable section 2061 (FIG. 22O) can be connected to a side 2057 (FIG. 22O) of the delivery container. In an aspect, latching strip 2055 can host the security features. Security features can include, but are not limited to including, latching mechanism 2051 and at least one sensor 2053. In an aspect, latching mechanism 2051 can receive a command to open the delivery container, and can disengage latching strip 2055 from latching receiver 2059 (FIG. 22O). Latching mechanism 2051 can include a magnetic latch or an automatic door lock device, for example. At least one sensor 2053 can include, for example, a camera, a movement sensor, an audio sensor, and/or an environment sensor.

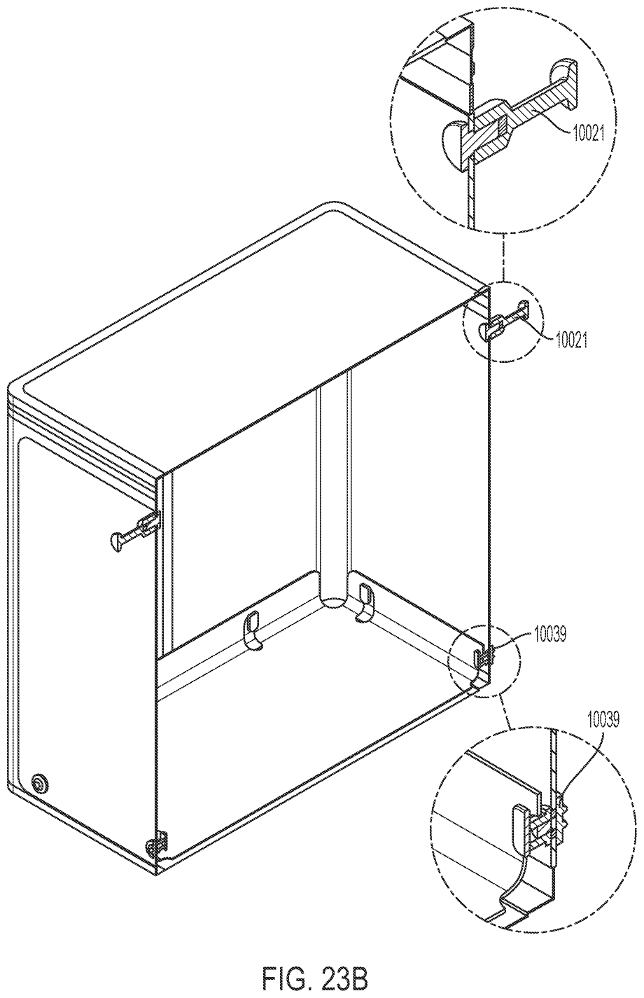

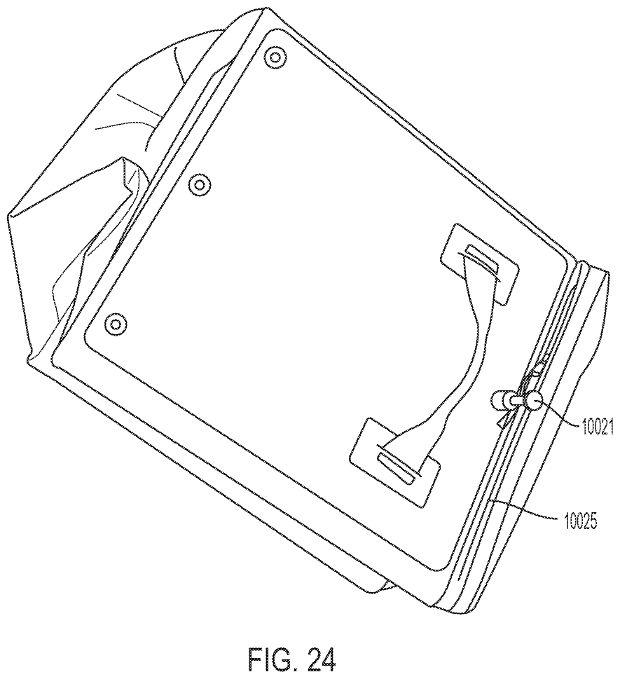

Referring now to FIGS. 23A-23B, an exploded view and a cross section view of an exemplary tote are shown. The shape of the tote shown is exemplary only. The tote can take any shape. For example, its size can conform to the amount of space in the autonomous vehicle for which it is designed to travel. In an aspect, the tote is smaller than the cargo bay of the autonomous vehicle, such that multiple totes can occupy the cargo bay. In an aspect, the tote can take on various shapes such as, for example, but not limited to, a cube, a cylinder, a cone, a sphere, or a pizza box shape. Multiple types of items that are destined for different target locations can occupy the tote. Identifications on the items themselves indicate the ultimate receiver of the item. In an aspect, the tote itself includes identifying information that is used to indicate the destination of the tote to the autonomous vehicle.

Continuing to refer to FIGS. 23A-23B, in an aspect, the tote is impervious to pre-selected environmental conditions, depending upon the materials used in its construction and the extent to which the seams are sealed. For example, if the outer surface of the tote is waterproof, water repellent, or water resistant, then the contents will be protected to some extent from water incursion. If the outer surface has thermal resistance, the outer surface will resist heat flow. If the outer surface has chemical resistance, the outer surface will resist a chemical attack for a specific period of time. Other forms of proofing and resistance are contemplated by the present teachings. Combinations of proofing and resistance can be applied to protect the contents of the tote from various types of environmental incursions, for example, thermal and moisture incursions. In an aspect, the tote outer surface includes outer skin 10023, top/bottom skins 10029, and connecting means 10025. Skins 10023/10029 can be coated with various materials to achieve resistance or proofing, or skins 10023/10029 can be constructed of materials that are inherently proofed, such as, for example, the waterproof material polytetrafluoroethylene. Connecting means 10025 includes some form of fastener that enables accessibility of the contents of the tote. Examples of such fasteners include zippers and hook-and-loop fasteners.

Continuing to refer to FIGS. 23A-23B, inside the outer shell, the exemplary tote of the present teachings includes top panel 10027, small panels 10031, and large panels 10037. Top panel 10027 is situated between top skin 10029 and outer skin 10023. In an aspect, small panels 10031 are situated between outer skin 10023 and inner skin 10035 on the non-pin sides of the tote. The plurality of small panels 10031 shown in FIG. 23A illustrate a configuration in which the sides of the tote are collapsible, folding at the seam between small panels 10031. Other configurations are contemplated by the present teachings. For example, there can be more than two small panels 10031, enabling a different type of fold. Large panels 10037 are situated between outer skin 10023 and inner skin 10035, and provide further support for the weight that tote pins 10021 must endure. In an aspect, tote pins 10021 are grasped by a lift/lower-raise mechanism that enables attended or unattended delivery/pickup of packages. The interior of the tote is bounded by inner skin 10035 and tote tray 10033. In an aspect, tote tray 10033 enables relatively weighty articles to be transported in the tote. In an aspect, tote tray 10033 is removably secured to large panels 10037 by combination 10039 (FIG. 23B) of a flanged bolt connected to a female hook. Other forms of attachment between tote tray 10033 and large/small panels 10021/10031 are contemplated by the present teachings.

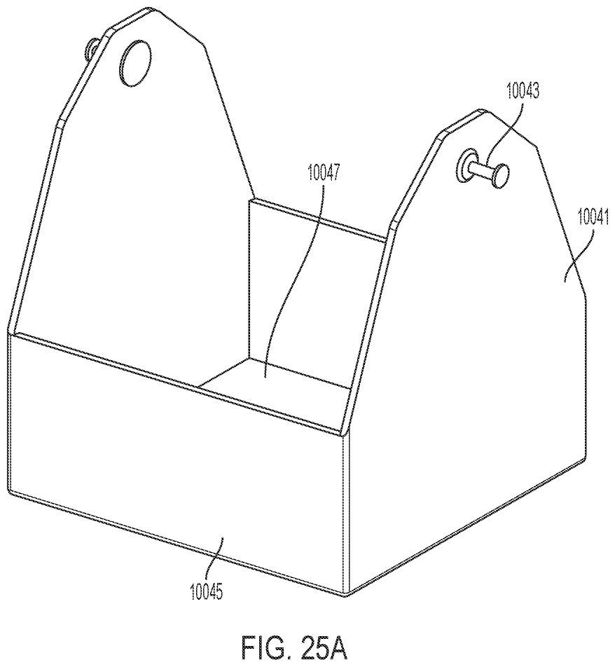

Referring now to FIG. 24, an exemplary collapsed tote is shown. In an aspect, the collapse tote includes flexible panels and trays.

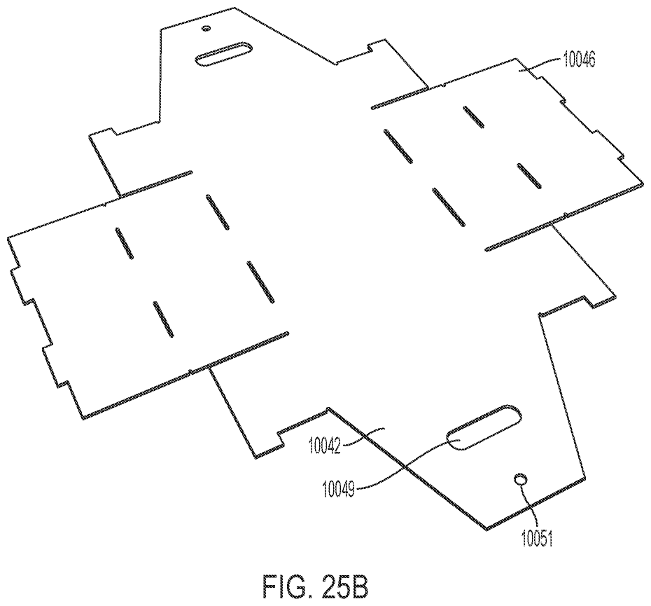

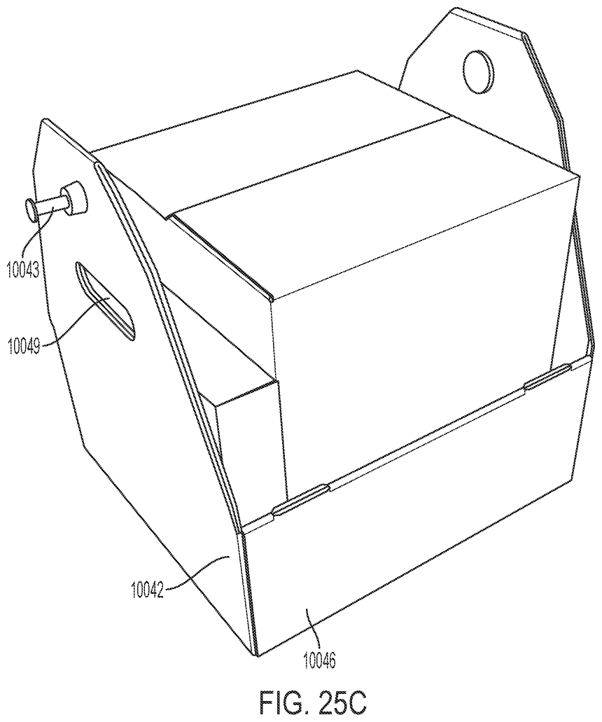

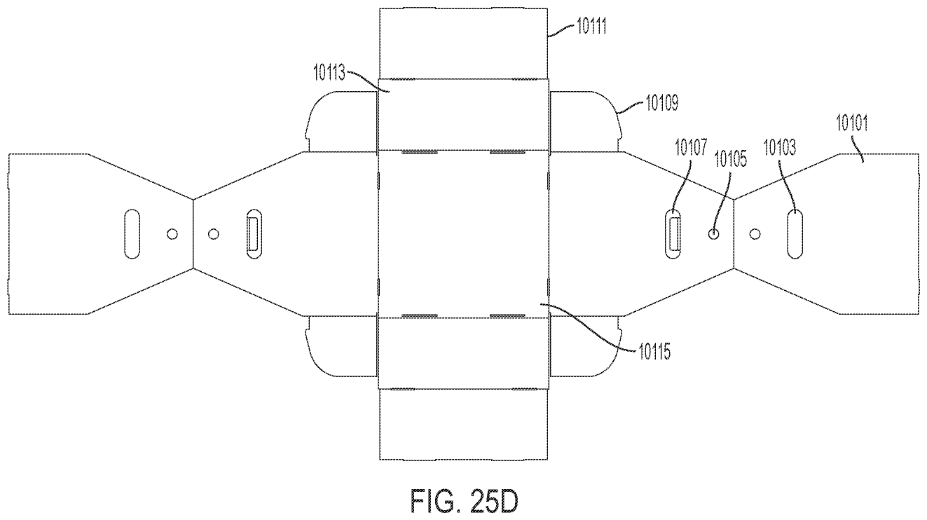

Referring now to FIGS. 25A-25D, an exemplary open-topped tote is shown. The exemplary open-topped tote as shown in FIG. 25A includes side panels 10045, pin panels 10041, floor 10047, and tote pins 10043. In an aspect, the tote can be autonomously lifted from a cargo bay by a grasping mechanism engaging with tote pins 10043. The tote can take on any shape, depending upon its intended use. In an aspect, the tote takes the shape of the cargo bay of the autonomous vehicle. Side panels 10045, pin panels 10041, and floor 10047 can take on any shape. Another configuration of the exemplary tote, as shown in FIGS. 25B and 25C, is constructed of 22O material, and additionally flattens for stacking and storing. In an aspect, side panels 10046 are perforated for fold-over construction. In an aspect, end panels 10042 include pin cavities 10051 as well as hand-held cavities 10049. In an aspect, the tote can transport multiple packages as shown in FIG. 25C. In an aspect, the disposable tote can be constructed of cardboard and/or waterproofed materials, such as, but not limited to, plastic, wood fiber, medium density fiber board, and/or oriented strand board. In an aspect, and referring to FIG. 25D, a collapsible box includes foldover wings 10101 (FIG. 25D) and 10111/10113 (FIG. 25D) that both enable flat storage of the box, but strengthen the sides of the box. In an aspect, the box includes handholds 10103/10107 (FIG. 25D) and bottom 10115 (FIG. 25D). Fold flaps 10109 secure the sides to each other. In an aspect, the box is open-topped.

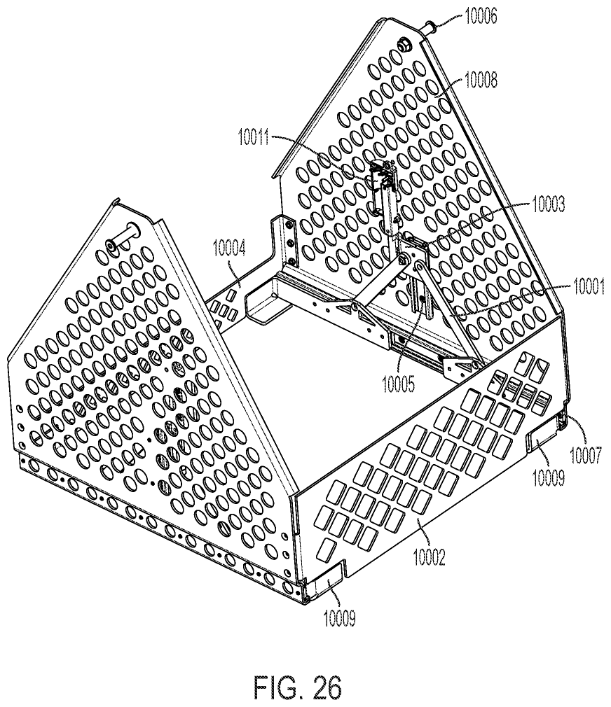

Referring now to FIG. 26, a durable container drop system is shown. The exemplary container drop system includes sides 10008, front 10002, and rear 10004. Sides 10008 host actuators 10011, link arms 10001, first rail 10005, and rail carriage 10003. In an aspect, actuators 10011 energize rail carriage 10003 to move up and down first rail 10005. As rail carriage 10003 moves up and down first rail 10005, the angle between link arms 10001 increases and decreases. As the angle between link arms 10001 changes, corners 10009 move along second rail 10007. As corners 10009 move away from front 10002 and rear 10004, a container (not shown) that is held by the container drop device falls through the container drop bottom opening. In an aspect, the container drop device is lifted/lowered/raised by an autonomous grasping means engaging with pins 10006. In an aspect, actuators 10011 are activated remotely through wireless control, possibly by a user, a remote operator, or in conjunction with movement of the autonomous device.

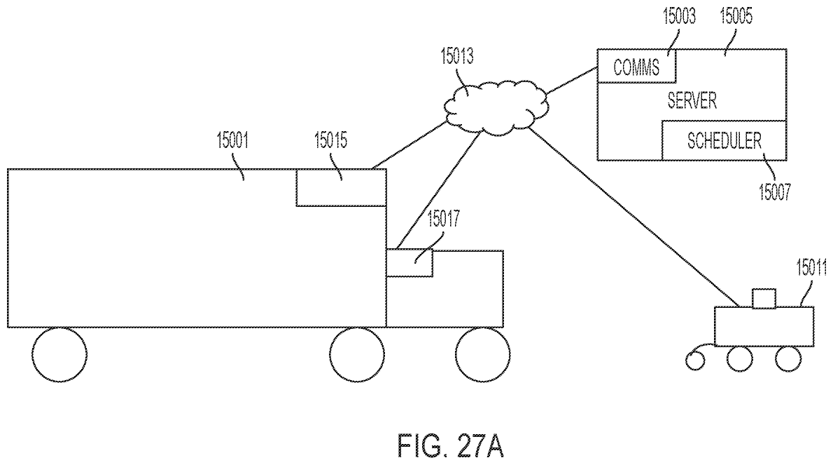

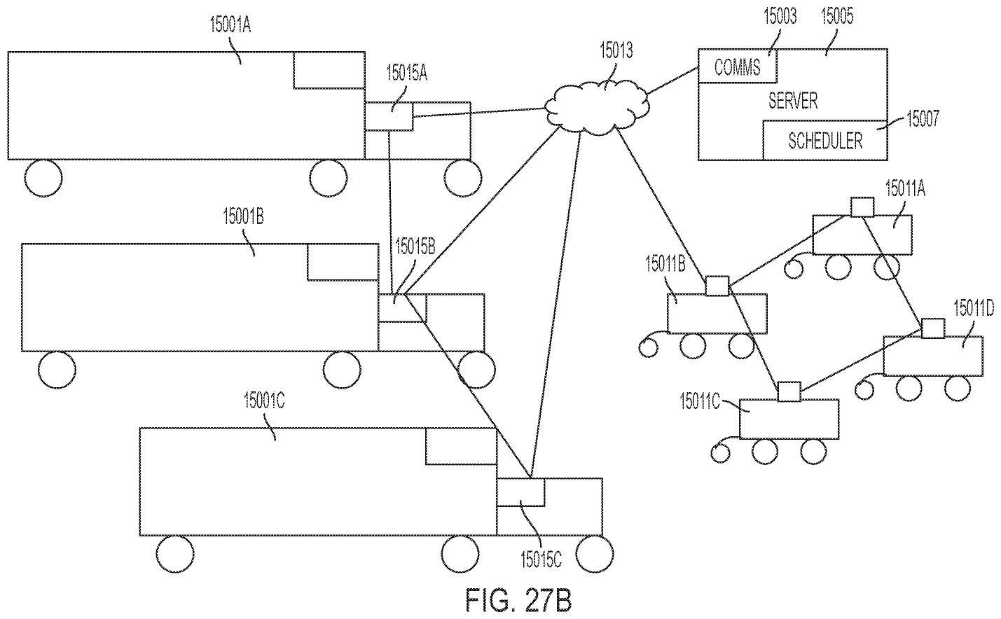

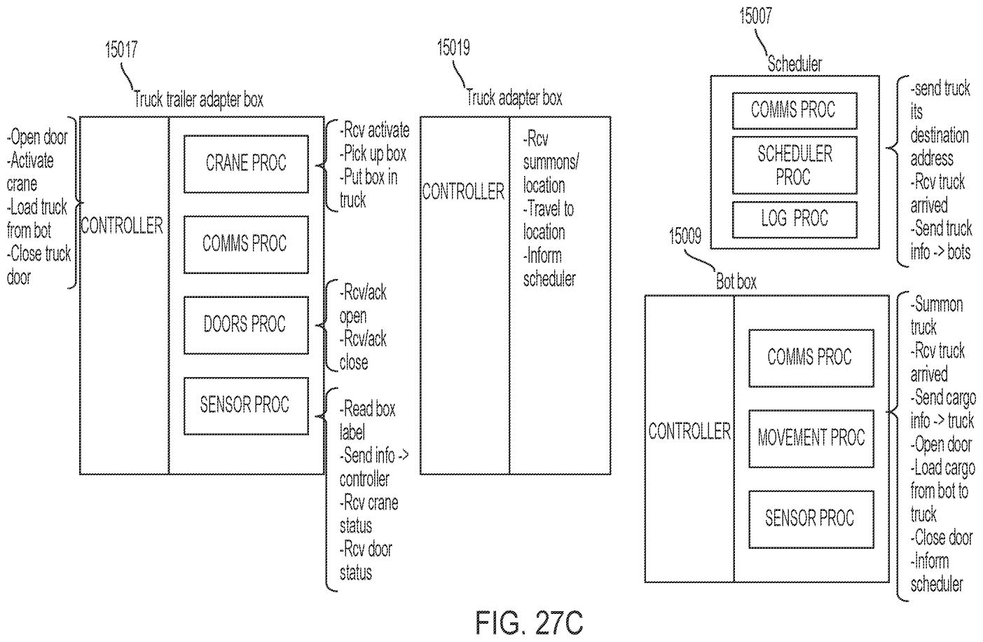

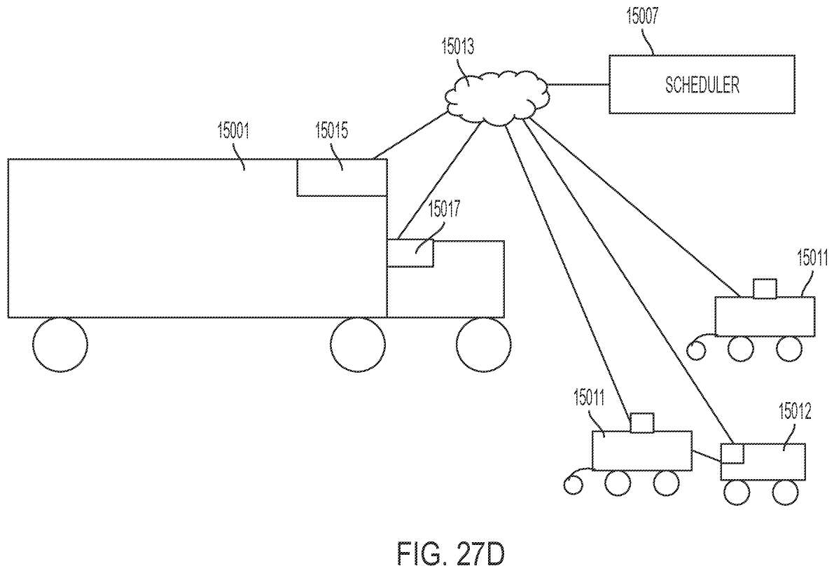

Referring now to FIGS. 27A-27D, exemplary interactions between delivery trucks and autonomous vehicles are illustrated. In an aspect, delivery trucks and autonomous vehicles are communicatively coupled, through direct communication or communication through a scheduler and/or remote operator. Such communicative coupling may be enabled by a network-based cloud. In an aspect, delivery trucks summon autonomous vehicles and vice versa. In an aspect, delivery trucks summon each other, autonomous vehicles summon each other, and/or summoning occurs cross-vehicle among delivery trucks and autonomous vehicles. In an aspect, activities among vehicles are coordinated among each other, or coordinated by a scheduler and/or remote operator, or a combination, depending on the circumstances. In an aspect, a trailer may accompany an autonomous vehicle. In an aspect, the trailer communicates with at least one autonomous vehicle and at least one delivery truck. In an aspect, the trailer carries additional power options for an autonomous vehicle. In an aspect, trailer power is used for locking and anti-theft protection of the cargo being hauled in the trailer. In an aspect, a trailer may carry at least one battery, for example in a base compartment of the trailer, that can be used by an autonomous vehicle that requires charging. In an aspect, an autonomous vehicle may supply power to another autonomous vehicle in need of charging. In an aspect, autonomous vehicles are pre-loaded and know their respective target destination(s). In an aspect, autonomous vehicles summon delivery trucks to carry them to their target destination(s) and deliver them as close as possible to the target destination(s). In an aspect, if the autonomous vehicle needs additional cargo space, a trailer, or more autonomous vehicles are brought to join the requesting autonomous vehicle and/or delivery truck.

Referring now to FIG. 27A, in an aspect, an autonomous vehicle summons a delivery vehicle such as, for example, a delivery truck. The autonomous vehicle may summon the delivery truck if the autonomous vehicle has made a delivery and can accommodate additional items to be delivered, or the autonomous vehicle could need to be picked up for any number of reasons. For example, the autonomous vehicle may require charging, or the autonomous vehicle could have been summoned to a target destination that is too distant from the current location of the autonomous vehicle for a timely delivery to be made. The delivery truck could transport the autonomous vehicle to a location that is closer to the target destination, and the autonomous vehicle could travel the remaining distance, if necessary, such as if the remaining distance is not navigable by a delivery truck. In an aspect, the autonomous vehicle informs a scheduler that it has a problem, for example, a power problem. The delivery truck is summoned to possibly swap out batteries, or in the alternative, rescue the autonomous vehicle and/or its cargo. In an aspect, the delivery truck is summoned to bring more cargo to the autonomous vehicle or to pick up items that are pre-loaded on an autonomous vehicle.

An exemplary configuration is shown in FIG. 27. An autonomous vehicle communicates either directly or indirectly with delivery truck controller 15017 in delivery truck 15001. In an aspect, delivery truck 15001 is a tractor-trailer. In an aspect, the truck-trailer includes truck-trailer controller 15015. The vehicle controllers communicate, through network 15013 with each other and with communications processor 15003 of server 15005. In an aspect, scheduler 15007 operates in server 15005 and manages the locations and deliveries of autonomous vehicles and delivery trucks. Such an exemplary configuration can be used and expanded in many ways. Exemplary commands exchanged between the summoning autonomous vehicle(s) and the delivery truck(s) include (a) determine, by the autonomous vehicle, the issue with the autonomous vehicle, (b) if the autonomous vehicle is disabled, request, by the autonomous vehicle, assistance from a delivery truck that has room to haul the autonomous vehicle, (c) if the autonomous vehicle needs a lift to make at least one delivery, request, by the autonomous vehicle, a delivery truck meeting delivery criteria such as proximity to the autonomous vehicle and/or proximity to the target destination, and (d) if the autonomous vehicle needs more cargo to deliver, request, by the autonomous vehicle, a delivery truck containing cargo that is destined to be delivered in the vicinity of the autonomous vehicle. Other reasons for summoning the delivery truck can be accounted for by a state table executed by the autonomous vehicle. The state table can be updated dynamically, can have a set of pre-selected states, or can by amended by a user or remote operator.

Continuing to refer to FIG. 27A, when the delivery truck is summoned, it moves to the summoning autonomous vehicle. The summoning autonomous vehicle can issue further commands such as (a) direct, by the autonomous vehicle, if possible, depending upon any issues with the autonomous vehicle, the truck-trailer to open door(s) to the truck-trailer cargo area, (b) direct, by the autonomous vehicle, if possible, a lift device within the truck-trailer to locate the autonomous vehicle, or possibly position a loading device within the truck-trailer to deliver cargo to the autonomous device, (c) command, by the autonomous vehicle, the lift device to lift the autonomous vehicle into the delivery truck, or command, by the autonomous vehicle, the doors of the autonomous vehicle to open towards the doors of the truck-trailer, and (d) command, by the autonomous vehicle, the loading device to move cargo from the truck-trailer to the autonomous vehicle. In an aspect, the cargo is electronically labeled with its destination and other characteristics. In an aspect, the autonomous vehicle issues a command to scan the identifying information on the cargo and determine a route to the target destination(s) based at least on the identifying information on the cargo. In an aspect, the autonomous vehicle issues a command to move the cargo from the autonomous vehicle cargo hold and/or from the autonomous vehicle trailer cargo hold to the delivery truck autonomously using delivery arms in the autonomous vehicle, as described herein, or using mechanisms provided by the truck-trailer. In an aspect, the autonomous vehicle navigates to another pickup or delivery target destination.

Referring now to FIG. 27B, an exemplary configuration with multiple delivery trucks and multiple autonomous vehicles is shown. It should be understood that multiple servers, though not shown, can be used to offload processing from a single processor. In the exemplary configuration shown in FIG. 27B, autonomous vehicles 15011A-15011D are configured to communicate with each other in a, possibly ad hoc, local network. In an aspect, multiple autonomous vehicles 15011x form a convoy and use the local network to convey which autonomous vehicle 15011x is the leader, the leader's speed and speed/direction changes, and braking actuation. Information about the leader can be transmitted by the leader or inferred from sensors on non-leader autonomous vehicles 15011x. In an aspect, multiple autonomous vehicles 15011x may summon trucks 15001x to multiple locations Likewise, delivery trucks 15001A-15001C are configured to communicate with each other in a, possibly ad hoc, local network. Each of the local networks, and possibly each individual vehicle, is configured to communicate with server 15005, either directly or through a conventional communications network. In an aspect, multiple autonomous vehicles 15011x may summon at least one delivery truck 15001x either directly choosing a delivery truck or through server 15005 in which scheduler 15007 consults the schedules and locations of the delivery trucks and sends the closest truck, or the truck with no cargo, or the truck with cargo destined for deliveries to target destinations that are nearby to the summoning autonomous vehicle(s). In an aspect, the process outlined herein for moving cargo from the autonomous vehicles' cargo holds and/or the trailers' cargo holds to the delivery truck(s) is followed. The autonomous vehicles communicate among each other and with the scheduler to coordinate next pickups/deliveries which can involve more cargo than a single autonomous vehicle and/or trailer and/or delivery truck can handle alone.

Referring to FIG. 27C, a block diagram illustrating the functions each of the components perform in an exemplary truck summoning process is depicted. In an aspect, autonomous vehicle 15009 summons truck 15001 (FIG. 27A), and truck adapter box 15019 receives a summons from autonomous vehicle 15009, travels to the location indicated by the summons, and informs scheduler 15007 of its status. When truck 15001 (FIG. 27A) arrives, autonomous vehicle 15009 is informed, either by truck 15001 (FIG. 27A) or by scheduler 15007, or by both, and truck 15001 (FIG. 27A) opens its door(s). Autonomous vehicle 15009 opens its door(s) and activates its delivery arm(s) to move its cargo to truck 15001 (FIG. 27A). The doors are closed and scheduler 15007 is informed of the status. In an aspect, the activity is logged.

Referring now to FIG. 27D, in an aspect, autonomous vehicle trailer 15012 is configured to communicate with scheduler 15007 and truck 15001 to provide status and other information about its cargo. In an aspect, autonomous vehicle trailer 15012, which carries such items as power supplies and cargo, is summoned by autonomous vehicle 15011 and/or truck 15001 to carry cargo that does not fit in autonomous vehicle 15012, or when power is needed by autonomous vehicle 15011, such as a charged battery pack. In an aspect, autonomous vehicle trailer 15012 tracks the status of power supplies that it hauls and provides that information to scheduler 15007, autonomous vehicles 15011, and trucks 15001, for example. Alternatively, in an aspect, power supplies are charged by wireless transmitters (not shown). The wireless transmitters can be located under road surfaces upon which autonomous vehicle 15011 and autonomous vehicle trailer 15012 travel. The wireless transmitters can be located on trucks 15001, autonomous vehicles 15011, and/or autonomous vehicle trailers 15012. In an aspect, among other features that are powered on autonomous vehicle trailer 15012, sensors that enable, among other things, locking and antitheft protection are located around the autonomous vehicle trailer's cargo. In an aspect, the autonomous vehicle trailer includes protection from environmental incursion, and sensors to detect such incursion.

Configurations of the present teachings are directed to computer systems for accomplishing the methods discussed in the description herein, and to computer readable media containing programs for accomplishing these methods. The raw data and results can be stored for future retrieval and processing, printed, displayed, transferred to another computer, and/or transferred elsewhere. Communications links can be wired or wireless, for example, using cellular communication systems, military communications systems, and satellite communications systems. Parts of the system can operate on a computer having a variable number of CPUs. Other alternative computer platforms can be used.

The present configuration is also directed to software/firmware/hardware for accomplishing the methods discussed herein, and computer readable media storing software for accomplishing these methods. The various modules described herein can be accomplished on the same CPU, or can be accomplished on different CPUs. The present configuration has been described in language that is specific as to structural and methodical features. It is to be understood, however, that the present configuration is not limited to the specific features shown and described herein.

Methods can be, in whole or in part, implemented electronically. Signals representing actions taken by elements of the system and other disclosed configurations can travel over at least one live communications network. Control and data information can be electronically executed and stored on at least one computer-readable medium. The system can be implemented to execute on at least one computer node in at least one live communications network. Common forms of at least one computer-readable medium can include, for example, but not be limited to, a floppy disk, a flexible disk, a hard disk, magnetic tape, or any other magnetic medium, a compact disk read only memory or any other optical medium, punched cards, paper tape, or any other physical medium with patterns of holes, a random access memory, a programmable read only memory, and erasable programmable read only memory (EPROM), a Flash EPROM, or any other memory chip or cartridge, or any other medium from which a computer can read. Further, the at least one computer readable medium can contain graphs in any form, subject to appropriate licenses where necessary, including, but not limited to, Graphic Interchange Format (GIF), Joint Photographic Experts Group (JPEG), Portable Network Graphics (PNG), Scalable Vector Graphics (SVG), and Tagged Image File Format (TIFF).

While the present teachings have been described above in terms of specific configurations, it is to be understood that they are not limited to these disclosed configurations. Many modifications and other configurations will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A method for autonomous unattended package delivery comprising:
receiving a package into a cargo area of an autonomous vehicle (AV), the cargo area including a secure container;
receiving a desired destination for the package;
autonomously commanding the AV to navigate to the desired destination; and
autonomously deploying the secure container containing the package from the AV at the desired destination, the desired destination being unattended.

2. The method as in claim 1 wherein autonomously receiving the package comprises:
adjusting security settings on the secure container achieving consistency between the desired destination and the secure container.

3. The method as in claim 2 wherein autonomously deploying the package comprises:
opening the cargo area;
autonomously moving the secure container out of the cargo area using a deployment device;
commanding the deployment device to move the secure container to a surface outside of the AV;
continuously determining a position of the secure container;
disengaging the secure container from the deployment device when the secure container reaches the surface;
retracting the deployment device into the cargo area; and
closing the cargo area.

4. The method as in claim 3 wherein the secure container comprises:
at least one secure entry device;
at least one location sensing device;
at least one camera;
at least one alarm system; and
at least one device coupling the deployment device with the secure container.

5. The method as in claim 3 further comprising:
reading package identifying information associated with the package, the package identifying information including the desired destination.

6. The method as in claim 1 further comprising:
autonomously picking up a second package at the desired destination;
determining a second desired destination from identifying information on the second package; and
navigating to the second desired destination.

7. A system for autonomous unattended package delivery comprising:
an autonomous vehicle (AV) having a cargo area;
a receiver on the AV configured to receive a desired destination for a package;
a deployment device associated with the cargo area, the deployment device configured to deploy the package at the desired destination;
a plurality of sensors configured to receive sensor information about an environment surrounding the AV;
a controller configured to
determine a route between a location of the AV and the desired destination;
continuously determine free navigation space along the route based at least one the sensor information;
autonomously generate commands to navigate the AV in the free navigation space to the desired destination;
autonomously generate the commands to deploy the package;
autonomously re-store the deployment device; and
autonomously provide a notification when the package has completed deployment.

8. A trailer for autonomous package delivery comprising:
a mast configured to mount a cargo box;
a hitch cross configured to connect the trailer to a towing vehicle;
a frame structure configured to operably couple with the mast at a first end, the frame structure configured to operably couple with the hitch cross at a second end; and
a tie rod configured to operably couple with the mast at a third end, the tie rod configured to operably couple with the hitch cross at a fourth end,
wherein the mast, the hitch cross, the frame structure, and the tie rod are configured to form rigid elements of a 4-bar linkage, the 4-bar linkage maintaining consistent pitch between the cargo box and a cargo hold of the towing vehicle.

9. The trailer as in claim 8 further comprising:
a steering damper operably coupled with the frame structure.

10. A delivery arm assembly for moving cargo autonomously from a cargo area comprising:
a motor;
a drive gear configured to be rotated by the motor;
at least one delivery arm; and
a spur gear configured to be driven by the drive gear, the spur gear configured to drive the at least one delivery arm,
wherein the motor, the drive gear, the at least one delivery arm, and the spur gear are configured to occupy the cargo area.

11. The delivery arm assembly as in claim 10 wherein the at least one delivery arm comprises:
at least one extension tube configured to move when the spur gear rotates; and
at least one roller guide plate including at least one cam channel,
wherein the at least one delivery arm is slidingly coupled with the at least one extension tube, the at least one delivery arm including a cam follower, the cam follower traveling in the at least one cam channel as the at least one extension tube moves.

12. The delivery arm assembly as in claim 10 further comprising:
a geared cross shaft configured to rotate when the motor is activated, the geared cross shaft operably coupling a first of the at least one delivery arm with a second of the at least one delivery arm.

13. A container drop system comprising:
a plurality of panels;
at least one actuator;
at least two link arms configured at an angle with respect to each other, the at least two link arms configured to move under control of the at least one actuator; and
at least two corners operably coupled with the at least two link arms, the at least two corners traveling in opposite directions from each other when at least one of the at least two link arms moves, the at least two corners traveling along an edge of at least one of the plurality of panels,
wherein the at least two corners release a container when the angle increases past a threshold value.

14. The container drop system as in claim 13 further comprising:
at least one lift device.

15. The container drop system as in claim 14 wherein the lift device comprises:
at least one pin.

16. A delivery system comprising:
at least one long haul vehicle controller associated with at least one long haul vehicle;
at least one autonomous vehicle controller associated with at least one autonomous vehicle, the at least one autonomous vehicle controller configured to communicate with the at least one long haul device controller, the at least one autonomous vehicle controller executing instructions including:
issuing a summons to the at least one long haul vehicle controller;
issuing at least one command to the at least one autonomous vehicle, the at least one command configured to receive into the at least one autonomous vehicle a delivery from the at least one long haul vehicle;
issuing at least one movement command to the at least one autonomous vehicle, the at least one movement command navigating the at least one autonomous vehicle to a delivery location; and
issuing the at least one command to the at least one autonomous vehicle, the at least one command configured to enable delivery at the delivery location.

17. The delivery system as in claim 16 further comprising:
at least one trailer configured to operably couple with the autonomous vehicle.

18. A method for managing a delivery of goods autonomously comprising:
determining, by an autonomous vehicle, an issue with the autonomous vehicle;
if the issue is autonomous vehicle disability, requesting, by the autonomous vehicle, assistance from a delivery truck, the delivery truck configured to carry the autonomous vehicle;
if the issue is autonomous vehicle transportation needs for making at least one delivery, requesting, by the autonomous vehicle, the delivery truck that meets first pre-selected delivery criteria; and
if the issue is that the autonomous vehicle needs more of the goods to deliver, requesting, by the autonomous vehicle, the delivery truck containing the goods that meet second pre-selected delivery criteria.

19. The method as in claim 18 wherein the first pre-selected delivery criteria comprise:
a proximity of the delivery truck to the autonomous vehicle; and
the proximity of the delivery truck to at least one delivery destination of the goods.

20. The method as in claim 19 further comprising:
labeling the goods electronically with at least one characteristic of the goods.
